(19) United States
(12) Patent Application Publication
(10) Pub. No.: US 2024/0024823 A1
(43) Pub. Date: Jan. 25, 2024

(54) Systems and Methods for Bipolar Membranes

(71) Applicant: California Institute of Technology, Pasadena, CA (US)

(72) Inventors: Eowyn Lucas, Los Angeles, CA (US); Harry A. Atwater, South Pasadena, CA (US); Chengxiang Xiang, San Marino, CA (US)

(73) Assignee: California Institute of Technology, Pasadena, CA (US)

(21) Appl. No.: 18/343,597

(22) Filed: Jun. 28, 2023

Related U.S. Application Data
(60) Provisional application No. 63/356,325, filed on Jun. 28, 2022.
(60) Provisional application No. 63/443,226, filed on Feb. 3, 2023.

(51) Int. Cl. B01D 61/44; B01D 69/02; B01D 61/46; C02F 1/469

(52) U.S. Cl. CPC B01D 61/445; B01D 69/02; B01D 61/461; C02F 1/4693; B01D 2325/42; B01D 2325/04; B01D 2313/345; C02F 2101/10

(57) ABSTRACT

Systems and methods for catalyzed asymmetric bipolar membranes are described. Catalyzed asymmetric bipolar membranes can sustain desired current densities under low operational voltage for prolonged time periods. Catalyzed asymmetric bipolar membranes can be implemented in electrodialysis cells for various applications such as carbon capture.

### CROSS-REFERENCE TO RELATED APPLICATIONS

The current application claims the benefit of and priority under 35 U.S.C. § 119 (e) to U.S. Provisional Patent Application No. 63/356,325 entitled “High Current Density, Catalyzed Bipolar Membrane for Efficient Direct Ocean Capture” filed Jun. 28, 2022, and to U.S. Provisional Patent Application No. 63/443,226 entitled “High Current Density, Catalyzed Bipolar Membrane for Efficient Direct Ocean Capture” filed Feb. 3, 2023. The disclosures of U.S. Provisional Patent Application Nos. 63/356,325 and 63/443,226 are hereby incorporated by reference in their entirety for all purposes.

### GOVERNMENT SPONSORED RESEARCH

This invention was made with government support under Grant No. DE-AR0001407 awarded by the Department of Energy. The government has certain rights in the invention.

### FIELD OF THE INVENTION

The present invention generally relates to systems and methods for asymmetric bipolar membranes; and more particularly to systems and methods for asymmetric bipolar membranes with catalysts.

### BACKGROUND OF THE INVENTION

Ion exchange membranes comprise polymers containing ionizable functional groups that allow for the selective transport of cations in cation exchange membranes (CEMs) and of anions in anion exchange membranes (AEMs). Bipolar membranes (BPMs) can include a cation exchange layer (CEL) laminated to an anion exchange layer (AEL) with a water dissociation (WD) catalyst dispersed at the CEL-AEL junction. At the CEL-AEL junction, mobile protons and hydroxides from the CEL and AEL react to form water, neutralizing the mobile ions to generate a space-charge depletion region, which results in an electric field across the depletion region. When utilized in an electrochemical system with an anode and cathode, bias across the BPM can be applied and controlled. Controlling the applied bias at the cathodes and anodes can move the protons (H⁺) and hydroxides (OH⁻) in different directions. When a BPM is placed in an electrochemical cell under reverse bias, enhanced WD due to the presence of a large electric field occurs at the junction between the CEL and AEL. H⁺ ions can travel selectively through the CEL, while OH⁻ ions travel selectively through the AEL, creating separate acidic and basic streams on either side of the BPM. BPMs enable isolated acidic/alkaline regions in electrochemical devices, facilitating optimized catalytic environments for water electrolysis, CO₂ reduction, and electrodialysis.

Direct ocean capture (DOC) is a carbon capture strategy that can leverage the fact that the solvation equilibrium between gaseous and aqueous CO₂ results in atmospheric carbon being concentrated in the ocean. DOC technologies need to overcome the requirement that proton-transfer reactions have to occur in oceanwater to convert bicarbonate (HCO₃⁻) into either carbonate (CO₃²⁻) that can precipitate out, or dissolved CO₂ that can be pulled off as gas.

### BRIEF SUMMARY OF THE INVENTION

Many embodiments are directed to systems of asymmetric bipolar membrane for electrodialysis cells and associated methods thereof.

An embodiment of the invention includes a bipolar membrane comprising: an anion exchange layer comprising an anion exchange membrane; a cation exchange layer comprising a cation exchange membrane, wherein the anion exchange layer has a different thickness than the cation exchange layer such that water transport rate at an anion exchange layer-cation exchange layer interface increases; and a catalyst disposed between the anion exchange layer and the cation exchange layer, wherein the catalyst catalyzes a water dissociation reaction; wherein the catalyst comprises a plurality of ionizable sites with a property of proton donating, proton withdrawing, or a combination thereof, such that the plurality of ionizable sites enhances an electric field at the anion exchange layer-cation exchange layer interface.

In another embodiment, the catalyst comprises a material selected from the group consisting of: a two-dimensional material, graphene oxide, a metal oxide, a titanium-based multivalent catalyst, a nanomaterial, a polymer, and any combinations thereof.

In an additional embodiment, the catalyst layer further comprises an ionomer.

In a further embodiment, the plurality of ionizable sites comprises functional groups of different pkₐ values.

In another further embodiment, the anion exchange membrane is selected from the group consisting of: SELEMION®, NEOSEPTA®, Fumapem® FAA, Fumasep® FAP, Sustainion® X37, Versogen® PiperION®, Ionomr Aemion®, and any combination thereof; and the cation exchange membrane comprises Nafion®.

In another additional embodiment, a thickness of the bipolar membrane is greater than or equal to 70 microns.

In yet another embodiment, the anion exchange layer has a thickness less than 100 microns and is thinner than the cation exchange layer.

In a yet further embodiment, the cation exchange layer has a thickness less than 100 microns and is thinner than the anion exchange layer.

In a further yet embodiment, the membrane is configured to be a portion of an electrodialysis cell.

In another further embodiment, the electrodialysis cell has a configuration selected from the group consisting of: an H cell, a cell stack, a flow cell, and a flow stack.

In an additional embodiment again, the electrodialysis cell comprises a cathode and an anode comprising a material selected from the group consisting of: a metal, a metal alloy, nickel, a nickel-based alloy, copper, a copper-based alloy, titanium, a titanium-based alloy, iron, an iron-based alloy, stainless steel, platinum, gold, silver, carbon, carbon cloth, glassy carbon, graphite, and any combinations thereof.

In yet another embodiment, the electrodialysis cell is a portion of a carbon capture system, an electrochemical conversion system, an energy storage system, a water splitting system, or a carbon dioxide reduction system.

In a further yet embodiment, the carbon capture system is a direct ocean capture system.

In another additional embodiment, the electrodialysis cell operates at a current density of greater than or equal to 100 mA/cm² and at a voltage of less than or equal to 1.5 V for a duration of at least 60 hours.

An additional embodiment includes an electrodialysis cell comprising: a freestanding bipolar membrane comprising: an anion exchange layer comprising an anion exchange membrane; a cation exchange layer comprising a cation exchange membrane, wherein the anion exchange layer has a different thickness than the cation exchange layer such that water transportation rate at an anion exchange layer-cation exchange layer interface increases; and a catalyst disposed between the anion and cation exchange layers catalyzes a water dissociation reaction; wherein the catalyst comprises a plurality of ionizable sites with a property of proton donating, proton withdrawing, or a combination thereof, such that the plurality of ionizable sites enhances an electric field at the anion exchange layer-cation exchange layer interface; an anode and a cathode, wherein the freestanding bipolar membrane is disposed between the anode and the cathode.

In a further embodiment, the catalyst comprises a material selected from the group consisting of: a two-dimensional material, graphene oxide, a metal oxide, a titanium-based multivalent catalyst, a nanomaterial, a polymer, and any combinations thereof.

In another embodiment again, the catalyst layer further comprises an ionomer.

In yet another embodiment, the plurality of ionizable sites comprises functional groups of different pkₐ values.

In a further yet embodiment, the anion exchange membrane is selected from the group consisting of: SELEMION®, NEOSEPTA®, Fumapem® FAA, Fumasep® FAP, Sustainion® X37, Versogen® PiperION®, Ionomr Aemion®, and any combination thereof; and the cation exchange membrane comprises Nafion®.

In another further embodiment, a thickness of the bipolar membrane is greater than or equal to 70 microns.

In yet another embodiment, the anion exchange layer has a thickness less than 100 microns and is thinner than the cation exchange layer.

In a further embodiment again, the cation exchange layer has a thickness less than 100 microns and is thinner than the anion exchange layer.

In a yet further embodiment, the electrodialysis cell has a configuration selected from the group consisting of: an H cell, a cell stack, a flow cell, and a flow stack.

In another yet embodiment again, the cathode and the anode comprise a material selected from the group consisting of: a metal, a metal alloy, nickel, a nickel-based alloy, copper, a copper-based alloy, titanium, a titanium-based alloy, iron, an iron-based alloy, stainless steel, platinum, gold, silver, carbon, carbon cloth, glassy carbon, graphite, and any combinations thereof.

In another additional embodiment, the electrodialysis cell is configured to be a portion of a carbon capture system, an electrochemical conversion system, an energy storage system, a water splitting system, or a carbon dioxide reduction system.

In a further embodiment again, the carbon capture system is a direct ocean capture system.

In yet another embodiment, the electrodialysis cell operates at a current density of greater than or equal to 100 mA/cm² and at a voltage of less than or equal to 1.5 V for a duration of at least 60 hours.

A further embodiment includes a method for direct ocean capture, comprising:
contacting a water source comprising a dissolved carbon with a bipolar membrane comprising: an anion exchange layer comprising an anion exchange membrane;
a cation exchange layer comprising a cation exchange membrane; wherein the anion exchange layer has a different thickness than the cation exchange layer such that water transport rate at an anion exchange layer-cation exchange layer interface increases; and a catalyst disposed between the anion exchange layer and the cation exchange layer catalyzes a water dissociation reaction; wherein the catalyst comprises a plurality of ionizable sites with a property of proton donating, proton withdrawing, or a combination thereof, such that the plurality of ionizable sites enhances an electric field at the anion exchange layer-cation exchange layer interface;
collecting a carbon dioxide gaseous stream; wherein the bipolar membrane enhances an efficiency of producing the carbon dioxide gaseous stream; and
collecting an output water stream that has a lower dissolved carbon concentration than the water source.

In a yet another embodiment, the catalyst comprises a material selected from the group consisting of: a two-dimensional material, graphene oxide, a metal oxide, a titanium-based multivalent catalyst, a nanomaterial, a polymer, and any combinations thereof.

In an additional embodiment again, the catalyst layer further comprises an ionomer.

In yet another embodiment, the plurality of ionizable sites comprises functional groups of different pkₐ values.

In another further embodiment, the anion exchange membrane is selected from the group consisting of: SELEMION®, NEOSEPTA®, fumapem FAA, fumasep FAP, Sustainion® X37, Versogen® PiperION®, Ionomr Aemion®, and any combination thereof; and the cation exchange membrane comprises Nafion®.

In another further embodiment, a thickness of the bipolar membrane is greater than or equal to 70 microns.

In yet another embodiment, the anion exchange layer has a thickness less than 100 microns and is thinner than the cation exchange layer.

In a further embodiment again, the cation exchange layer has a thickness less than 100 microns and is thinner than the anion exchange layer.

In yet another embodiment, the bipolar membrane is a portion of an electrodialysis cell.

In an additional further embodiment, the electrodialysis cell has a configuration selected from the group consisting of: an H cell, a cell stack, a flow cell, and a flow stack.

In a further yet embodiment again, the electrodialysis cell comprises a cathode and an anode comprising a material selected from the group consisting of: a metal, a metal alloy, nickel, a nickel-based alloy, copper, a copper-based alloy, titanium, a titanium-based alloy, iron, an iron-based alloy, stainless steel, platinum, gold, silver, carbon, carbon cloth, glassy carbon, graphite, and any combinations thereof.

In yet another embodiment again, the water source is selected from the group consisting of: native oceanwater, river water, pretreated oceanwater, or any combination thereof.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 illustrates a schematic of carbon dioxide dissolved in the ocean.

FIGS. 2A and 2B illustrate a schematic of an asymmetric BPM in accordance with an embodiment.

FIGS. 3A and 3B illustrate a schematic of direct ocean capture using asymmetric BPMs in a 3-compartment electrodialysis cell in accordance with an embodiment.

FIG. 4A illustrates a schematic of a catalyzed asymmetric BPM in accordance of an embodiment.

FIG. 4B illustrates a SEM cross section of a catalyzed asymmetric BPM in accordance of an embodiment.

FIG. 5 illustrates measured membrane thickness on Si for Nafion D2020, Sustainion, PiperION A, PiperION B, and PiperION C after spin coating 1-4 layers at 3000 rpm for 30 sec in accordance with an embodiment.

FIGS. 6A through 6D conceptually illustrate BPM fabrication methods (spin coating, hot pressing, casting, and sandwiching) in accordance with an embodiment.

FIG. 7 conceptually illustrates processes for depositing a catalyst layer onto a membrane sheet via spin coating in accordance with an embodiment.

FIG. 8 illustrates polarization curves for spin coated BPMs with varying CEL and AEL composition in accordance with an embodiment.

FIG. 9 illustrates polarization curves for BPMs constructed from Nafion® and PiperION® using varying fabrication techniques in accordance with an embodiment.

FIG. 10 illustrates polarization curves for BPMs with varying catalyst materials in accordance with an embodiment.

FIG. 11 illustrates polarization curves for varying BPMs with varying heat treatments in accordance with an embodiment.

FIG. 12 illustrates polarization curves for various BPMs with varying ionomers in GrOx ink in accordance with an embodiment.

FIGS. 13A and 13B illustrate experimental setups for characterizing the performance of electrodialysis cells fitted with asymmetric BPMs in accordance with an embodiment.

FIG. 14 illustrates shape and regions of a current density vs. voltage curve for bipolar membranes in reverse bias in accordance with an embodiment.

FIG. 15 illustrates voltage at different current densities, up to 2 A/cm² of an asymmetric BPM in accordance with an embodiment.

FIG. 16 illustrates voltage at different current densities of a catalyzed and non-catalyzed asymmetric BPM in accordance with an embodiment.

FIG. 17 illustrates current density of a GrOx catalyzed, asymmetric BPM with different iR correction methods implemented in accordance with an embodiment.

FIG. 18 illustrates current density performance of asymmetric BPMs with various CL load weights in accordance with an embodiment.

FIG. 19A illustrates the polarization curve of an asymmetric BPM in accordance with an embodiment.

FIG. 19B illustrates the sum of voltage contributions due to WD potential, CEL ohmic losses, AEL ohmic losses, and electrolyte ohmic losses compared to measured performance of the BPM in accordance with an embodiment.

FIGS. 20A through 20C illustrate the voltage stability of asymmetric BPMs in accordance with an embodiment.

FIG. 21 illustrates stability plots of asymmetric BPMs in accordance with an embodiment.

FIG. 22A illustrates a schematic of an experimental setup for characterizing the performance of a one-cell electrodialysis stack fitted with asymmetric BPMs in accordance with an embodiment.

FIG. 22B illustrates one-cell polarization curve for multi-cell stack with GrOx catalyzed, asymmetric BPM, calculated voltages for each section of the one-cell stack at current densities of 10-500 mA cm⁻², and calculated voltages for each section of a projected optimized one-cell stack in accordance with an embodiment.

FIGS. 23A through 23D illustrate Faradaic efficiency in accordance with an embodiment.

FIG. 24A illustrates polarization curves of asymmetric BPMs with varying CL load weights in accordance with an embodiment.

FIG. 24B illustrates voltage of asymmetric BPMs in with varying CL load weights in accordance with an embodiment.

FIG. 24C illustrates RWD of asymmetric BPMs in with varying CL load weights in accordance with an embodiment.

FIG. 24D illustrates CWD asymmetric BPMs in with varying CL load weights in accordance with an embodiment.

FIGS. 24E through 24G illustrate optical images of varying CL layers of asymmetric BPMs in with varying CL load weights in accordance with an embodiment.

FIG. 25A illustrates polarization curves, simulated and experimental, in accordance with an embodiment.

FIG. 25B illustrates Faradic Efficiencies for simulated and experimental tested asymmetric BPMs in accordance with an embodiment.

FIG. 25C illustrates simulated concentration profiles of varying CL materials in accordance with an embodiment.

FIG. 25D illustrates simulated current density for various WD pathways in accordance with an embodiment.

FIGS. 26A through 26D illustrate current density performance of asymmetric BPMs with various AEL and CEL thickness in accordance with an embodiment.

FIG. 27 illustrates voltage of asymmetric BPMs with varying GrOx catalyst load weights in accordance with an embodiment.

FIG. 28 illustrates a schematic of graphene oxide and functional groups on Graphene oxide.

FIGS. 29A and 29B illustrate the XPS of GrOx in accordance with an embodiment.

FIGS. 30A and 30B illustrate the simulated local pH across an asymmetric BPM in accordance with an embodiment.

FIG. 31 illustrates asymmetric BPMs with varying AEL and/or CEL thickness and/or varying CL loading weights in accordance with an embodiment.

FIG. 32 illustrates simulated Nyquist plots for thin AEL BPMs with varying GrOx load weights at 50 mA/cm² in accordance with certain embodiments.

FIGS. 33A and 33B illustrate simulated RWD of asymmetric BPMs with varying GrOx CL load weights in accordance with an embodiment.

FIGS. 34A through 34F illustrate SEM images of asymmetric BPMs with varying GrOx CL layers in accordance with an embodiment.

FIGS. 35A through 35H illustrate optical images of asymmetric BPMs with varying GrOx CL layers in accordance with an embodiment.

FIGS. 36A through 36C illustrate schematics of GrOx coverage for asymmetric BPMs with varying GrOx CL layers in accordance with several embodiments.

FIG. 37 illustrates a T-peel test of BPMs in accordance with certain embodiments.

FIGS. 38A through 38F illustrate current density and voltage of asymmetric BPMs with varying GrOx CL layers in accordance with an embodiment.

FIGS. 39A through 39F illustrate temperature distribution inside an electrodialysis cell stack at varying current densities in accordance with an embodiment.

FIG. 40 illustrates a simulated mesh dependence study in accordance with an embodiment.

FIG. 41 illustrates a simulated control volume analysis across the CL of an asymmetric BPM in accordance with an embodiment. The change in proton flux and hydroxide flux across the CL are equivalent due to the stoichiometric nature of WD. Because Na+ and Cl⁻ are not generated or consumed by any buffer reactions, there is no net change in their flux across the CL.

FIG. 42 illustrates the simulated calculated change in proton and hydroxide flux across the CL of an asymmetric BPM along with the integration of the proton and hydroxide source terms. The integrated source terms are equivalent to the change in flux in accordance with an embodiment.

FIG. 43 illustrates the simulated change in flux across the CL of an asymmetric BPM plotted alongside the measured proton and hydroxide flux measured at the reference electrodes to demonstrate flux-matching. Generation of protons and hydroxides via WD occurs within the CL in accordance with an embodiment.

FIGS. 44A and 44B illustrate the simulated Cl⁻ and Na⁺ flux measured at different regions of the model of an asymmetric BPM in accordance with an embodiment. The Cl⁻ and Na⁺ fluxes remain constant throughout, as there is no generation or consumption of these species via homogeneous reactions.

FIG. 45 illustrates the simulated integration of catalyzed water dissociation pathways within the WD catalyst layer in accordance with an embodiment. The fluxes of protons and hydroxides due to each pathway are stoichiometrically linked. The rates of the first and second step in each of the catalyzed WD pathways are equal.

FIG. 46A illustrates the simulated fixed charge in an asymmetric BPM as a function of position for entire simulated domain in accordance with an embodiment.

FIG. 46B illustrates the simulated fixed charge in an asymmetric BPM as a function of position for the simulated CL domain in accordance with an embodiment.

FIG. 47A illustrates simulated total catalyst site distribution (c_{[Gr]}⁰(x)) in an asymmetric BPM as a function of position for the entire simulated domain in accordance with an embodiment.

FIG. 47B illustrates simulated total catalyst site distribution (c_{[Gr]}⁰(x)) in an asymmetric BPM as a function of position for the simulated CL domain in accordance with an embodiment.

FIG. 48A illustrates simulated water concentration of an asymmetric BPM as a function of position for the entire simulated domain in accordance with an embodiment. Water concentration changes as a function of current density as BPM changes from Na⁺—Cl⁻ form to H⁺—OH⁻ form and water content increases.

FIG. 48B illustrates simulated water concentration of an asymmetric BPM as a function of position for the simulated CL domain in accordance with an embodiment.

FIG. 49A illustrates simulated relative permittivity of an asymmetric BPM as a function of position for the entire simulated domain in accordance with an embodiment. Permittivity changes as a function of current density as BPM changes from Na⁺—Cl⁻ form to H⁺—OH⁻ form and water content increases.

FIG. 49B illustrates simulated relative permittivity of an asymmetric BPM as a function of position for the simulated CL domain in accordance with an embodiment.

FIG. 50 illustrates a titration curve of 0.1 M NaOH 4001 and 10 mL of 10 g/L GrOx paste added to 20 mL NaOH 4002 with 0.1 M HCl.

FIG. 51 illustrate simulated (lines) and experimentally measured (markers) Faradaic efficiency for water dissociation of an asymmetric BPM in accordance with an embodiment.

FIG. 52A through 52D illustrate the simulated local electrostatic potential gradient across an asymmetric BPM in accordance with an embodiment.

FIG. 53 illustrates a simulated asymmetric BPM polarization curve using Onsager kinetics and exponential kinetics in accordance with an embodiment

FIGS. 54A through 54D illustrate simulated concentration profiles for various GrOx species within an asymmetric BPM CL in accordance with an embodiment. Solid lines represent concentrations of various GrOx sites. Dashed lines represent concentration of total sites present within an asymmetric BPM CL in accordance with an embodiment.

FIGS. 55A through 55D illustrate simulated concentration profiles for various GrOx species at the AEL-CL interface in accordance with an embodiment. Solid lines represent concentrations of various GrOx sites. Dashed lines represent concentration of total sites present within the BPM CL.

FIG. 56 illustrates average GrOx surface charge within the BPM CL in accordance with an embodiment.

FIG. 57A illustrates simulated profiles of local electric field throughout the BPM domain in accordance with an embodiment.

FIG. 57B illustrates simulated profiles of pH+pOH throughout the BPM domain in accordance with an embodiment.

FIG. 58A illustrates simulated profiles of local electric field throughout the CL domain of an asymmetric BPM in accordance with an embodiment.

FIG. 58B illustrates simulated profiles of pH+pOH throughout the CL domain of an asymmetric BPM in accordance with an embodiment.

FIG. 59A illustrates simulated rate enhancement

$$( \frac{{k}_{f} ( E )}{{k}_{r} ( E )} )$$

as a function of position within the CL domain of an asymmetric BPM in accordance with an embodiment.

FIG. 59B illustrates simulated rate enhancement

$$( \frac{{k}_{f} ( E )}{{k}_{r} ( E )} )$$

as a function of position at the AEL-CL junction of an asymmetric BPM in accordance with an embodiment.

FIG. 60 illustrates simulated total WD contribution terms for proton and hydroxide generation within the CL domain of an asymmetric BPM in accordance with an embodiment.

FIGS. 61A through 61D illustrate simulated WD contribution terms for proton and hydroxide generation within the CL domain of an asymmetric BPM with varying CL sites in accordance with an embodiment. The rates of the first and second step of each catalyzed pathway (i.e., R₁ and R_{1.5}) are equal and stoichiometrically linked.

FIG. 62 illustrates simulated BPM polarization curves for asymmetric BPMs with varying CL sites in accordance with an embodiment.

FIG. 63 illustrates simulated electric field maximums for asymmetric BPMs with varying CL sites in accordance with an embodiment.

FIGS. 64A through 64D illustrate simulated WD current density integrated within the CL for asymmetric BPMs with varying CL sites in accordance with an embodiments.

FIG. 65 illustrates polarization curves of asymmetric BPMs with varying CL thickness to show WD sensitivity to CL thickness in accordance with an embodiment.

FIG. 66A illustrates polarization curves of asymmetric BPMs with varying CL thickness and varying GrOx site concentrations in accordance with an embodiment.

FIG. 66B illustrates polarization curves of asymmetric BPMs with varying GrOx site concentrations and constant CL thickness in accordance with an embodiment.

### DETAILED DESCRIPTION OF THE INVENTION

Turning now to the drawings, asymmetric bipolar membranes (BPMs) in accordance with various embodiments are illustrated. In some embodiments, asymmetric bipolar membranes can be catalyzed. Many embodiments implement catalyzed asymmetric bipolar membranes in electrodialysis cells for carbon capture. Catalyzed asymmetric bipolar membranes in accordance with certain embodiments can be free standing, mechanically stable, and structurally intact during electrodialysis processes. In several embodiments, catalyzed asymmetric bipolar membranes are used for capturing carbon dioxide through direct ocean capture and/or direct air capture. Carbon capture processes in accordance with many embodiments can capture any dissolved inorganic carbon in a water source including (but not limited to): ocean, river, lake, reservoir, desalinated water, synthetic ocean water, and ocean water mimics. Water source can be pretreated with acidic and/or alkaline solutions, or can be used without pre-treatment. Examples of dissolved inorganic carbon include (but are not limited to): aqueous carbon dioxide, bicarbonate, carbonate, carbonic acid, minerals, and sediments.

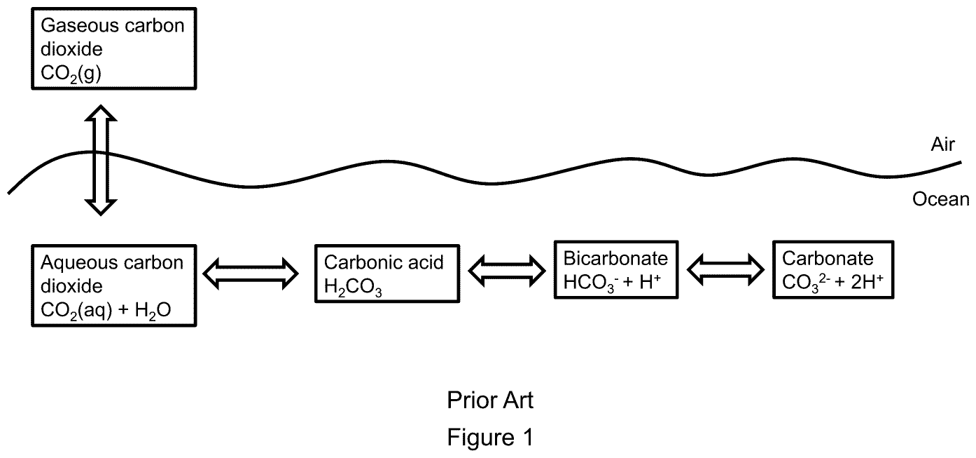

The ocean contains more carbon in the form of dissolved inorganic carbon than carbon dioxide (CO₂) in the atmosphere, in terms of moles per volume. The ocean is the largest inorganic carbon reservoir in exchange with atmospheric CO₂ and as a result, the ocean exerts a dominant control on atmospheric CO₂ levels. Dissolved carbon dioxide in the ocean occurs mainly in three inorganic forms: free aqueous carbon dioxide (CO₂(aq)), bicarbonate (HCO₃⁻), and carbonate ion (CO₃²⁻). The majority of dissolved inorganic carbon in the ocean is in the form of HCO₃⁻. FIG. 1 illustrates a schematic of dissolved inorganic carbon in the ocean. When CO₂ gas dissolves in the ocean, it interacts with the water to produce a number of different compounds according to Equation 1:

CO₂(aq)+H₂O↔H₂CO₃↔H⁺+HCO₃⁻↔2H⁺+CO₃²⁻ (1)

CO₂ reacts with water to produce carbonic acid (H₂CO₃), which then dissociates into bicarbonate (HCO₃) and hydrogen ions (H⁺). Bicarbonate can further dissociate into carbonate (CO₃²⁻) and an additional hydrogen ion.

One method for direct ocean capture through electrodialysis is to drive the CO₂-bicarbonate equilibrium or balance toward dissolved CO₂ by acidifying the seawater. The acidified stream can be passed through a liquid-gas membrane contactor, which captures the gaseous CO₂ from the dissolved CO₂ in the aqueous stream. Catalyzed BPMs in accordance with many embodiments enhance water electrolysis at BPMs. Increase in proton concentration as a result of water electrolysis push the equilibrium toward dissolved CO₂ such that carbon capture efficiency can be improved. BPM electrolysis cells can be used for efficient water splitting, CO₂ reduction, and direct ocean capture (DOC) of CO₂.

Conventional BPMs become unstable in electrodialysis cells when current densities are higher than about 100 mA/cm². Such BPMs are limited to lower current densities (less than about 100 mA/cm²) due to water transport limitations through the membranes, leading to failure at the junction region of the BPM. In order for CO₂ capture from ocean water using BPM electrodialysis system to be economically feasible, BPMs that can withstand current densities greater than or equal to 100 mA/cm² are needed.

Many embodiments implement catalyzed asymmetric BPMs that are stable at current densities greater than or equal to 100 mA/cm²; or greater than or equal to 200 mA/cm²; or greater than or equal to 300 mA/cm²; or greater than or equal to 400 mA/cm²; or greater than or equal to 500 mA/cm²; or greater than or equal to 600 mA/cm²; or greater than or equal to 700 mA/cm²; or greater than or equal to 800 mA/cm²; or greater than or equal to 900 mA/cm²; or greater than or equal to 1 mA/cm². Catalyzed BPMs in accordance with several embodiments can be operated at a voltage lower than or equal to about 1.5 V; or lower than or equal to about 1.0 V. Catalyzed BPMs in accordance with many embodiments exhibit voltage stability at extended periods of time such as (but not limited to) at least 60 hours; or at least 80 hours; or at least 100 hours; or at least 110 hours; or at least 120 hours; or at least 130 hours; or at least 140 hours; or at least 150 hours; or at least 500 hours; or at least 1000 hours; or greater than about 1000 hours. In certain embodiments, catalyzed asymmetric BPMs can sustain stable voltage at a current density of about 80 mA cm⁻² for at least 1100 hours; or at a current density of about 500 mA cm⁻² for about 100 hours; and/or at a current density of about 1 A cm⁻² for about 60 hours.

In many embodiments, asymmetric BPMs comprise a CEL and an AEL, where one of the layers is thinner than the other. In some embodiments, CELs can be thinner than AELs. In certain embodiments, AELs can be thinner than CELs. The thinner layer in asymmetric BPMs can allow for faster water transport at the CEL-AEL junction. The thinner layer can have a thickness of less than about 100 microns; or from about 15 microns to about 100 microns; or from about 15 microns to about 20 microns; or from about 20 microns to about 25 microns; or from about 25 microns to about 30 microns; or from about 30 microns to about 35 microns; or from about 35 microns to about 40 microns; or from about 40 microns to about 45 microns; or from about 45 microns to about 50 microns; or from about 50 microns to about 100 microns. Total thickness of asymmetric BPMs may range from about 50 microns to about 1 cm; or from about 50 microns to about 100 mm; or from about 50 microns to about 10 mm; or from about 50 microns to about 1 mm. Thicker BPMs may provide stronger mechanical support and form more stable membranes.

In several embodiments, asymmetric BPMs can be freestanding without external support such as (but not limited to) gaskets and/or clamps. Freestanding BPMs can have a thickness of at least about 50 microns; or at least about 70 microns; or at least about microns; or at least about 100 microns; or at least about 150 microns; or at least about 200 microns; or at least about 300 microns.

Various types of CEMs and AEMs can be used for CEL and AEL respectively. Any combination of CEM and AEM can be used in asymmetric BPMs. Several embodiments use commercial off-the-shelf CEMs and/or AEMs. Some embodiments use polymer powders and/or ionomers to form AEM and/or CEM. In several embodiments powders and/or ionomers can be cast via (but not limited to) spin coating to form layers of AEMs and/or CEMs. The thickness of AEMs and/or CEMs can be determined by scratching the spin coating deposited layer on a substrate and scanning with a profilometer. BPMs can be assembled by pressing CEMs and AEMs together using hands and/or tools such as (but not limited to) clamps, clips, or screws. In some embodiments BPMs can be fabricated via (but not limited to) spin coating, hot pressing, casting, sandwiching, and any combination thereof. Some embodiments modify CEMs and/or AEMs via (but not limited to) coating with ionomers before assembling to form BPMs. Ionomer modified CEMs and/or AEMs can be formed via processes including (but not limited to) drop casting, spin coating, spray coating, and any combinations thereof. Several embodiments form AEMs and/or CEMs using ionomers via processes including (but not limited to) drop casting, spin coating, spray coating, and any combinations thereof. In many embodiments the catalyst can be spin coated onto CEMs and/or AEMs and heated at an elevated temperature (of at least about 100° C.) for approximately a period of time (such as, at least 1 minute, at least 2 minutes, at least 5 minutes) to dry the catalyst ink. Spin coating and heating the catalyst can be repeated until the desired catalyst mass loading is reached. In many embodiments, when depositing catalyst ink or binding layers to dry membrane surfaces, water should be removed or dried quickly, otherwise the dry membrane can warp and wrinkle. In several embodiments, thermal stability of AEMs and/or CEMs at temperatures greater than about 40° C. is preferred when selecting membranes for BPMs. Thermal stability can prevent delamination of membranes during prolonged operation cycles of BPMs. In many embodiments, the AEM and/or CEM can be made of (but not limited to) polymers, perfluorosulfonic acid (PFSA)/polytetrafluoroethylene (PTFE) copolymer in the acid (H⁺) form, functionalized poly(aryl piperidinium) polymer, hydrocarbon resins, and poly(aryl piperidinium) resin. Asymmetric BPMs in accordance with certain embodiments choose an AEM that is stable in alkaline solutions. Examples of AEMs include (but are not limited to) SELEMION®, NEOSEPTA®, fumapem FAA, fumasep FAP, Sustainion® X37, Versogen® PiperION, Ionomr Aemion®, Fumasep membranes, Sustainion® membranes, Sustainion® ionomer, PiperION ionomer, and PiperION membranes. Examples of CEMs include (but are not limited to) Nafion, Nafion® ionomers, Nafion® membranes, and/or any of a variety of Nafion® membranes. Examples of ionomers include (but are not limited to) Nafion® D520 ionomer, and Versogen® PiperION-A5 ionomer. As can readily be appreciated, any of a variety of AEMs and/or CEMs and/or ionomers can be utilized as appropriate to the requirements of specific applications in accordance with various embodiments of the invention. In many embodiments CEM and/or AEM materials, CEM and/or AEM ionic conductivities, CEM and/or AEM thicknesses, BPM thickness, CEM and/or AEM modifications, and/or BPM formation methods can be selected in order to form structurally stable and free standing BPMs with desired current densities.

In various embodiments, asymmetric BPMs comprises a catalyst at the CEL and AEL junction. Catalysts can expedite water dissociation. Catalysts in accordance with many embodiments have a plurality of ionizable sites. Ionizable sites can be and/or modified with different electrically charged groups (positive charged and/or negative charged). Electrically charged groups can have different pKₐ and/or pK_{b} values such that ionizable sites can have different pKₐ and/or pK_{b} values. In several embodiments, ionizable sites can be (but not limited to) proton donating sites and/or proton withdrawing sites. Ionizable sites can be functional groups of polymers, nanomaterials, nanoparticles, mixture of various nanomaterials and nanoparticles, 2D materials, and any combinations thereof. Modification of ionizable sites should be compatible with other properties of catalysts such as (but not limited to) dielectric constant, rigidity of backbone materials. In many embodiments, catalysts with multiple pKₐ or pK_{b} values can generate a larger electric field at the AEM and CEM junction, compared to catalysts with a single pKₐ or pK_{b} value. The ability to generate larger electric field and to catalyze water dissociation reactions enable asymmetric BPMs with catalysts with desired properties to be used in electrodialysis cells. Such properties can include (but are not limited to) being structurally stable and intact when used under high current density (greater than or equal to 100 mA/cm²) for at least 60 hours. Examples of catalyst for asymmetric BPMs include (but are not limited to) two dimensional catalyst materials, graphene oxides, metal oxides, titanium-based multivalent catalysts, nanomaterials, polymers, and any combinations thereof. Certain embodiments use graphene oxides as catalysts for BPMs as graphene oxide has a low water dissociation overpotential and possesses ionizable sites with well-defined pKₐ values. Catalysts can be dissolved in water. Several embodiments dissolve catalysts in solutions comprising ionomers to improve adhesion to CELs and/or AELs. Dissolved catalysts can be deposited at the CEL-AEL junction via a variety of processes including (but not limited to) drop casting, spin coating, spray coating, and any combinations thereof. Uniform and flat catalyst morphology can improve AEL and/or CEL adhesion. In some embodiments, electrostatic forces due to electrically charged groups on catalysts can also improve adhesion of asymmetric BPMs and prevent delamination. Various loads such as (but not limited to) concentrations, weights, and/or number of layers can be selected to achieve optimal catalyst loading for asymmetric BPMs. Some embodiments vary mass loading of catalysts by changing number of layers of catalyst solution (or ink) spin-coated onto CEMs or AEMs during BPM fabrication. Catalyst layers can have various thickness ranging from about 10 nm to about 2000 nm; or from about nm to about 100 nm; or from about 10 nm to about 1000 nm; or from about 100 nm to about 1000 nm; or from about 200 nm to about 1000 nm; or from about 300 nm to about 500 nm. Catalyst materials (or combination of materials), catalyst concentrations, catalyst solutions, ionomer in catalyst solutions, catalyst thickness, and/or catalyst deposition methods can be selected in order to form uniform and stable catalyst layers to achieve stable BPMs with desired current densities.

Electric current can be applied to BPMs using electrodes such as anodes and cathodes. Cathodes can be connected with CELs and anodes connected with AELs under reverse bias. Cathodes can be connected with AELs and anodes connected with CELs under forward bias. Anodes and cathodes can have supporting electrolyte solution such as anolyte and catholyte, respectively. Cathodes and anodes can be made with various materials. Examples of electrode materials include (but are not limited to) metals, metal alloys, nickel, nickel based alloys, copper, copper based alloys, titanium, titanium based alloys, iron, iron based alloys, stainless steel, platinum, gold, silver, carbon, carbon cloth, glassy carbon, graphite, and any combinations thereof. Electrodes can be in various configurations such as (but not limited to) foils, films, layers, coatings, plates, and any combinations thereof. Electrodes can be of various sizes with at least one dimension ranging from 1 mm to about 100 cm. Examples of supporting electrolyte include (but are not limited to) NaCl—HCl solution, K₄Fe(CN)₆, K₃Fe(CN)₆, FeCl₂, FeCl₃, KOH, K₂CO₃, KHCO₃, NaCl, and any combinations thereof.

In many embodiments, catalyzed asymmetric BPMs can be integrated in various electrodialysis cells including (but not limited to) H cells, flow cells, cell stacks, and any combinations thereof. BPMs are mechanically and structurally stable in order to be freestanding in electrodialysis cells. Electrodialysis stacks can be formed through the configuration of multiple ion exchange membranes between anodes and cathodes. A zero-cell stack in accordance with some embodiments can include a BPM with two electrolyte outer chambers. In several embodiments, a one-cell, two-cell, three-cell, etc. stack has a group of membranes (an AEM, CEM, and BPM in this order) repeating within the zero-cell stack, one, two, three, etc. times. In many embodiments, a single-cell stack can comprise of a BPM, AEM, CEM, and a BPM from anode to cathode. In many embodiments, a single-cell stack comprises of an anode, an anolyte chamber, a CEM, a dilute chamber, an AEM, an acid chamber, a BPM, a base chamber, a CEM, a catholyte, and a cathode.

In various embodiments, asymmetric BPMs can be free standing without external support such as (but not limited to) gaskets. BPMs are mechanically stable throughout the operation of electrodialysis cells. CEMs and/or AEMs can expand when hydrated during water dissociation. Many embodiments choose CEMs and/or AEMs with similar expansion ratio when hydrated in order to maintain structural stability of BPMs during operation. BPMs can achieve mechanical stability based on the overall thickness of the membrane. In several embodiments, the thicker layer of the asymmetric BPM contributes to the mechanical stability of the asymmetric BPM to allow for free standing operation. Many embodiments choose the thickness of AEMs and/or CEMs based on the overall thickness needed to maintain mechanical stability.

Many embodiments implement planar BPMs. BPMs can be in various sizes with a planar active surface area ranging from about 1 cm² to about 1 m²; or from about 1 cm² to about 10 cm²; or from about 10 cm² to about 50 cm²; or from about 50 cm² to about 1 m²; or greater than about 1 m².

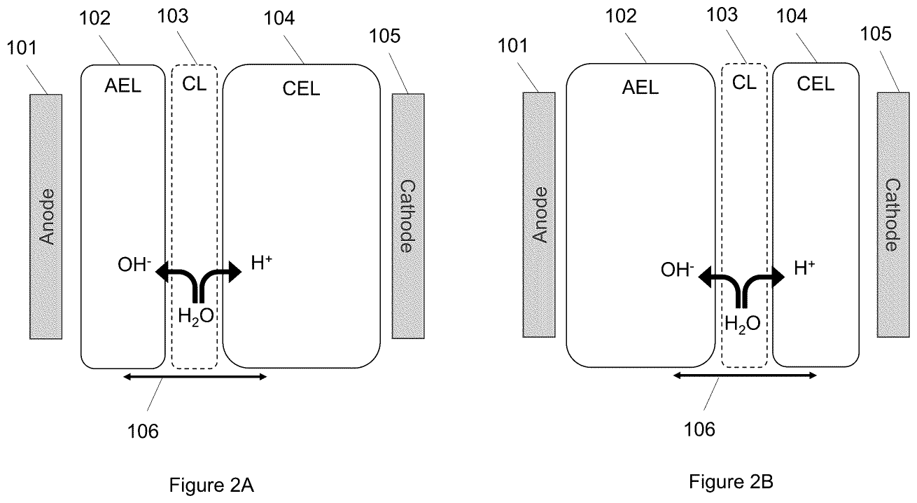

FIGS. 2A and 2B conceptually illustrate catalyzed asymmetric BPMs in accordance with an embodiment. FIG. 2A illustrates a catalyzed asymmetric BPM with a thinner AEL 102 and a thicker CEL 104. AEL 102 can have a thickness from about 15 microns to about 100 microns. CEL 104 can have a thickness greater than AEL 102. Catalyst layer (CL) 103 can be formed between the AEL 102 and CEL 104 at the bipolar junction 106. Water can be dissociated into protons and hydroxide ions (H₂O↔H⁺+OH⁻) at the bipolar junction 106. Thinner AEL 102 improves water transport rate at the junction such that asymmetric BPMs have higher current densities compared to symmetric configurations. CL 103 comprises a catalyst that expedites water dissociation reactions at the bipolar junction 106.

FIG. 2B illustrates a catalyzed asymmetric BPM with a thicker AEL 102 and a thinner CEL 104. CEL 104 can have a thickness from about 15 microns to about 100 microns. AEL 102 can have a thickness greater than CEL 104. Catalyst layer 103 can be formed between the AEL 102 and CEL 104 at the bipolar junction 106. Water can be dissociated into protons and hydroxide ions (H₂O↔H⁺+OH⁻) at the bipolar junction 106. Thinner CEL 104 improves water transport rate at the junction such that asymmetric BPMs have higher current densities compared to symmetric configurations. CL 103 comprises a catalyst that can expedites water dissociation reactions at the bipolar junction 106.

Under reverse bias, an anode 101 can be formed next to the AEL 102, and a cathode 105 can be formed next to the CEL 104. When a current is applied across a BPM, ionic current can be carried by H⁺ and OH⁻ ions generated via water dissociation at the junction 106. As ions cannot transport across BPMs, the generated H⁺ can transport through CEL 104 and OH⁻ can transport through AEL 102.

As can be readily appreciated, asymmetric BPMs can have various configurations with varying membrane materials, membrane layer thickness, membrane deposition processes, catalyst loading processes, catalyst materials, use of ionomers at the junction and/or in catalyst solution, and/or deposition methods for catalyst. BPMs can be fabricated by pressing AEM and CEM together, or cast from ionomers, or spin coated from ionomers, or any combinations of the proceeding methods thereof.

Asymmetric catalyzed BPMs can be incorporated in electrodialysis cells for various applications. Examples of such applications can include (but are not limited to) long duration energy storage, electrochemical conversion reactions, water splitting reactions, carbon dioxide reduction reactions, electrochemical applications that are under high current densities, carbon capture, direct ocean capture, and/or direct air capture.

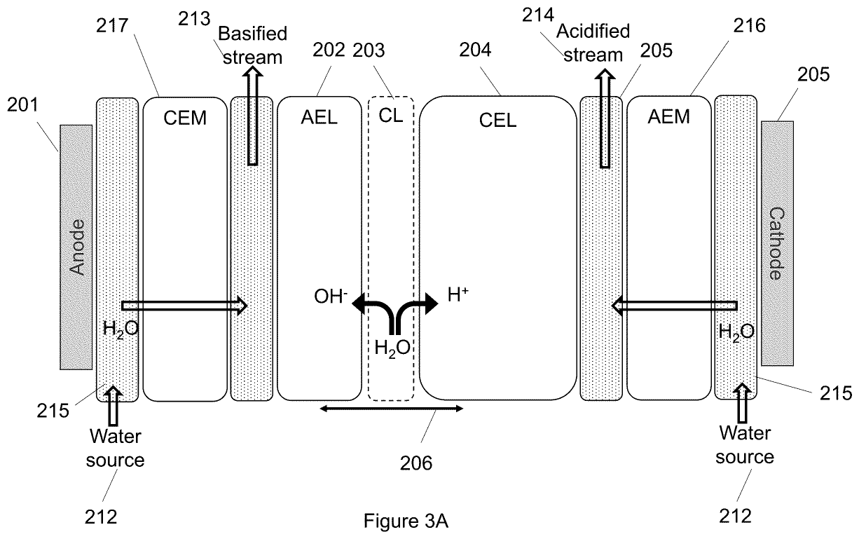

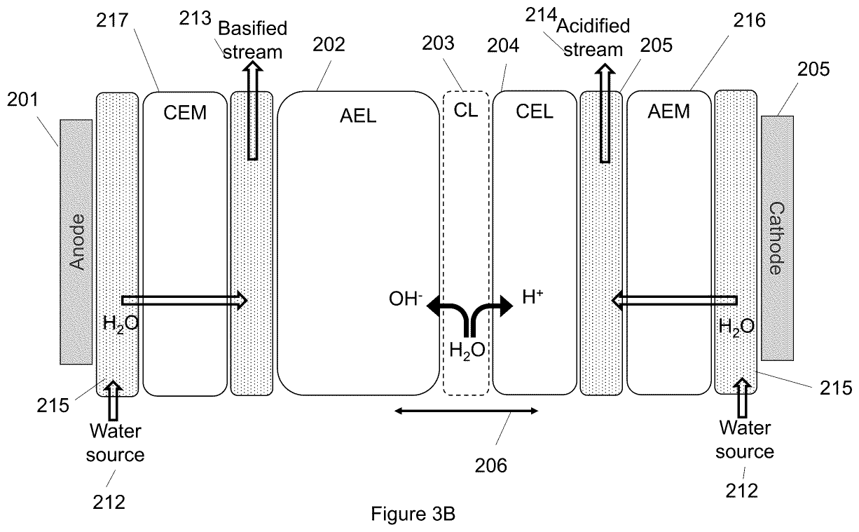

Many embodiments incorporate catalyzed asymmetric BPMs in direct ocean capture. BPMs in accordance with several embodiments are stable under electrodialysis cell operation conditions and can achieve current density of at least about 100 mA/cm² with an applied voltage of less than about 1.5 V. FIGS. 3A and 3B conceptually illustrate catalyzed asymmetric BPMs for DOC configured into a 3-compartment electrodialysis cell in accordance with an embodiment of the invention. FIG. 3A illustrates a catalyzed asymmetric BPM with a thinner AEL 202 and a thicker CEL 204. FIG. 3B illustrates a catalyzed asymmetric BPM with a thicker AEL 202 and a thinner CEL 204. Catalyst layer (CL) 203 can be formed between the AEL 202 and CEL 204 at the bipolar junction 206. Water can be dissociated into protons and hydroxide ions (H₂O↔H⁺+OH⁻) at the bipolar junction 206. Thinner AEL 202 (or CEL 204) improves water transport rate at the junction such that asymmetric BPMs have higher current densities compared to symmetric configurations. CL 203 comprises a catalyst that can expedites water dissociation reactions at the bipolar junction 206.

Under reverse bias, ionic current can be carried by H⁺ and OH⁻ ions generated via water dissociation at the junction 206. As ions cannot transport across BPMs, the generated H⁺ can transport through CEL 204 and OH⁻ can transport through AEL 202. At the CEL-AEL junction 206, mobile protons and hydroxides from the CEL and AEL react to form water, neutralizing the mobile ions to generate a space-charge depletion region of a few nanometers, which can result in a strong electric field on the order of 10⁸ to 10⁹ Vm⁻¹. Under reverse bias, the electric field present at the junction 206 accelerates water dissociation via the Second Wien Effect, allowing for enhanced production of H⁺ and OH⁻, which provide ionic currents through the CEL 204 and AEL 202 and enable buildup of pH gradients across the BPM. Catalysts in the CL 203 can increase the electric field by accelerating water dissociation.

Oceanwater has an innate pH of about 8.1. The native oceanwater can be pretreated using an oceanwater pretreatment system. The pretreated (or native) oceanwater can be acidified by adding acids to bring the pH down to less than or equal to about 4. Water source 212 (such as native oceanwater or acidified oceanwater) can be added to a water channel 215 on the CEL 204 side of the asymmetric BPMs. Bicarbonate ions (HCO₃⁻) in native oceanwater can react with H⁺ and form CO₂. An AEM 216 is placed between the CEL 204 side of the asymmetric BPM and the water channel 215 to prevent the movement of H⁺ ions out of the acidified stream 214. The acidified stream 214 can be collected and/or neutralized before returning the partially decarbonized water back to the ocean. The generated gaseous CO₂ can be collected later for industrial applications and/or other applications. Water source 212 can be added to a water channel 215 on the AEL 202 side of the asymmetric BPMs. A CEM 217 is placed between the AEL 202 side of the asymmetric BPM and the water channel 215 to prevent movement of OH⁻ ions out of the basified stream 213. CO₂ can react with OH⁻ and form HCO₃⁻. The basified stream 213 can be collected for industrial applications and/or other applications. In many embodiments, water source 212 can enter the system simultaneously or independently. In several embodiments the acidified stream 214 can be collected as acidified oceanwater for further decarbonation treatment. In many embodiments the acidified stream 214 can be cycled through the same electrodialysis cell or different electrodialysis cells in the stack as water source 212. In several embodiment acidified and/or native ocean water can be inputted through water channels 215. In many embodiments acidified oceanwater can be added to one water channel while native oceanwater is added to a different water channel; or acidified oceanwater can be added to all water channels; or native oceanwater can be added to all water channels.

The described apparatuses, systems, and methods should not be construed as limiting in any way. Instead, the present disclosure is directed toward all novel and nonobvious features and aspects of the various disclosed embodiments, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods, systems, and apparatuses can be used in conjunction with other systems, methods, and apparatus.

Systems and methods for catalyzed asymmetric BPM systems in accordance with various embodiments of the invention are discussed further below.

### Catalyzed Asymmetric Bipolar Membrane

BPMs can be used for electrochemical technologies such as water electrolysis, CO₂ conversion, and carbon removal. BPMs can be integrated into salt-water fed electrodialysis cells used for pH swing-based direct air capture (DAC) or extraction of dissolved inorganic carbon from ocean water for direct ocean capture (DOC) and ocean deacidification. In many embodiments, catalyzed asymmetric BPMs can withstand high current densities operations under reverse bias and stay stable in electrodialysis cells. Such BPMs can stay intact and operable in separated acidic and alkaline environments in electrodialysis cells. The ability to sustain large differences in pH allows for cathode and anode local reaction environments that are desired for attaining high activity, selectivity, and stability of electrocatalysts based on earth-abundant elements. In several embodiments, BPMs can operate at current densities of greater than or equal to about 500 mA cm⁻²; or greater than or equal to about 1 A cm⁻², and under voltages of less than or equal to about 1.5 V.

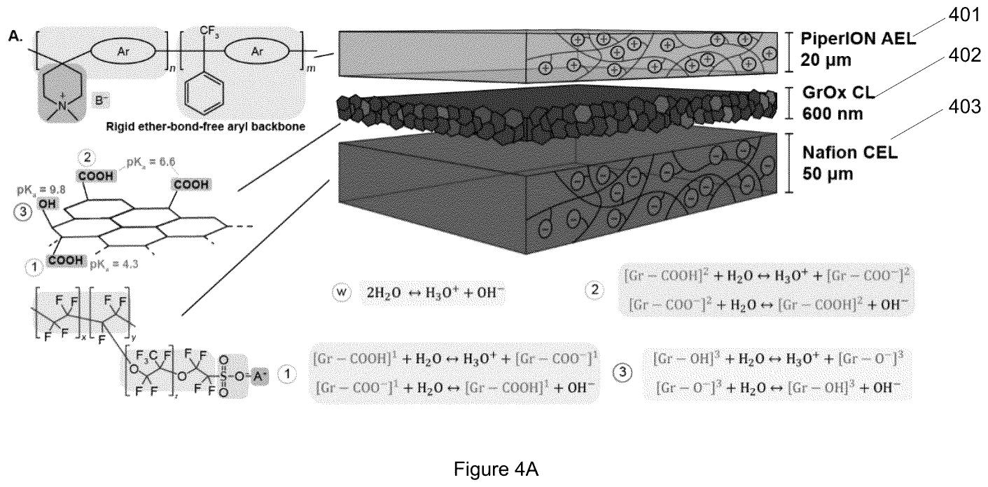

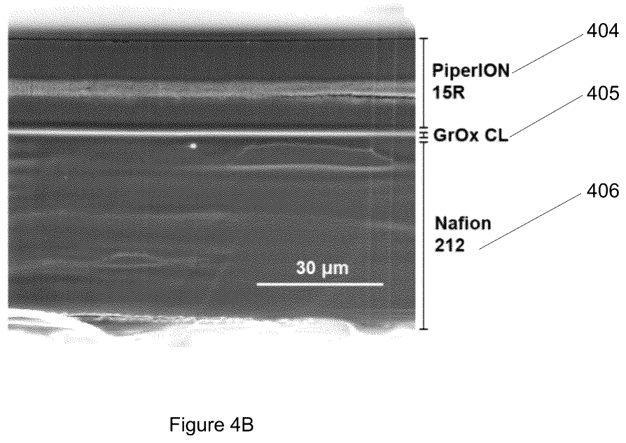

Many embodiments implement BPMs comprising CELs including (but not limited to) Nafion® 212, AELs including (but not limited to) PiperION® A15R, and water dissociation (WD) catalysts including (but not limited to) graphene oxide (GrOx). FIG. 4A illustrates a catalyzed asymmetric BPM in accordance with an embodiment of the invention. FIG. 4B illustrates a cross sectional scanning electron microscope image of the BPM layers in accordance with an embodiment. The catalyzed asymmetric BPM includes a Nafion® 212 CEL 403 with a thickness of about 50 μm), a PiperION® A15R AEL 401 with a thickness of about 20 μm), and a GrOx WD catalyst layer 402 with a thickness from about 200 nm to about 1000 nm. Chemical structures of each layer of the GrOx catalyzed asymmetric BPM, along with relevant catalytic WD enhancement reactions are shown. The thinner AEL and incorporation of GrOx catalyst enables BPM to overcome water transport limitations and enable operation at high current densities of greater than or equal to about 500 mA cm⁻². GrOx has three ionizable sites with well-defined pKₐ values. BPM can operate above the thermodynamic potential needed for WD, with an overpotential of less than about 250 mV at about 1 A cm⁻². BPM can operate for over about 1100 hours operation at a current density of about 80 mA cm⁻², and/or over about 100 hours at a current density of about 500 mA cm⁻², and/or over about 60 hours at a current density of about 1 A cm⁻². The performance indicates effective water transport through the BPM and stability of CEL/AEL junction.

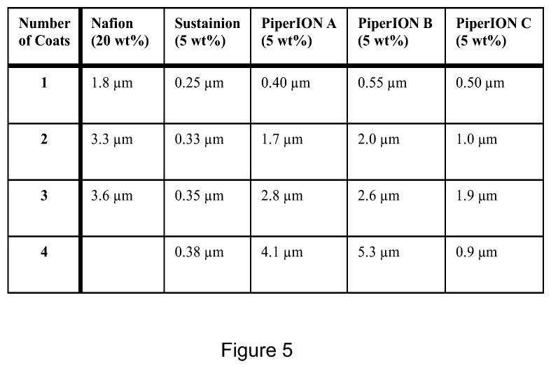

FIG. 5 illustrates measured membrane thickness in accordance with an embodiment. Membrane thickness can vary from about 200 nm to about 4 microns depending on membrane materials and number of layers deposited.

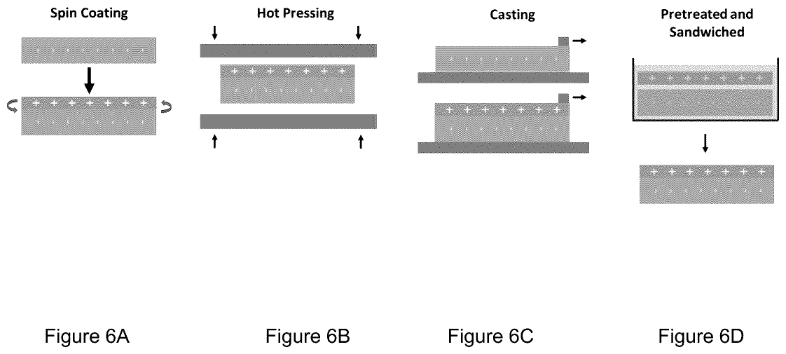

FIGS. 6A through 6D conceptually illustrate non-limiting BPM fabrication methods. FIG. 6A conceptually illustrates spin coating an AEM onto a CEM to form a BPM. FIG. 6B conceptually illustrates hot pressing an AEM and a CEM together to form a BPM. FIG. 6C conceptually illustrates casting a CEM on a substrate followed by casting an AEM onto the CEM. FIG. 6D conceptually illustrates sandwiching a pretreated AEM to a pretreated CEM.

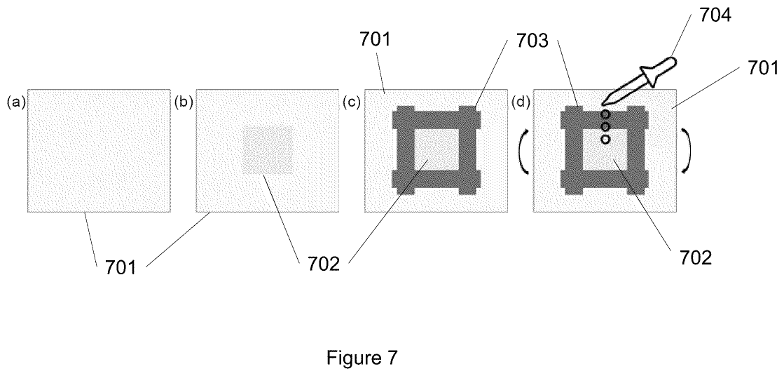

FIG. 7 illustrates a process, in accordance with an embodiment, for fabricating a BPM. The process includes placing a pretreated CEM 702 on a clean glass slide 701 and dabbing dry with a Kimwipe®; taping four sides 703 with the membrane flat such that there are no air pockets between the glass slide and the membrane; drop coating a catalyst 704 onto the CEM after spinning has begun to prevent wetting and wrinkling of the membrane; placing the catalyst coated CEM in an oven at about 100° C. for approximately 2 minutes to fully dry the catalyst ink; repeating the spin coating and baking of the catalyst until desired mass loading is reached; cutting the CEM just inside the tape to rewet the membrane; gently place a wetted AEM on top of the catalyst coated CEM; and smooth out any bubbles. In some embodiments, the process for fabricating a BPM further comprises, using Nafion® ionomer as a binder between the CEL and AEL and applying a heat treatment to fully laminated BPMS. In some embodiments the GrOx catalyst inks are made with Nafion® and PiperION® ionomers as binding agents. In several embodiments the AEM and/or CEM are fabricated with Nafion® or PiperION® membranes. In some embodiments, the catalyst inks with Nafion® ionomers remain well dispersed and suspended while the catalyst inks with PiperION® ionomer form aggregates within the ink.

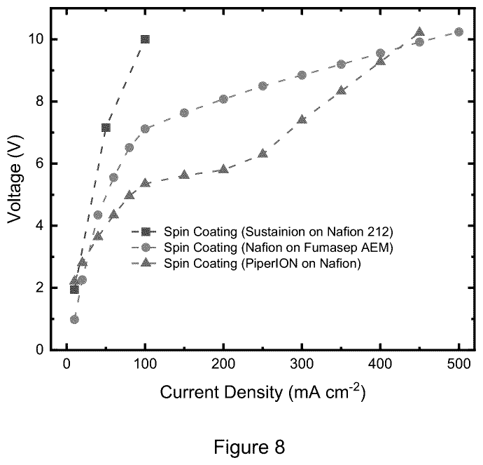

FIG. 8 illustrates the voltage at different current densities of various spin coated BPMs. Sustainion® AEM spin coated on a Nafion® 212 CEM reaches a high voltage (about 10 V) at a low current density (less than about 100 mA/cm²). Nafion® CEM spin coated on a Fumasep® AEM operates under a similar voltage range to PiperION® AEM spin coated on a Nafion® CEM when current density is between about 400 mA/cm² and about 500 mA/cm². PiperION® AEM spin coated on a Nafion® CEM can operate at a lower voltage when current density is between about 100 mA/cm² and about 400 mA/cm².

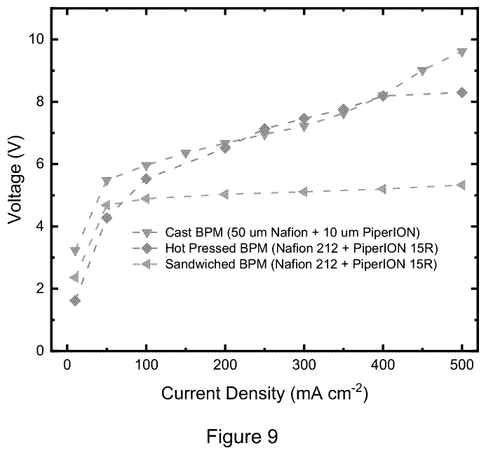

FIG. 9 illustrates the voltage at different current densities of Nafion® CEM and thinner Piperlon® AEM BPM fabricated via casting, hot pressing, and sandwiching. BPM performance in an electrodialysis cell can be impacted by BPM fabrication methods. Hot pressed Nafion® 212 to PiperION® 15R has a similar voltage range as cast 50 μm Nafion® to 10 μm PiperION® when current density is between about 0 mA/cm² and about 400 mA/cm². Sandwiched Nafion® 212 CEM to PiperION® 15R can operate at a lower voltage range (less than about 5 V) when current density is between about 100 mA/cm² and about 500 mA/cm². Altering the fabrication method can lower the operation voltage at higher current densities of the BPM.

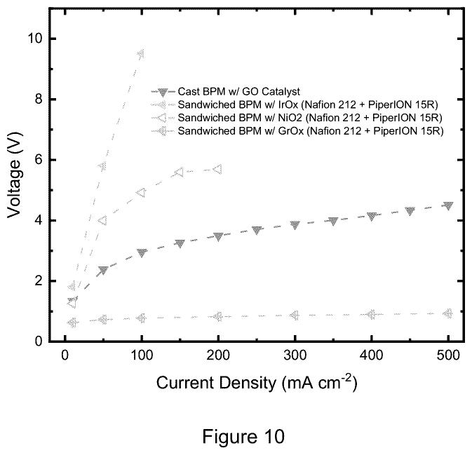

FIG. 10 illustrates the voltage at different current densities of a BPM with various catalyst materials. The addition of a catalyst can lower the operation voltage of a BPM at higher current densities. Nafion® AEM and PiperION® CEM BPMs with various catalyst materials are compared. A Nafion® AEM and PiperION® CEM BPM sandwiched with a NiO₂ catalyst reaches high voltages (of about 6 V) when current density is less than about 200 mA/cm². A Nafion® AEM and PiperION® CEM BPM sandwiched with an IrOx catalyst reaches higher voltages (of about 10 V) when current density is less than about 100 mA/cm². A Nafion® AEM and PiperION® CEM BPM cast with a GO catalyst can operate at a low voltage (less than about 4 V) when current density is between about mA/cm² and about 500 mA/cm². A Nafion® AEM and PiperION® CEM BPM sandwiched with a GrOx catalyst can operate at a lower voltage (of less than or equal to about 1 V) when current density is between about 0 mA/cm² and about 500 mA/cm². The catalyst material can lower operating voltage ranges of a BPM in an electrodialysis cell.

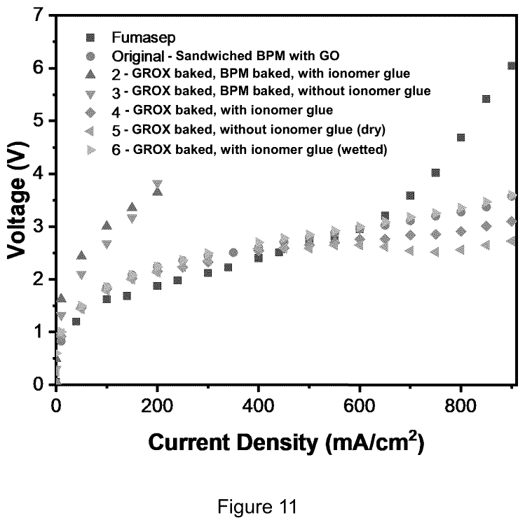

Nafion® ionomer can be used as a binder between CELs and AELs. A heat treatment can be applied to fully laminated BPMs to enhance adhesion. FIG. 11 illustrates the voltage at different current densities of differently heat treated BPMs with the addition of a Nafion® ionomer glue. During fabrication, the catalyst layer is deposited on the CEM or AEM. The catalyst loaded membrane is heated at an elevated temperature. The alternative AEM or CEM is then fabricated onto the heat treated membrane and catalyst. The alternative AEM or CEM can be fabricated with a Nafion® ionomer glue to aid in lamination. The fabricated BPM can be heated at an elevated temperature once the additional membrane has been added. The BPMs heat treated after lamination reach high voltages (of about 4 V) when current density reaches about 200 mA/cm². The BPM heat treated after lamination with the addition of a Nafion® ionomer glue ionomer has a similar voltage range (less than about 3 V) to a BPM heat treated after lamination without the addition of a Nafion® ionomer glue. A commercially available Fumasep® BPM reaches a high voltage (of about 6 V) when current density reaches about 800 mA/cm². The BPMs not heated after lamination operate at a lower voltage range (less than about 3 V) at a high current density region. A BPM with a GO catalyst has a similar voltage range (less than about 3.5 V) to a BPM fabricated with wetted Nafion® ionomer glue and a GrOx catalyst that is heat treated. A BPM fabricated with a Nafion® ionomer glue and a heat treated GrOx catalyst operates at a lower voltage (less than about 3 V) when current density is between about 0 mA/cm² and about 800 mA/cm². A BPM fabricated without a Nafion® ionomer glue and a heat treated GrOx catalyst operates at a lower voltage (less than about 3 V) when current density is between about 0 mA/cm² and about 800 mA/cm². A BPM fabricated with a Nafion® ionomer glue and a heat treated GrOx catalyst has a similar voltage range to a BPM fabricated without a Nafion® ionomer glue and a heat treated GrOx catalyst at low current density regions.

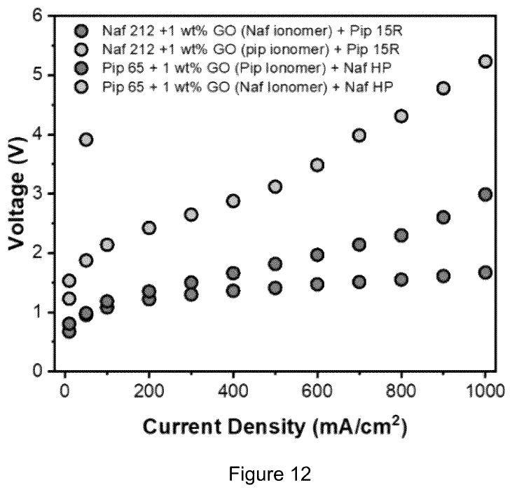

Ionomers can be added to catalyst materials. The ionomers can serve as binding agents. The addition of an ionomer to a catalyst material can aid in lamination. The addition of the ionomer to the catalyst ink can operate at a lower voltage at higher current densities. In several embodiments GrOx catalyst inks are made with Nafion® ionomer. In some embodiments catalyst inks are made with PiperION® ionomers. BPMs are fabricated with Nafion® CEM and PiperION® AEM as the original membrane that the catalyst is spin coated onto. FIG. 12 illustrates the voltage at different current densities of BPMs fabricated in various membranes and ionomer combinations. A Nafion® 212 CEM and PiperION® 15R AEM BPM with a GO catalyst with PiperION® ionomers reaches a high voltage (of about 4 V) when current density is less than about 100 mA/cm². A Nafion® HP CEM and PiperION® 65 AEM BPM with a GO catalyst with Nafion® ionomers can operate at a high voltage (of less than or equal to about 5 V) when current density is less than or equal to about 1000 mA/cm². A Nafion® HP CEM and PiperION® 65 AEM BPM with a GO catalyst with PiperION® ionomers can operate at a lower voltage (less than or equal to about 3 V) when current density is less than or equal to about 1000 mA/cm². A Nafion® 212 CEM and PiperION® 15R AEM BPM with a GO catalyst with Nafion® ionomers can operate at a lower voltage (less than or equal to about 1.5 V) when current density is less than or equal to about 1000 mA/cm². A Nafion® HP CEM and PiperION® 65 AEM BPM with a GO catalyst with PiperION® ionomers has a similar voltage range to a Nafion® 212 CEM and PiperION® 15R AEM BPM with a GO catalyst with Nafion® ionomers when current density is less than or equal to about 400 mA/cm².

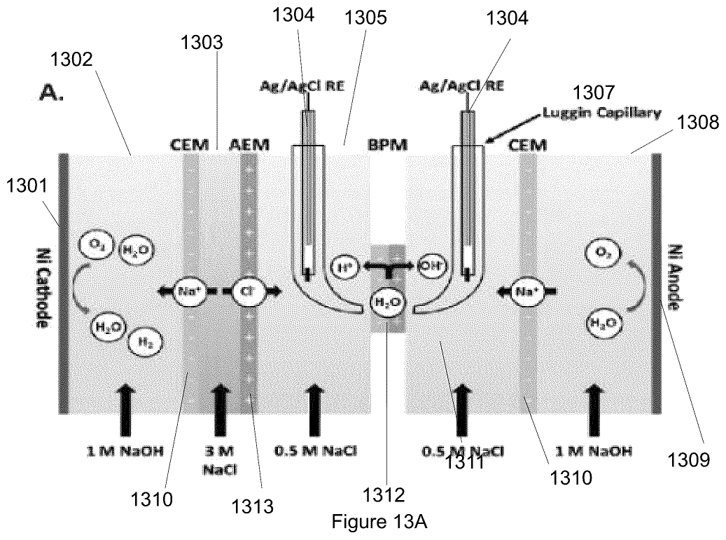

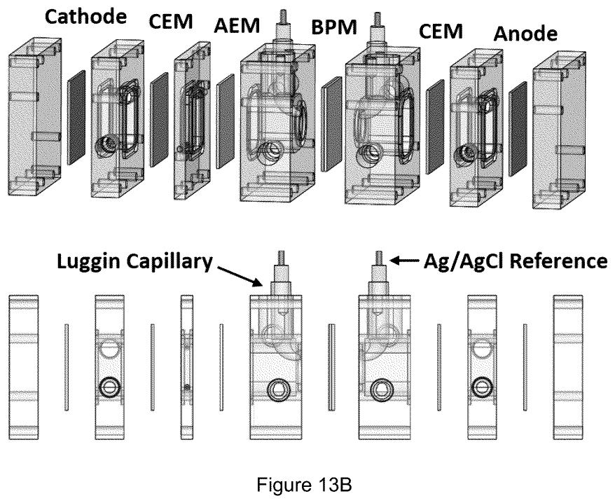

To accurately understand the performance of BPMs for electrodialysis, several embodiments implement custom made electrodialysis cells to measure BPM performance. It is important to be able to directly measure the voltage across the BPM without interference from electrolyte resistance or redox reactions. Luggin capillaries with reference electrodes can be implemented into H-Cells to measure the BPM voltage as close to the surface of the membrane as possible. However, in a H-Cell configuration, equilibrium at each applied current density cannot be reached as the acid and base concentration will continue to increase (especially directly at the surface of the BPM) for the duration the bias is applied. To overcome these challenges for electrochemical testing of BPMs, a custom electrodialysis cell with embedded Luggin capillaries in accordance with some embodiments can allow electrolyte to be flowed through each chamber. FIG. 13A illustrates cross section schematic of electrodialysis cell designed for direct testing of BPMs in accordance with an embodiment. FIG. 13B illustrates a schematic of flow cell in accordance with an embodiment. The custom-made, 5-chamber electrodialysis flow cell includes Luggin capillaries 1307, reference electrodes 1304, anode 1309, cathode 1301, and flow channels (not shown). Luggin capillaries 1307 with Ag/AgCl reference electrodes 1304 are implemented to allow for direct measurement of the BPM voltage without interference from electrolyte resistance. The tips of the capillary tubes are placed approximately 0.1 mm from the surface of the BPM 1312. The BPM 1312 active area in the custom cell is about 1 cm². The AEM 1313, CEMs 1310, anode 1309, and cathode 1301 have an active area of about 4 cm². To guarantee equilibrium during experiments, fresh solution is continuously flowed through each chamber of the electrodialysis cell and the acid/base chambers can be agitated using small magnetic stir bars with a plate placed under the cell.

Since the concentration of acid and base increases as current density is stepped up, the solution conductivity increases as well. Thus the solution iR drop cannot be accurately calculated directly from the initial salt conductivity. As equilibrium can be achieved in the custom electrodialysis cell by flowing and stilling the acid and base chamber solutions, Equation S9 can be implemented to calculate the ohmic contribution from the acid and base solutions. In Equation S9 J is the current density, Kₛₒₗᵤₜᵢₒₙ is the conductivity of NaCl, HCl, or NaOH based on the current density and flow rate, and d is the distance of the Luggin capillary tips from the BPM surface (about 0.01 cm). Furthermore, the calculated equilibrium acid and base concentrations are used with Equation S10 to calculate the Nernstian thermodynamic potential necessary for WD at a specific current density and flow rate. The final iR contributions, from the AEL and CEL, are then calculated using Equation S11 along with membrane conductivity values measured using a four-point probe system.

$${G}_{{H}^{+}} = \frac{{I}_{applied}}{n F} \qquad ( S1 )$$

$${[ {H}^{+} ]}_{a d d e d} = \frac{{G}_{{H}^{+}}}{{Q}_{0 \text{.5} M NaCl}} \qquad ( S2 )$$

$${[ {H}^{+} ]}_{present} = {10}^{- 6.85} \qquad ( S3 )$$

$${[ {H}^{+} ]}_{theoretical} = {[ {H}^{+} ]}_{a d d e d} + {[ {H}^{+} ]}_{present} \qquad ( S4 )$$

$${G}_{O {H}^{-}} = \frac{{I}_{applied}}{n F} \qquad ( S5 )$$

$${[ {OH}^{-} ]}_{a d d e d} = \frac{{G}_{O {H}^{-}}}{{Q}_{0 \text{.5} M NaCl}} \qquad ( S6 )$$

$${[ {OH}^{-} ]}_{present} = \frac{1 {0}^{- 13.71}}{1 {0}^{- 6.85}} \qquad ( S7 )$$

$${[ {OH}^{-} ]}_{theoretical} = {[ {OH}^{-} ]}_{a d d e d} + {[ {OH}^{-} ]}_{present} \qquad ( S8 )$$

$$i {R}_{solution} = \frac{J * d}{{κ}_{solution}} \qquad ( S9 )$$

$${E}_{W D , T h e r m o} = 0.0 \; 59 ( {pH}_{b a s e} - {pH}_{a c i d} ) = 0.0 \; 59 Δ pH \qquad ( S10 )$$

$$i {R}_{AEM / CEM} = \frac{J * Δ x}{{κ}_{AEM / CEM}} \qquad ( S11 )$$

$${Efficiency}_{W D} = \frac{{E}_{WD , Thermo}}{{V}_{B P M}} \times 100 \qquad ( S12 )$$

Using accurate pumps to set specific flow rates, Equations S1-S8 can be used to calculate the theoretical concentration of H⁺ and OH⁻ in the acid and base chambers of the electrodialysis cell.

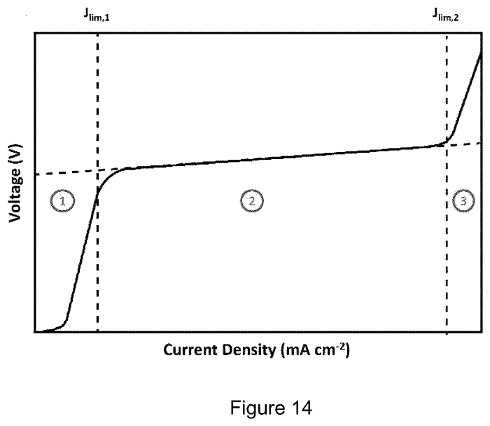

FIG. 14 illustrates current density vs. voltage curve for asymmetric BPMs in reverse bias in accordance with an embodiment. In region 1, the current is dominated by co-ion crossover. In region 2, the current is dominated by migration of water dissociation products. In region 3, the current is dominated by water transport limitations. These regions are divided by the limiting currents, J_{lim,1} and J_{lim,2}.

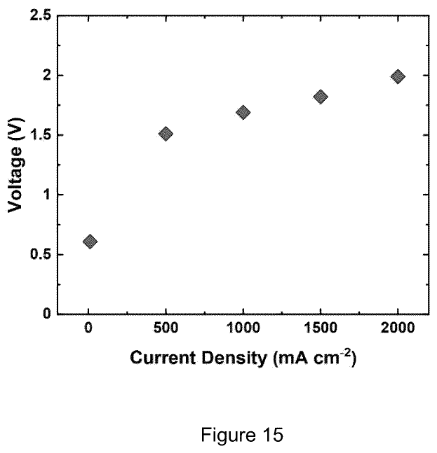

FIG. 15 illustrates current density vs. voltage curve of thin AEL BPM with 75 μg cm⁻² of GrOx ink at the BPM junction operated up to 2 A cm⁻² in accordance with an embodiment. The thin AEL BPM structure is shown in FIG. 4A.

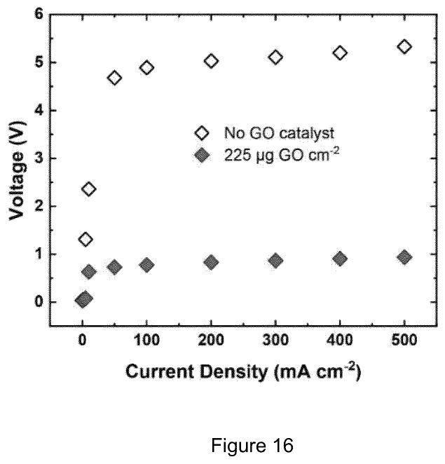

FIG. 16 illustrates current density vs. voltage of GrOx catalyzed, asymmetric BPM compared to same BPM construction without GrOx catalyst at the junction in accordance with an embodiment. The lower voltage of the catalyzed BPM demonstrates that although WD is enhanced due to the electric field at the AEL/CEL junction, implementation of a catalyst at the BPM inner layer can further enhance the rate of WD. The catalyst layer enables low operating overpotentials.

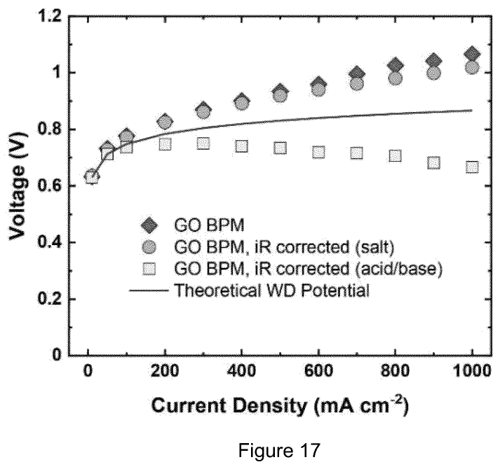

FIG. 17 illustrates iR drop effect of asymmetric BPM in various solutions in accordance with an embodiment. FIG. 17 shows GrOx catalyzed, asymmetric BPM voltage as measured (diamonds), voltage minus iR calculated based on salt conductivity (squares), and voltage minus iR calculated based on acid/base conductivity (circles). This shows calculating solution resistance voltage contributions is affected based on the changing conductivity as the solutions are acidified and basified.

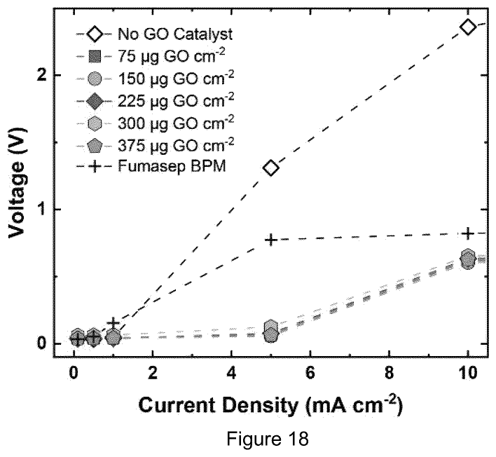

FIG. 18 illustrates current density vs. voltage plot comparing GrOx BPMs to BPM without catalyst and Fumasep BPM at low currents in accordance with an embodiment. BPMs with GrOx show greater co-ion leakage than those without GrOx.

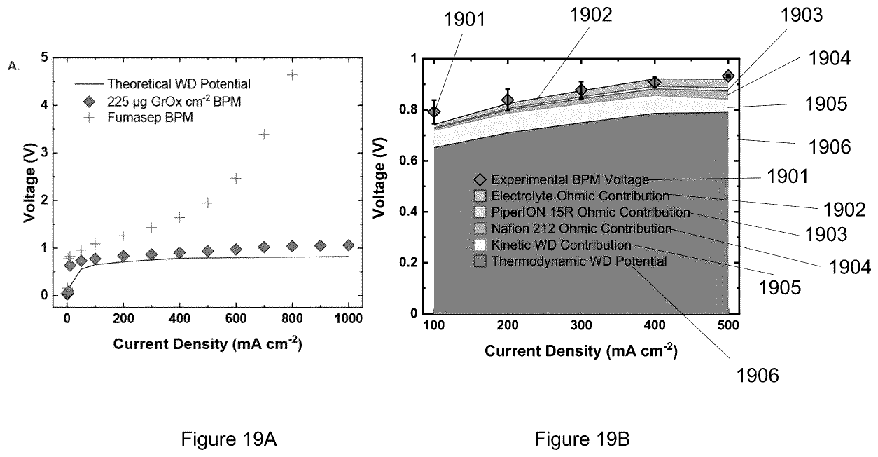

FIGS. 19A and 19B illustrate performance of GrOx catalyzed, asymmetric BPM in accordance with an embodiment. FIG. 19A shows polarization curves for BPM (about 225 μg cm⁻² GrOx loading) and the commercial Fumasep BPM, tested in the custom electrodialysis cell, compared to the thermodynamic potential for WD. The ability to operate BPMs at high current densities and low voltages is desirable as it enables greater production of acid and base at lower capital and operating costs. The GrOx catalyzed, asymmetric BPM operates under 1 V across current density ranges from about 80 mA cm⁻² to about 1000 mA cm⁻². In contrast, the performance of the Fumasep® BPMs may be limited by either water transport or WD kinetics at current density higher than about 300 mA cm⁻².

FIG. 19B illustrates the sum of voltage contributions due to WD potential CEL ohmic losses 1904, AEL ohmic losses 1903, and electrolyte ohmic losses 1902 compared to measured performance 1901 of the BPM. FIG. 19B shows that most of the voltage for the BPM may be due to the thermodynamic potential needed for WD, indicating that the BPM has been optimized for WD close to the maximum possible efficiency. The catalyzed asymmetric BPM has a calculated kinetic overpotential of about 126 mV at a current density of about 100 mA cm⁻², a calculated kinetic overpotential of about 144 mV at a current density of about 500 mA cm⁻², a calculated kinetic overpotential of about 242 mV at a current density of about 1 A cm⁻², and a calculated kinetic overpotential of less than about 250 mV at a current density of about 1 A cm⁻². The total overpotential for high current density operation could be further reduced by making the CEL layer thinner or by increasing the ion-exchange capacity of both the CEL and AEL component.

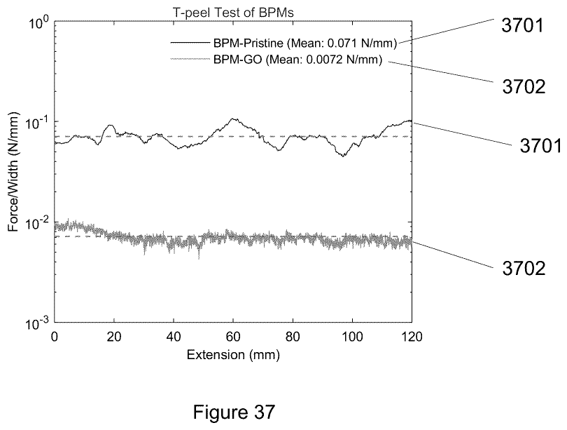

The Nafion® CEL and PiperION® AEL BPMs in accordance with various embodiments show great mechanical adhesion likely due to strong electrostatic interactions. No obvious delamination of the AEL and CEL is observed. The catalyzed asymmetric BPMs can be mechanically and chemically stable under reverse bias operation as well as in acidic and basic environments. The uniform WD catalyst at the BPM junction minimally interferes with the adhesion between AELs and CELs. The asymmetric BPMs can be freestanding during operation without the need for additional mechanical support. One possibility for strong adhesion in the presence of the GrOx CL in asymmetric BPMs can be that the high conductivity of the GrOx enables the electrostatic forces between the AEL and CEL to maintain adhesion with minimal disruption. The strong layer-to-layer adhesion of the BPMs, resulting from the optimized combination of AELs, CELs, and CLs enables the BPMs to overcome the stability limitations due to membrane delamination. FIG. 37 illustrates T-peel tests of BPM adhesion. The BPM sample 3701 shows the strongest adhesion with the mean peel force being 0.071 N·mm⁻¹. The graphene-oxide sample 3702 shows an order of magnitude weaker adhesion which is about 0.0072 N·mm⁻¹, however, despite the decreased adhesion the experimental results indicate it is sufficient for free standing operation in the geometries. BPM fabricated with a TiO₂ catalyst layer is no longer adhered upon drying, thus the adhesion is so weak as to be nonexistent making a peel test impossible. This is illustrative of free-standing capabilities of BPMs with GrOx catalysts compared to typical metal-oxide water dissociation catalysts. Graphene oxide films with strong interfacial adhesion have been reported previously. The strong adhesion can perhaps be attributed to interfacial Van der Waals forces, hydrogen bonding interactions and other physiochemical properties. The amphiphilic nature of graphene oxide may increase the adhesion forces with the similarly amphiphilic ionomer membranes, as beneficial hydrophobic and hydrophilic interactions likely increase the adhesion energy. Alternatively, it is possible that the strong adhesion could be a result of GrOₓ being sufficiently conductive to screen the electrostatic adhesion interactions between the AEL and CEL, thus only minimally disrupting the adhesive forces.

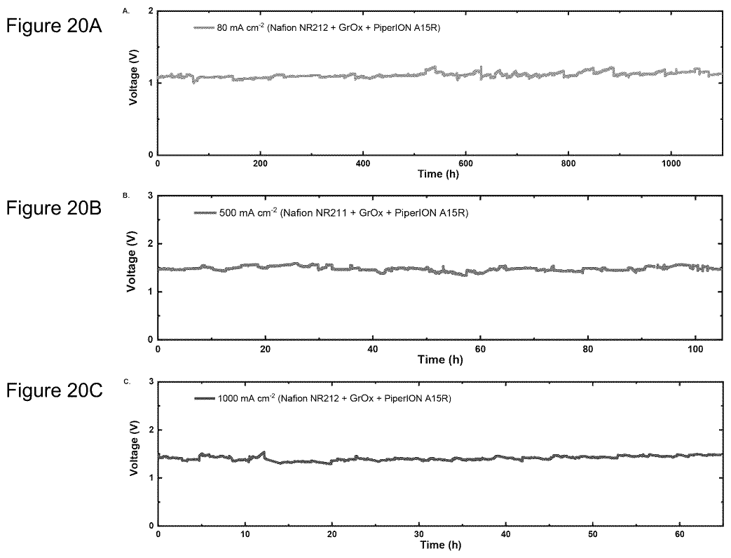

FIGS. 20A through 20C illustrate voltage stability of catalyzed asymmetric BPMs over time at various current densities in accordance with an embodiment. FIG. 20A shows the asymmetric BPM with stability of about 1100 hours at a current density of about 80 mA cm⁻². FIG. 20B shows the asymmetric BPM with stability of about 100 hours at a current density of about 500 mA cm⁻². FIG. 20C shows the asymmetric BPM with stability of about 60 hours at a current density of about 1000 mA cm⁻². The noise seen in the stability data can be due to the formation and eventual release of dissolved gas bubbles on the surface of the BPM. Furthermore, the presence of these bubbles at the BPM surface, which occur after about 1 hour of continuous applied current, leads to additional resistance and higher voltage.

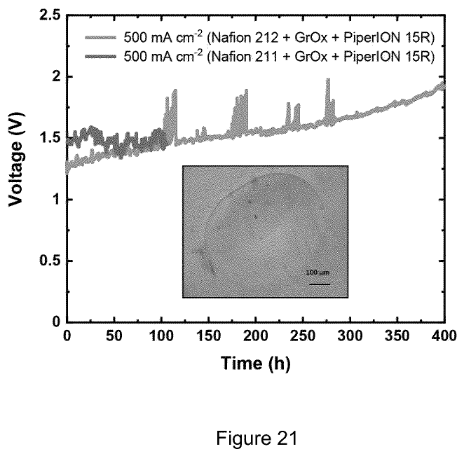

In some embodiments, multi-day tests of asymmetric BPMs may lead to elevated temperature (higher than about 40° C.) in the BPMs due to concentration of current through the custom electrodialysis cell. Elevated temperature over time may cause the membranes to warp and delaminate at the junction. FIG. 21 illustrates stability of BPMs of over 400 hours at 500 mA cm⁻² in accordance with an embodiment. Asymmetric BPM with Nafion® 211 has better stability and does not climb in voltage over time as Nafion® 212 membranes do. The picture insets depict the irreversible pitting and warping that occurs in the Nafion® 212 membranes due to high temperatures reached in the cell when testing at large current densities. The same pitting in the Nafion® 212 can be observed when membranes are heated in a furnace at about 150° C. for about 10 minutes. During chronopotentiometry experiments, the temperature measured in the bulk M NaCl electrolyte on either side of the BPM is about 35° C. at about 500 mA cm⁻² and about 50° C. at about 1 A cm⁻², indicating that BPM temperature is likely higher in itself.

To further understand possible temperature effects on the membranes, 3D modeling of the custom electrodialysis cell can be performed using COMSOL®. These models indicate that the temperature in the BPM is reaching an estimated 42° C. at about 500 mA cm⁻² and about 80° C. at about 1 A cm⁻². From these temperature measurements and modeling results, heating in the membrane due to high current densities may be the cause of the membrane deformation leading to slow delamination and voltage ramping in stability tests. During heating tests with various membranes, Nafion® 211 does not exhibit deformation compared to Nafion® 115 and Nafion® 117.

Several embodiments implement catalyzed asymmetric BPMs in electrodialysis cells of various types and sizes. In certain embodiments, electrodialysis cells can be H-cells and/or cell stacks. Electrodialysis cells can have active areas from about 1 cm² to about 6 cm² (with the full size of the BPM of about 35 cm²). FIGS. 22A and 22B illustrate catalyzed asymmetric BPMs tested in single cell electrodialysis stack in accordance with an embodiment. FIG. 22A shows a schematic of one-cell electrodialysis stack with 6 cm² active area. The cell stack is referred to as a one-cell electrodialysis stack and is analogous with the electrodialysis cells for acid and base generation. A zero-cell stack has a BPM with the two electrolyte outer chambers and a one-cell, two-cell, three-cell, etc. stack has a group of membranes (an AEM, CEM, and BPM in this order) repeating within the zero-cell stack, one, two, three, etc. times.

The scaled-thin AEL BPMs are tested in a zero-cell and one-cell stack. FIG. 22B shows experimental one-cell polarization curve for multi-cell stack with GrOx catalyzed, asymmetric BPM (dashed line), calculated voltages for each section of the one-cell stack at current densities of 10-500 mA cm⁻² (taller stacked bars), and calculated voltages for each section of a projected optimized one-cell stack (shorter stacked bars). The taller stacked bars in FIG. 22B show the calculated voltage values for each of these contributions. The grey error bars show the standard deviation for the AEM and CEM voltage contribution and the black error bars show the total standard deviation for the AEM and CEM voltage. All other voltage contributions do not have significant error. The sum of the calculated voltage contributions closely matches the experimental one-cell voltage for the 6 cm² active area BPM across all current densities, indicating that low operating overpotentials and similar performance at high current density operation are maintained for the scaled BPM.

Electrodialysis stack systems in accordance with some embodiments can be made with thicker membranes, gaskets, and/or solution chamber layers to prevent leakage between compartments in the cell. Certain embodiments use AEM of about 129 μm in thickness and CEM of about 125 μm in thickness. When thin AEM and CEM layers are used with this stack design, the overall stack may not be compressed enough and solution from separated gasket layers can leak between chambers. Optimization of the electrodialysis stack design can allow for increased compression such that thin AEM and CEM layers can be implemented. The shorter bars in FIG. 22B show the voltage contribution of each layer of a one-cell stack based on the conductivities of thinner AEMs, CEMs, and gaskets. With thinner membranes, the total cell voltage at 500 mA cm⁻² can be dropped from about 14 V to less than about 4 V.

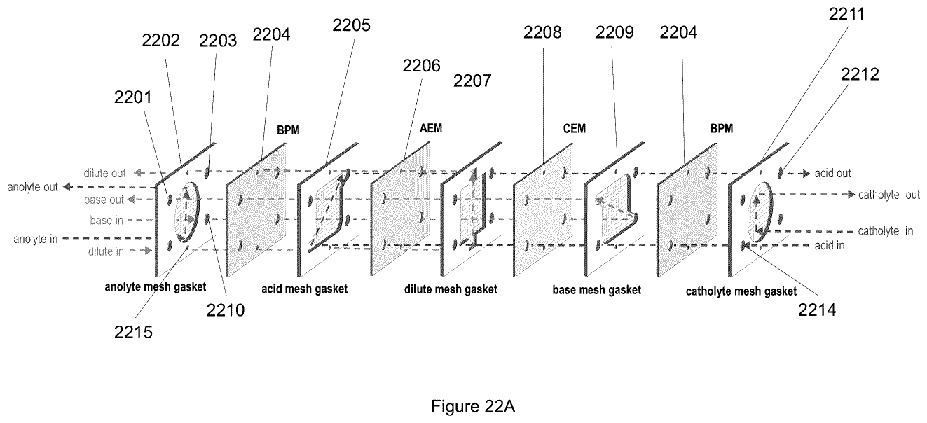

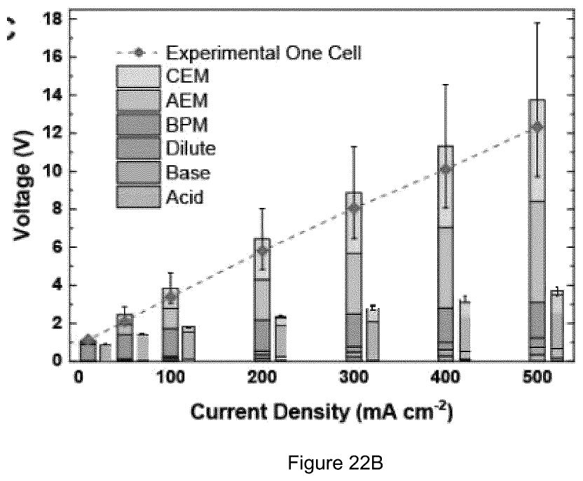

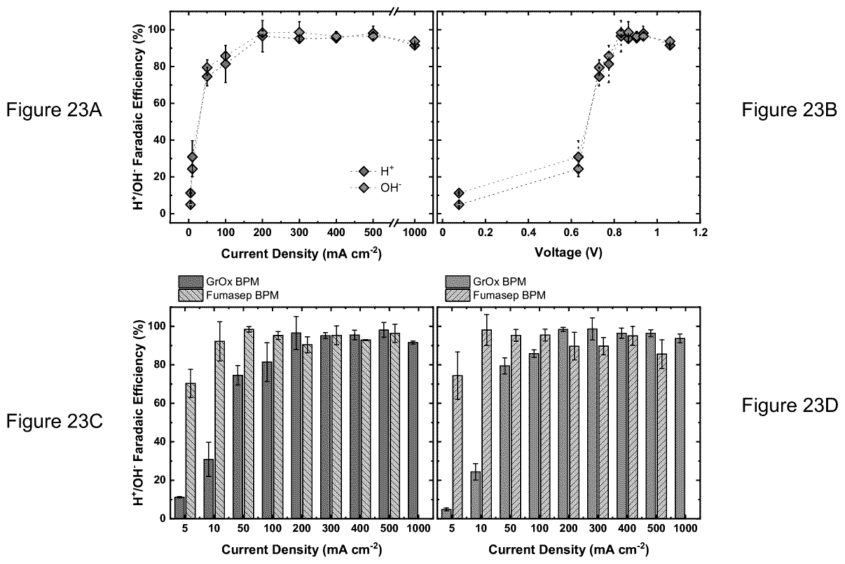

In addition to exhibiting scalability, low overpotentials, and exceptional stability at high current densities, catalyzed, asymmetric BPMs exhibit high Faradaic efficiencies (FEs, defined as the efficiency of the applied electronic current to generate protons and hydroxides via WD). FIGS. 23A and 23B illustrate Faradaic efficiency for H⁺ and OH⁻ vs. current density and voltage for catalyzed asymmetric BPMs in accordance with an embodiment. The BPM has about 225 μg cm⁻² GrOx loading. As shown in FIG. 23A, catalyzed asymmetric BPMs have high Faradaic efficiencies for acid and base production at current density greater than about 200 mA cm⁻². Because of co-ion leakage through the thin AEL, FEs for H⁺ and OH⁻ generation are about 80% and lower at operating current densities lower than about 200 mA cm⁻² (or voltage lower than about 0.8 V, FIG. 23B). However, at current densities of greater than about 200 mA cm⁻² (or voltage higher than about 0.8 V), the FEs for H⁺ and OH⁻ generation are about 95%. This indicates that most of the current flowing through the cell goes to production of acid and base, as desired for the use of a BPM for DAC and DOC.

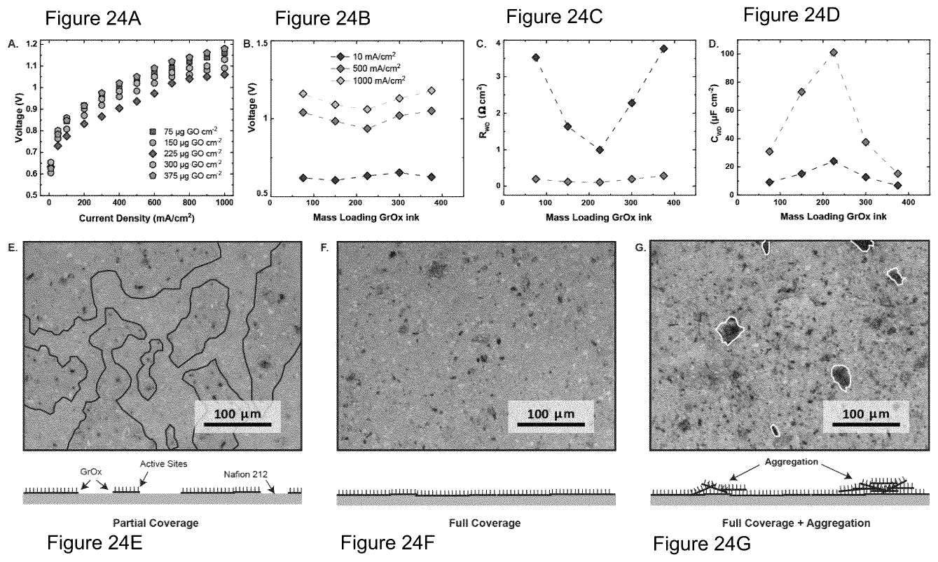

Several embodiments use varied catalyst loading in catalyzed asymmetric BPMs. Catalyst GrOx ink can be loaded to BPMs ranging from about 75 to about 325 μg cm⁻². Mass loading of catalysts can be varied by changing the number of layers of catalyst ink spin-coated onto the Nafion® CEL during BPM fabrication. FIGS. 24A through 24G illustrate effects of catalyst mass loading on WD enhancement in catalyzed asymmetric BPM in accordance with an embodiment. FIG. 24A shows polarization curves of BPMs with mass loading of about 75, about 150, about 225, about 300, and about 375 μg cm⁻² of GrOx ink. Voltage (FIG. 24B), RWD (FIG. 24C), and CWD (FIG. 24D) vs. GrOx mass loading at about 10, 500, and 1000 mA cm⁻² current density are shown. Optical images and supporting diagrams of (FIG. 24E) 1 layer of GrOx on Nafion® 212, showing partial coverage of active sites (outlined), (FIG. 24F) 3 layers of GrOx on Nafion® 212, showing full coverage, and (FIG. 24G) 5 layers of GrOx on Nafion® 212, showing full coverage and aggregation (outlined). An optimal mass loading of about 225 μg cm⁻² is observed in the polarization characteristics of the GrOx catalyzed, asymmetric BPMs, where further increasing or decreasing the mass loading may lower the BPM performance. FIG. 24C shows the relationship between the WD resistance, RWD, and the GrOx catalyst loading. The RWD is the lowest for the BPM at a catalyst mass loading of about 225 μg cm⁻², exhibiting an identical trend as demonstrated by the polarization characteristics in FIGS. 24A and 24B.

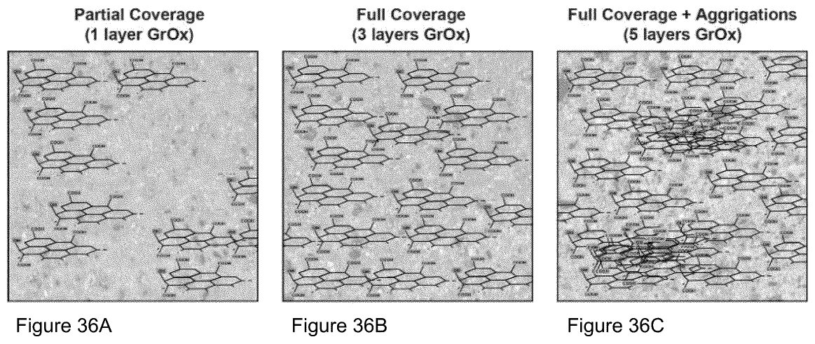

Similar trend can be observed for the BPM junction capacitance as a function of the GrOx catalyst loading in FIG. 24D, where the junction capacitance is maximized at a mass loading of about 225 μg cm⁻². As capacitance can be correlated with the number of (de)protonatable sites at the BPM junction, these data suggest a maximum number of catalytic sites for 3 layers of GrOx. Increased capacitance and activity from 1-3 layers of GrOx indicates that the catalyst coverage at the BPM junction is increasing, which is also supported by optical images and illustrations presented in FIGS. 24E through 24G. The optical images and supporting diagrams, also depict that upon introduction of layers 4 and 5, GrOx may aggregate, likely leading to the coverage of a percentage of the active sites available with 3 layers of GrOx. FIGS. 36A through 36C illustrate schematics of coverage level of GrOx based on number of spin coated layers in accordance with an embodiment. For one layer, the Nafion substrate is partially covered by GrOx. For three layers, full coverage is observed, increasing the number of active sites available for catalytic and electric field enhancement of WD. For 5 layers, aggregation of the GrOx begins, indicating that some of the previously available active sides are being buried within the aggregates.

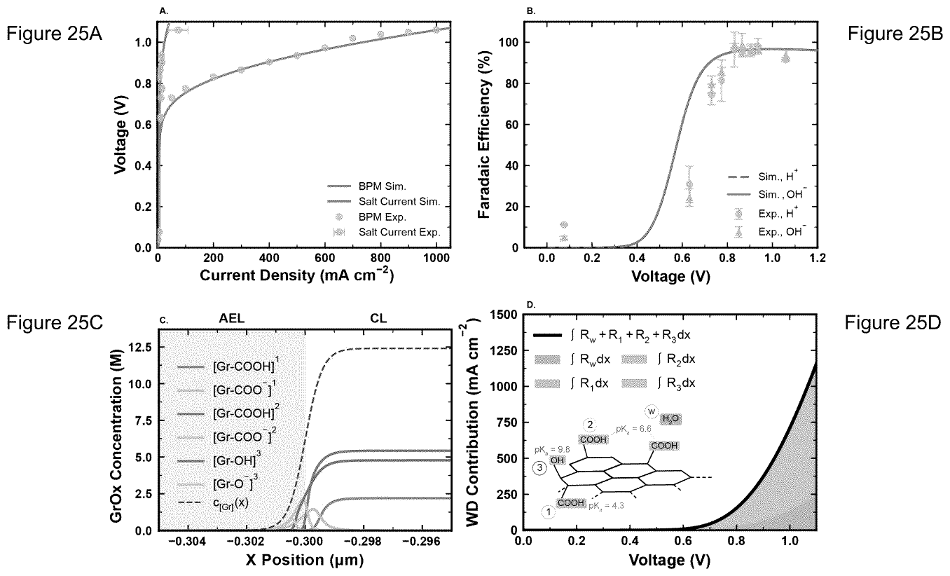

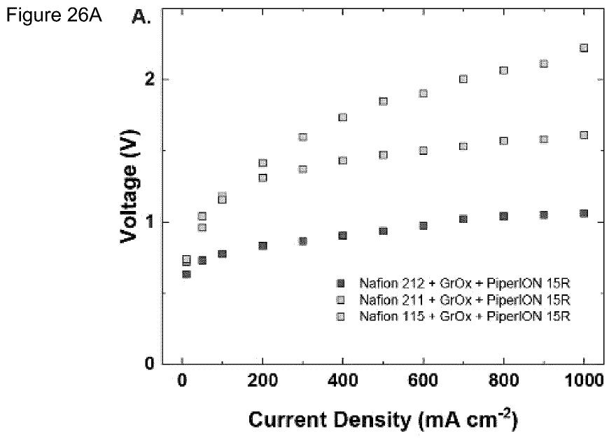

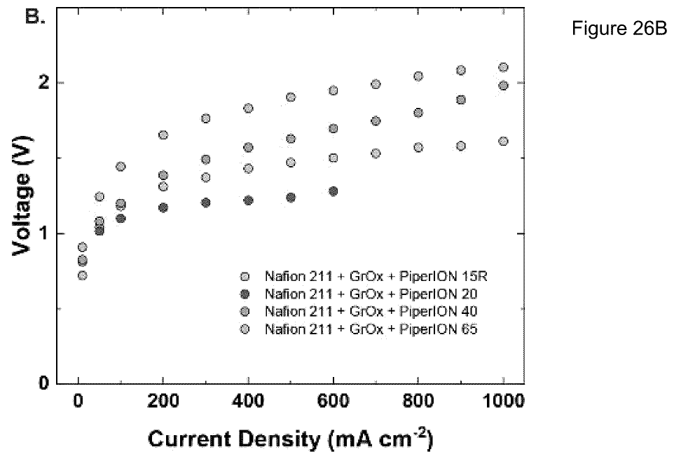

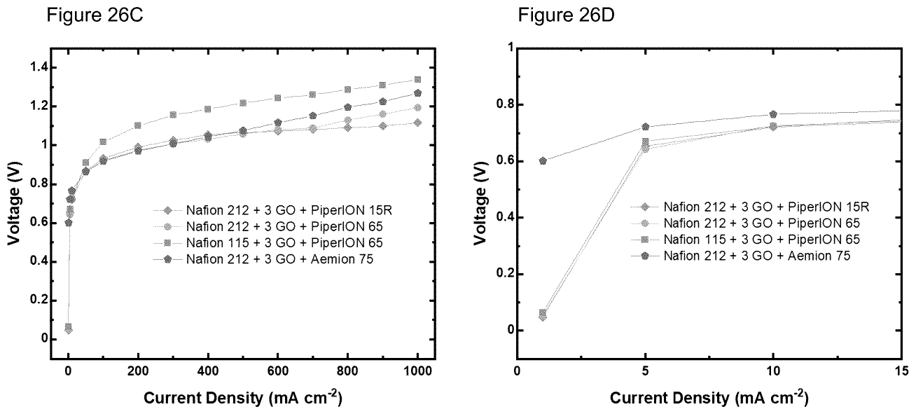

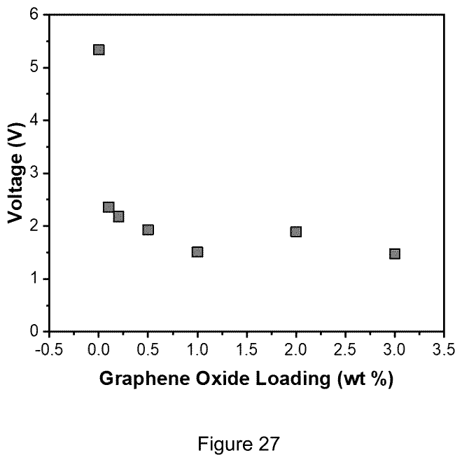

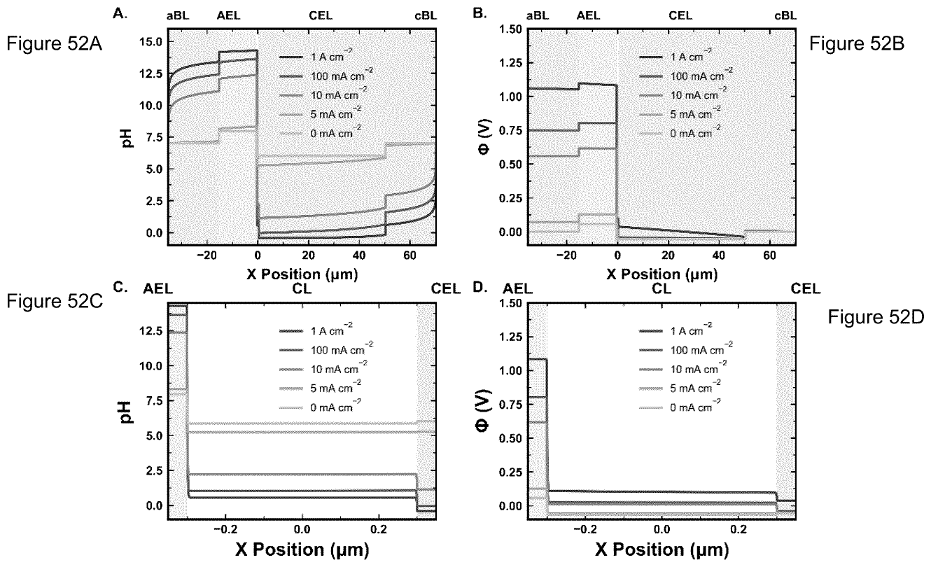

To elucidate the mechanism of WD within the BPM, as well as the sensitivity of the BPM performance to CL properties, a continuum-level model of the BPM can be developed. The model employs a continuum representation of mass conservation in which the species fluxes are defined by the Poisson-Nernst-Planck equations and homogeneous-phase bulk reactions in the BPM domain (i.e., WD) are described by mass-action chemical kinetics with electric-field enhancement. FIG. 25A illustrates the simulation of the electric-field enhanced WD in the CL and ionic transport in the polymer and electrolyte layers in accordance with an embodiment. FIG. 25A shows the experimental polarization curves of the GrOx-catalyzed, asymmetric BPM with a high degree of accuracy. The model is able to accurately simulate measured salt crossover and FEs for acid and base generation. FIGS. 52A through 52D illustrate the model used to define local pH and electrostatic potential profiles within the BPM and CL domains, demonstrating how the pH gradient within the BPM develops as voltage increases. It is observed that most of the pH and applied potential gradient occurs at the AEL-CL interface, suggesting that WD occurs primarily at this interface.

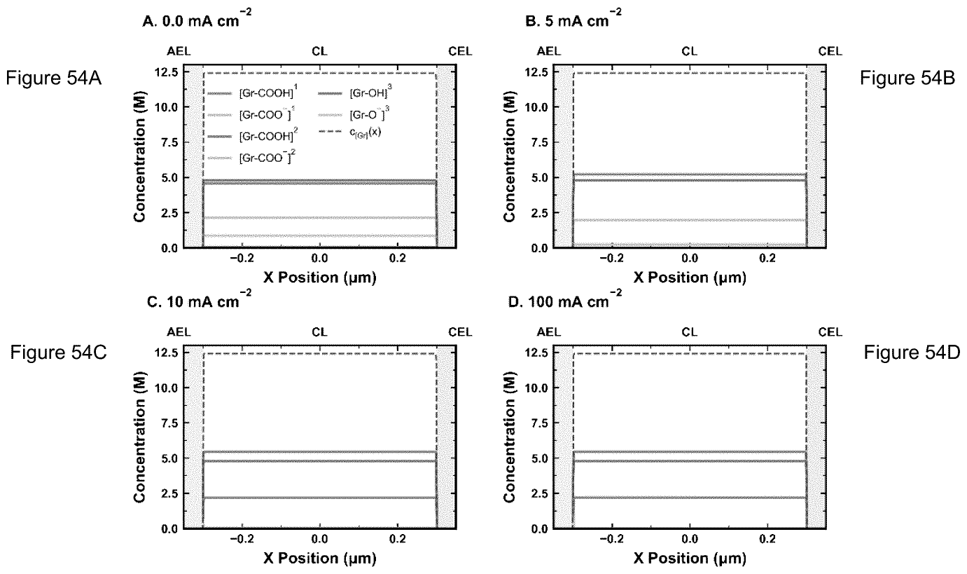

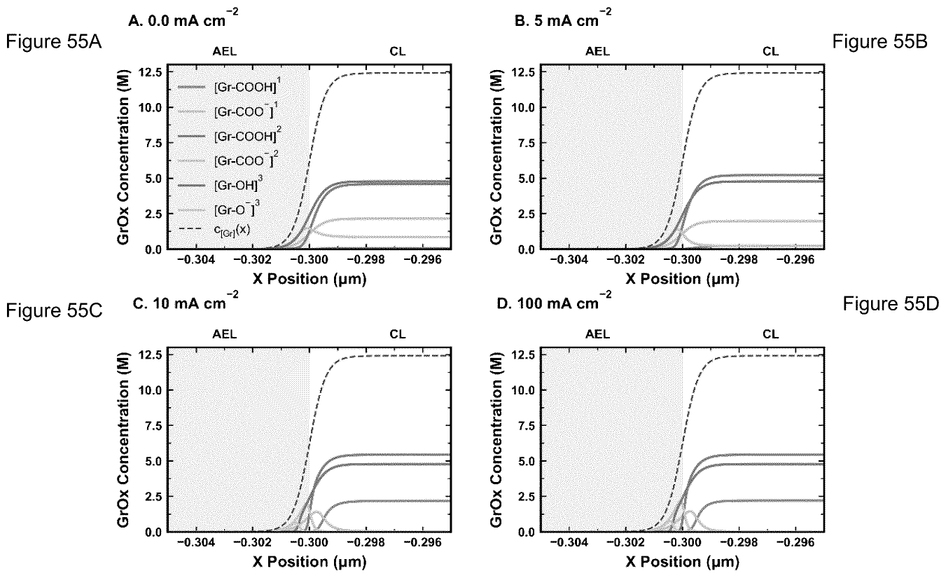

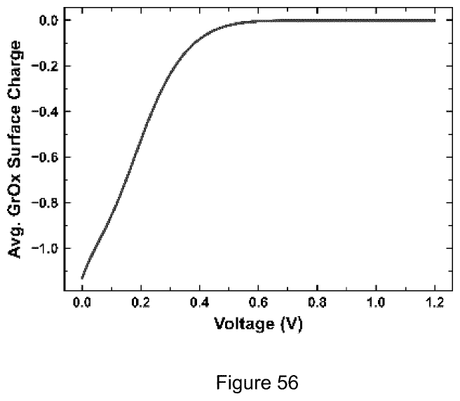

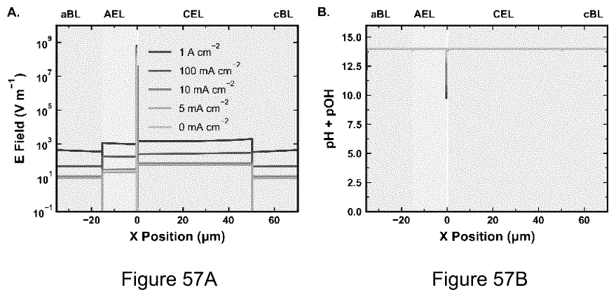

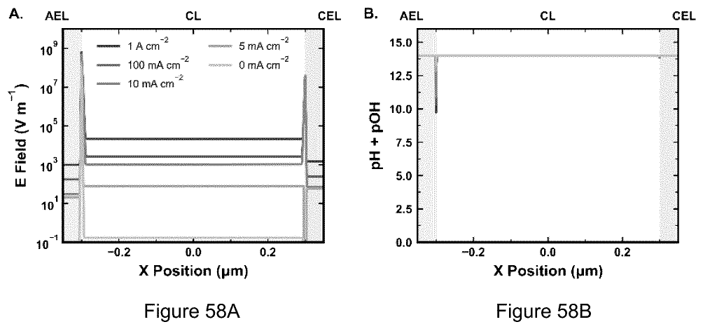

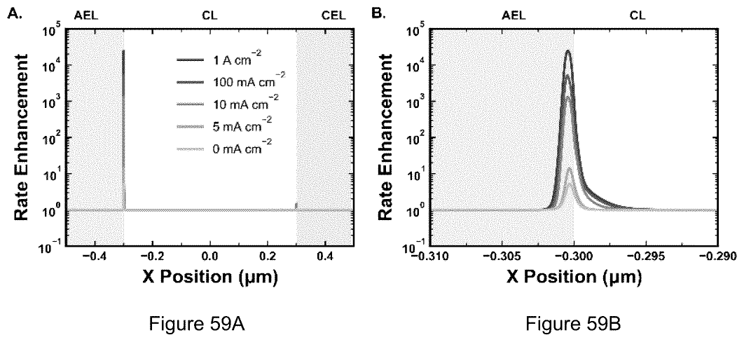

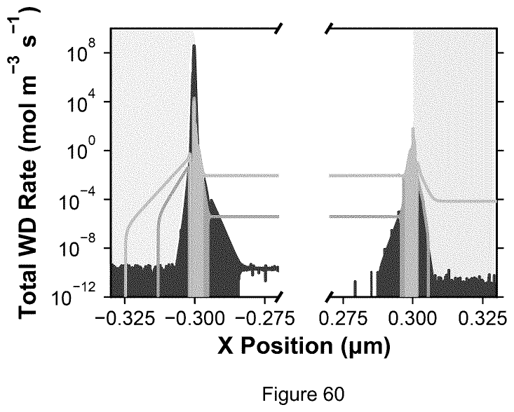

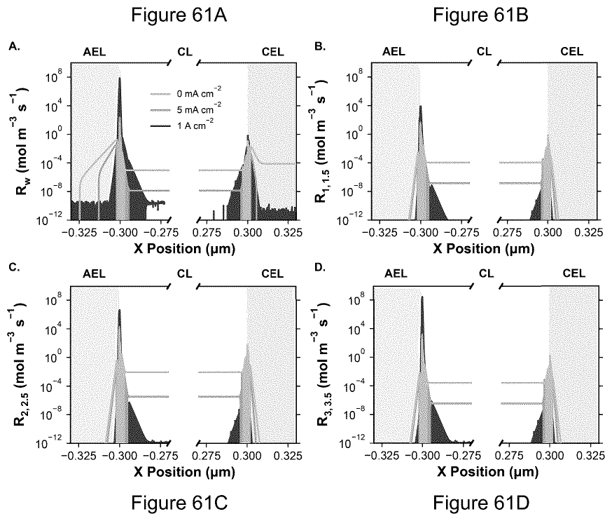

FIGS. 57A through 57B illustrate that the local electric field within the BPM CL reveals that the maximum in the electric field at the AEL-CL interface coincides with the maximum the rate of WD via the Second Wien Effect illustrated in FIGS. 58A through 59B. The local maximum in electric field can be explained by examining the concentration profiles of the GrOx functional groups within the CL presented in FIG. 25C and FIGS. 52A through 55D. Local generation of OH⁻ anions at the AEL-CL interface causes the most acidic GrOx functional groups (i.e., carboxylic groups) to deprotonated rapidly, resulting in a large buildup of negative charge at that interface, which, in turn, enhances the local electric field and accelerates the WD reaction via the Second Wien Effect. The role of the catalyst is to develop surface charges that enhance the electric field and drive WD. Examination of alternative WD pathways shown in Equations S37-S42 and FIG. 4A, along with experimentally determined concentrations of ionizable groups in the GrOx catalyst, shows that WD occurs primarily via the reaction of H₂O with the least acidic GrOx functional groups (i.e., phenolic groups) as illustrated in FIG. 25D and FIGS. 61A through 61D. WD occurred at substantial rates via a catalyzed pathway showing the catalyst promotes WD as well as the formation of the electric field. These simulations show that the more acidic GrOx sites serve to enhance the electric field and the least acidic GrOx sites provide additional pathways for WD. FIG. 25C illustrates the phenolic sites are present in >2 M concentrations at 100 mA cm⁻². Thus, the different pKₐ of the acidic groups on GrOx and their high concentration within the CL can be the reason that GrOx exhibits dual functionality.

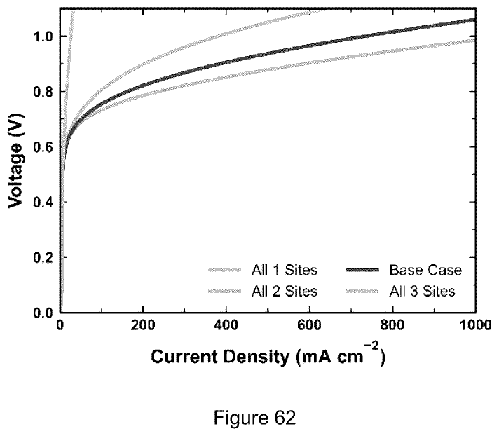

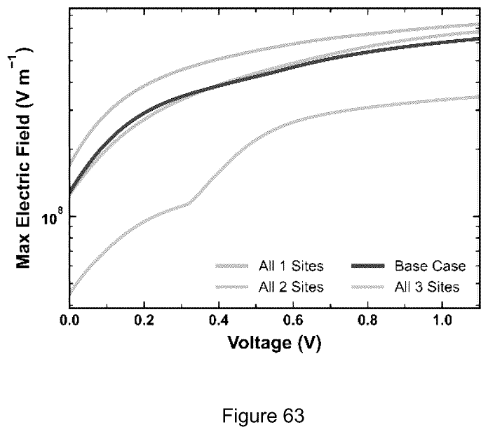

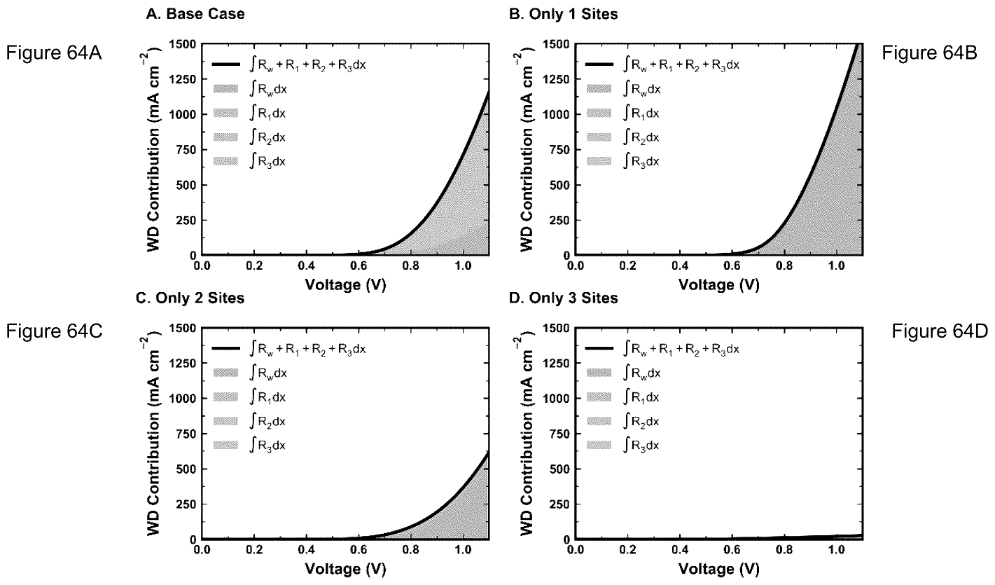

To determine the extent to which the pKₐ of different acidic groups in the CL affects the rate of WD, simulations of the BPM are carried out in which all sites in the CL are set to a single pKₐ value equal to that of one of the pKas associated with phenolic and carboxylic groups in GrOx (i.e., either pKₐ=4.3, 6.6, or 9.8). FIGS. 62 through 64D illustrate these single-site simulations are consistent with that as the pKₐ of the catalyst decreases, its WD performance improves because the acidic groups on the catalyst dissociate more readily, thereby enhancing the electric field and accelerating the rate-limiting step in WD. FIG. 63 shows that for low pKₐ (4.3 or 6.6) functional groups, WD occurs primarily via the electric-field-enhanced process, and catalyzed WD does not occur to a significant extent because of the lack of neutral sites at the AEL-CL interface. For higher pKₐ (9.8) functional groups, catalyzed WD becomes the dominant reaction pathway, because the pKₐ is sufficiently large to prevent full deprotonation. However, because there is substantially less negative charge at the AEL-CL interface in this case, the electric field, and thus the rate of WD, are significantly lower. FIGS. 64A through 64D illustrate for a single pKₐ=4.3 site, the theoretical current density is much higher than for the case of multiple acidic site GrOx due to the increase in the concentration of dissociated sites, implying that the role of the electric field enhancement is more critical to dictating WD performance. The coexistence of multiple sites on the GrOx enables the passage of WD through a catalyzed mechanism, and the multi-site GrOx CL vastly outperforms the simulated single site catalysts with pKₐ>5.

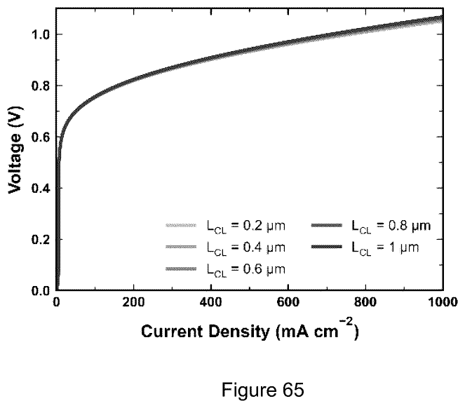

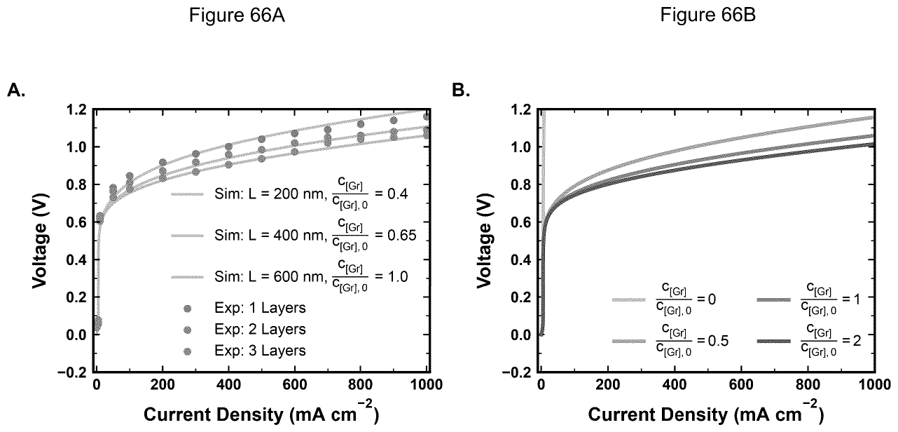

Continuum-level modeling also helps elucidate experimental trends observed when the mass loading of the GrOx catalyst is increased. The simulations illustrated in FIG. 65 reveal that changes in CL thickness alone cannot explain the observed trends in WD rate because WD is assumed to occur at the AEL-CL interface and not within the bulk of the CL. Further modeling shown in FIGS. 66A and 66B demonstrate that if the volumetric concentration of catalyst sites increases concomitantly with thickness from one to three layers, the performance enhancements observed experimentally can be explained. Such an increase in the volumetric concentration of GrOx sites results from an increase in the exposed GrOx surface with increasing CL thickness, consistent with the schematic of the GrOx structure deduced from the EIS analysis shown in FIGS. 24A through 24G.

GrOx catalyzed, asymmetric BPMs can overcome water transport limitations and operate in reverse bias at high current density and low overpotentials, with high efficiencies for acid and base production. Under conditions relevant for electrodialysis, BPMs in accordance with embodiments can sustain stable operation for at least 1100 hours at 80 mA cm⁻², at least 100 hours at 500 mA cm⁻², and at least 60 hours at 1 A cm⁻². Additionally, at an applied current density of 1 A cm⁻², BPMs exhibit an overpotential of about 242 mV and a Faradaic efficiency (FE) for acid and base generation near unity. Additionally, the combination of anion exchange layer (AEL), cation exchange layer (CEL), and catalyst (PiperION®, Nafion®, and GrOx) enables good adhesion at the BPM junction, which contributes to long-term stability. Initial testing of BPMs in accordance with some embodiments in an electrodialysis cell stack with a scaled active area of 6 cm² also demonstrate high current density operation at low voltage.

The performance of BPMs in accordance with certain embodiments can be changed by varying the loading of the catalyst. Varying the catalyst loading reveals that an optimum in loading exists, whereas too low loading results in patchy coverage of the membrane interface by the catalyst, which reduces the catalyst site concentration, and too high a catalyst loading results in catalyst agglomeration and a similar loss of sites. Continuum-level modeling of BPMs can match the experimentally measured polarization curves and FEs. These simulations reveal that high concentrations of both low and high pKₐ deprotonation sites in the GrOx CL enhance the electric field at the AEL-CL interface and provide alternative pathways for WD. Freestanding BPMs in accordance with embodiments can be employed in a wide array of electrochemical technologies in which operation with high current densities and low voltages is desirable.

### EXEMPLARY EMBODIMENTS

Although specific embodiments of systems and apparatuses are discussed in the following sections, it will be understood that these embodiments are provided as exemplary and are not intended to be limiting.

### Example 1: Materials and Devices

The following membranes are received in dry form, pretreated according to manufacturer's instructions before use, and stored in DI water (CEMs) or 1 M NaOH (AEMs): Nafion® 212 (50 μm), Nafion® 211 (25 μm), Nafion® 115 (127 μm), PiperION® A15R (15 μm), PiperION® 20 (20 μm), PiperION® 60 (60 μm), Fumasep FAB-PK-130 (110-140 μm), Fumasep FKB-PK-130 (110-140 μm), Nafion® D520 (5 wt % Ionomer). The following chemicals are used as received: graphene oxide paste (30 g/L), sodium chloride (NaCl), sodium hydroxide (NaOH, Pellets), hydrochloric acid (HCl, 1.0 M and 0.1 M), potassium hydroxide (KOH, pellets).

Catalyst inks are made by first diluting graphene oxide paste from 30 g/L to 10 g/L. The dilute graphene oxide dispersion is then mixed with Nafion® D520 in a 1:1 volume ratio. The final ink solution is sonicated for at least 10 minutes prior to use.

First, a piece of purchased Nafion® membrane (NR212, NR211, NR115), precut into a 1.5×1.5 cm square and soaked in DI water for at least 1 h, is placed on a glass slide and patted dry with a Kimwipe®. The membrane is then taped to the glass slide on all 4 sides with Kapton® tape. GrOx catalyst ink is then spin coated onto the Nafion® membrane at about 3000 rpm for about 30 s. Next, the Nafion® membrane with GrOx is placed in an oven at about 100° C. for about 2 min. This process of spin coating and heating is repeated if more layers, i.e., greater mass loading, is desired. Finally, the Nafion® membrane with GrOx is rewetted with a few drops of DI water, sandwiched with the desired thickness of PiperION® membrane, and pressed firmly between gloved fingers, taking care to press out any air pockets. All membranes are tested directly after assembly. The same methods are used for fabrication of both the 1 cm² and 6 cm² active area BPMs.

The conductivity of the AEMs and CEMs are measured using a four-point probe. Measurements are taken from about −10 to about 10 V on fully hydrated membranes. The measurements provide an in-plane conductivity, however, as the membranes are isotropic, this is equivalent to the through plane conductivity.

To determine the mass loading of GrOx ink spin coated onto Nafion®, the Nafion® membranes taped to glass slides are weighed before and after spin coating using a Sartorius CP Series electronic microbalance. Before weighing, the Nafion® taped to a glass slide, is dried at about 100° C. for about 10 min so that the measurements are not be affected by a change in hydration after the GrOx ink is added and heat treated. After the GrOx is spin coated onto the Nafion® and heated, a Kimwipe® is used to remove excess GrOx ink from the tape and glass. The final loading amount is calculated based on the exposed Nafion area within the tape border.

FIG. 13A shows a schematic of the electrodialysis cell used to test the BPMs. The cell consists of an anode 1301, an anolyte chamber 1302, a CEM 1310, a dilute chamber 1303, an AEM 1313, an acid chamber 1305, a BPM 1312 (1 cm² active area), a base chamber 1211, a CEM 1210, a catholyte 1208, and a cathode 1309. Both the anode 1301 and cathode 1309 consist of Ni foil with copper tape as leads. Aqueous 1 M NaOH is used as both the anolyte 1302 and the catholyte 1508 and is recirculated through both chambers at about 10 mL/min. Aqueous 3 M NaCl is recirculated at about 5 mL/min through the dilute chamber and aqueous 0.5 M NaCl is flowed through the acid 1305 and base 1311 chambers at about 0.2 mL/min. Both CEMs 1310 used in the cell stack are Nafion® N324 (280 μm) and the AEM 1313 is Fumasep FAB-PK-130 (130 μm). Luggin capillaries 1307 holding Ag/AgCl reference electrodes 1304 are placed in the acid 1305 and base 1311 chambers to allow for the most direct measurement of the voltage across the BPM.

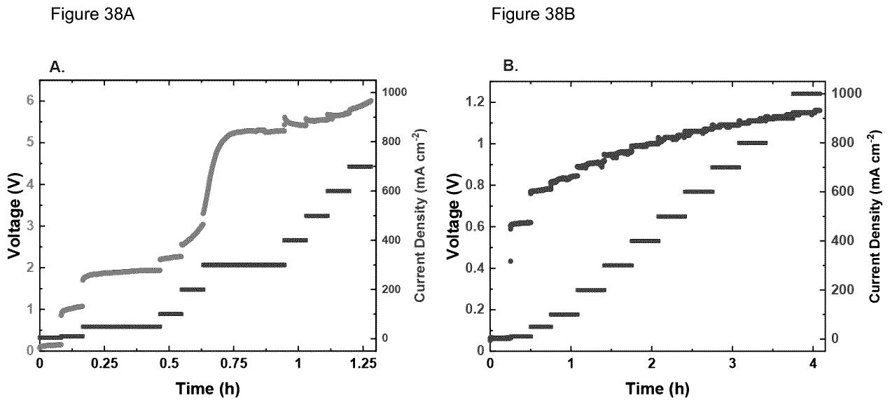

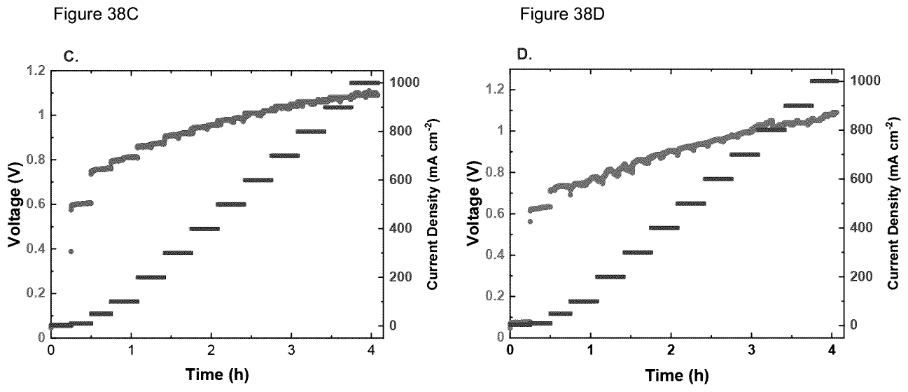

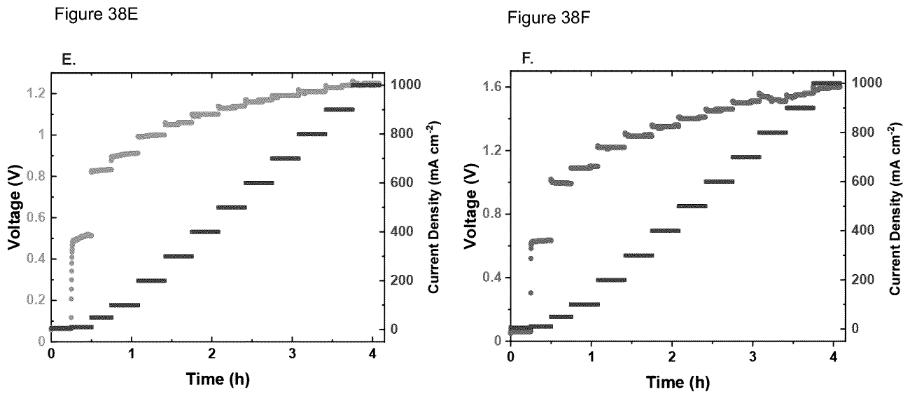

After the electrodialysis cell described above is assembled, potentiostat leads are attached in a four-point measurement configuration so that a current can be applied across the full cell and the resulting voltage can be measured directly across the BPM 1312. Chronopotentiometry measurements are used to obtain all reported data for all polarization curves. For each point, a chosen current is applied across the anode and cathode and is held steady for about 5-20 min or until the voltage measured across the BPM 1312 reaches steady state. The current is then increased to the next value and the process is continued until all desired current measurements are performed. Examples of current density vs. time plots, with voltage values as averages of the voltage collected over the steady state region for each chronopotentiometry step, can be seen in FIGS. 38A through 38F.

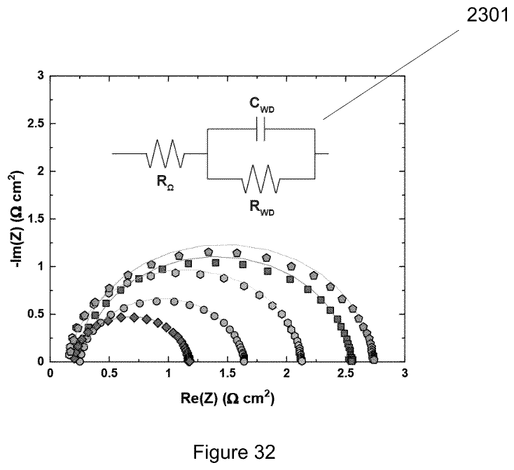

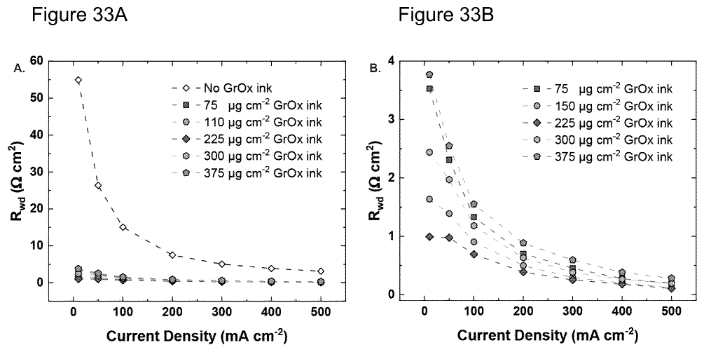

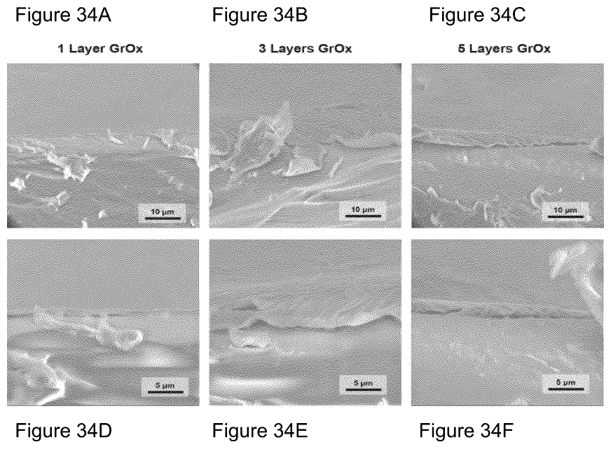

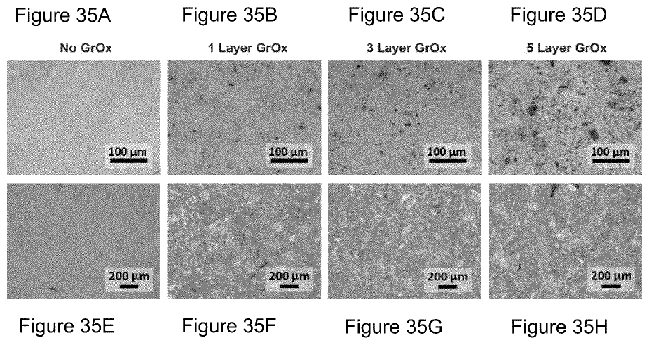

EIS measurements are performed in the same electrodialysis cell as described above. For each BPM, measurements are started at about 500 mA cm⁻² and stepped down through each desired current density. For each step, the current is held for about 1 min, then scanned from about 600 kHz to about 20 Hz with an amplitude of about 5-10% of the current, recording about every 0.5 sec. Nyquist plots are then fitted using software as shown in FIG. 32. The circuit 3201 is used to fit the EIS data. R_{Ω} is the resistance between the tips of the Luggin capillaries, which includes the solution and the membranes, RWD is the resistance due to the water dissociation reaction, and CWD is the capacitance due to a double layer build up at BPM inner layer.

The same five chamber electrodialysis cell as described above is used for collecting acid and base samples to measure the Faradaic efficiency at various current densities. Aqueous 0.5 M NaCl is flowed at about 5 mL/min through the acid and base chambers and the desired current is applied across the cell until the voltage stabilized (usually about 10-20 min). Samples are then collected in 20 mL vials from the acid and base chamber. The current is then increased to the next desired value and the process repeated. Once the samples are collected, the H⁺ and OH⁻ activity is evaluated via pH probe measurements or pH titration. Titration is used for more pH values >12 and <2.

SEM images are obtained. A spot size of about 5.0 and a voltage of about 10.00 kV is used for most images. For the BPM cross-sectional images, the membrane is embedded in resin and cut using a microtome. For cross sections of just the Nafion® with a GrOx CL, the membranes are sliced using a razor blade. ImageJ is used to evaluate membrane and CL thickness from these SEM cross sections.

All optical microscope images are obtained. Images of GrOx dispersions are taken during the BPM fabrication process, while Nafion® and GrOx-coated Nafion® remained taped to glass slides, before being rewetted and sandwiched with the AEM.

FIG. 22A shows a schematic of the fluid flow in the electrodialysis cell used to test the scaled BPM. A commercial cell with iridium oxide-mixed metal oxide electrodes and a 6 cm² active area is modified with two holes on the catholyte chamber to create inlet 2215 and outlet 2203 ports for the dilute chamber. For a single-cell stack, from anode to cathode, the membrane stack comprises of a BPM 2204, AEM 2206, CEM 2208, and a BPM 2204. All membranes are cut to a size of about 5 cm×7 cm with a blade. About 2 mm and about 4 mm holes are punched in the appropriate locations to allow solution flow past the membranes for the acid and base chambers and dilute chamber, respectively. In between the membranes, a modified commercial polypropylene mesh silicone gasket 2207 (about 450 μm thickness for the inner chambers (2205 and 2209) and about 450 μm thickness for the outer chambers (2202 and 2211) is used to allow continuous, segregated solution flow through the inner chambers and outer chambers of the cell. 1 M KOH solution is recirculated in two separate 5 L polypropylene reservoirs for the anolyte and catholyte chambers at rate of about 1.5 L/min. 0.5 M NaCl solution flows through the cell from separate source reservoirs for the acid, base, and dilute chambers and exits to a communal waste container at rates of about 35 mL/min for the acid (2212 and 2214) and base (2210 and 2215) channels and about 45 mL/min.

After the electrodialysis cell described above is assembled, power supply (360 W) leads are attached to the cell in a two-point configuration to apply current and measure voltage. A custom LabVIEW VI controls the applied current and chronopotentiometry measurements are used to obtain all reported current density and voltage data. For each point, a chosen current is applied across the anode and cathode and is held steady for at least one minute or until the measured voltage reaches steady state. Voltage data is collected at a time step of about 5 s. The current is then increased to the next point and the process is continued until all desired current density measurements are obtained.

At each chosen current, under steady state, solution samples are collected in 50 mL polypropylene conical tubes from the acid, base, and dilute chambers. Once the samples are collected, the conductivity is measured using a four-ring conductivity probe and meter. The voltage contributions for the inner chambers and ion-exchange membranes (AEM and CEM) are calculated using the following equation: V=jL/σ where j is the current density (mA cm⁻²), L is the width of the chamber (i.e., the thickness of the mesh gasket) or thickness of the membrane (cm), respectively, and K is the solution or membrane conductivity (mS cm⁻¹), respectively. The thickness of the membranes is determined using a micrometer. Errors in the membrane voltage contributions are determined using the standard errors in the conductivity and thickness measurements to calculate the minimum and maximum possible voltage contributions. The average is used for the error bars in FIG. 22A. The BPM voltage contribution is determined using custom BPM testing cell described above.

The simulation is performed using the COMSOL Multiphysics® software. The concentration of H₃O⁺, OH⁻, Na⁺, Cl⁻, and of all GrOx surface species along with the electrostatic potential profile are solved using conservation equations where Poisson-Nernst-Planck described mass and charge transport. Crucially, the rates of net-charge-generating homogeneous reactions are modified by the Second Wien effect such that the rate of ion dissociation, i.e., the forward direction, is substantially enhanced by an electric field.

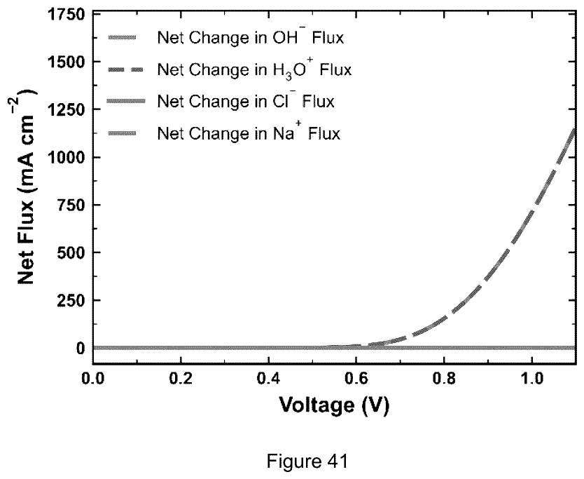

FIG. 41 illustrates a control volume analysis across the CL of an asymmetric BPM in accordance with an embodiment. The change in proton flux and hydroxide flux across the CL are equivalent due to the stoichiometric nature of WD. Because Na⁺ and Cl⁻ are not generated or consumed by any buffer reactions, there is no net change in their flux across the CL.

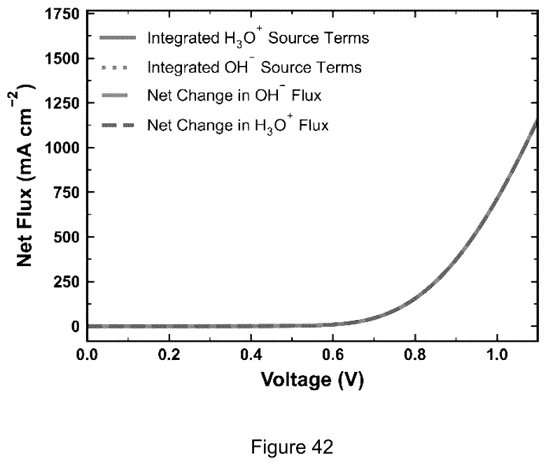

FIG. 42 illustrates the calculated change in proton and hydroxide flux across the CL of an asymmetric BPM along with the integration of the proton and hydroxide source terms. The integrated source terms are equivalent to the change in flux.

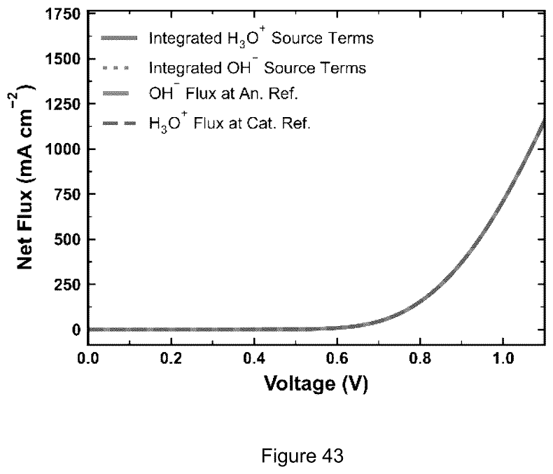

FIG. 43 illustrates the change in flux across the CL of an asymmetric BPM in accordance with an embodiment plotted alongside the measured proton and hydroxide flux measured at the reference electrodes to demonstrate flux-matching. Generation of protons and hydroxides via WD occurs within the CL.

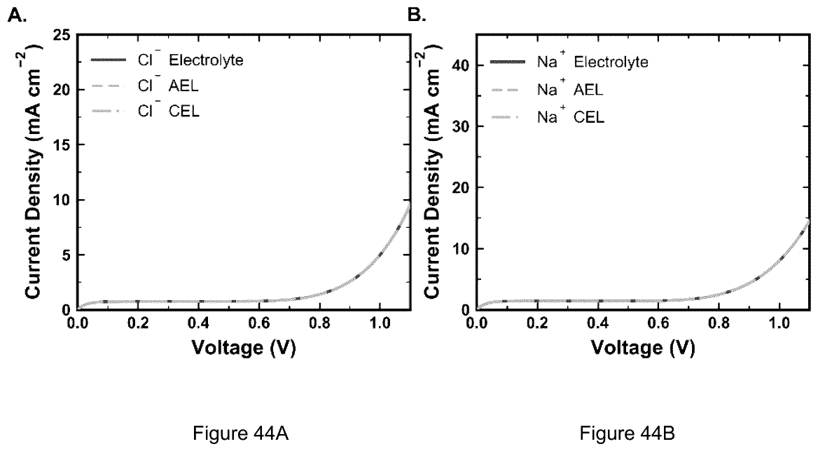

FIGS. 44A and 44B illustrate the Cl⁻ and Na⁺ flux measured at different regions of the model of an asymmetric BPM in accordance with an embodiment. The Cl⁻ and Na⁺ fluxes remain constant throughout, as there is no generation or consumption of these species via homogeneous reactions.

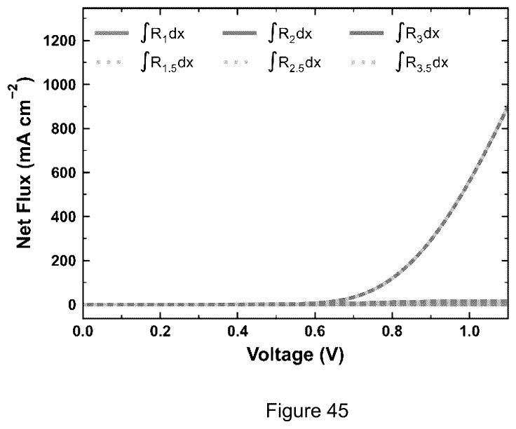

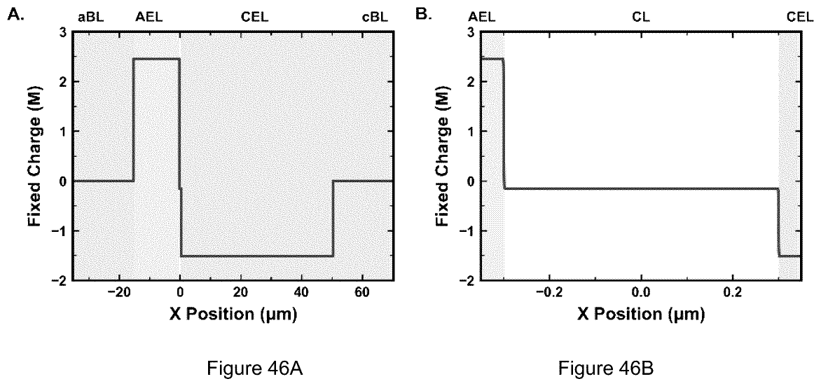

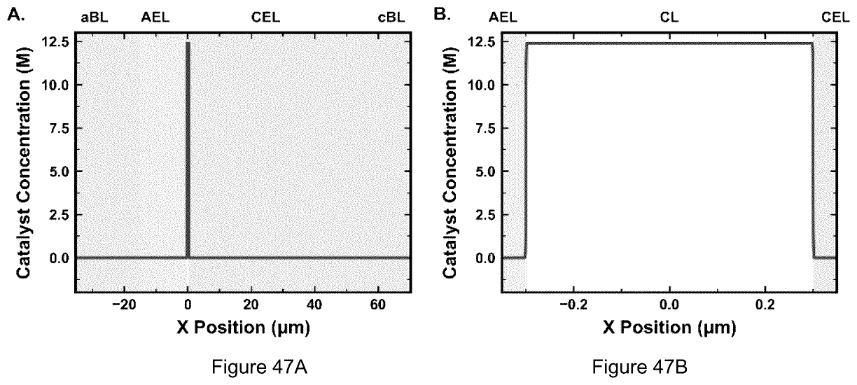

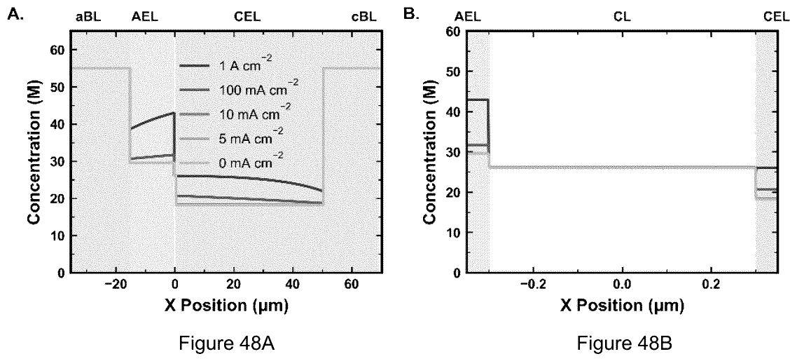

FIG. 45 illustrates the integration of catalyzed water dissociation pathways within the WD catalyst layer. The fluxes of protons and hydroxides due to each pathway are stoichiometrically linked. The rates of the first and second step in each of the catalyzed WD pathways must be equal.

### Example 2: Characterization and Analysis of GrOx Loading

TABLE 1
List of the main BPMs, and their properties.

| | | | | Layers of | Mass Loading of | Catalyst Layer |
|---|---|---|---|---|---|---|
| Name | CEL | AEL | Catalyst | Catalyst | Catalyst (μg cm⁻²) | Thickness (nm) |
| BPM 0 | Nafion | PiperION | GrOx ink | 0 | 0 | 0 |
| | 212 | 15R | | | | |
| BPM 1 | Nafion | PiperION | GrOx ink | 1 | 75 | 200 |
| | 212 | 15R | | | | |
| BPM 2 | Nafion | PiperION | GrOx ink | 2 | 150 | 400 |
| | 212 | 15R | | | | |
| BPM 3 | Nafion | PiperION | GrOx ink | 3 | 225 | 600 |
| | 212 | 15R | | | | |
| BPM 4 | Nafion | PiperION | GrOx ink | 4 | 300 | 800 |
| | 212 | 15R | | | | |
| BPM 5 | Nafion | PiperION | GrOx ink | 5 | 375 | 1000 |
| | 212 | 15R | | | | |
| BPM 6 | Nafion | PiperION | GrOx ink | 3 | 225 | 600 |
| | 211 | 15R | | | | |

### Example 3: Cell and Membrane Temperature Model

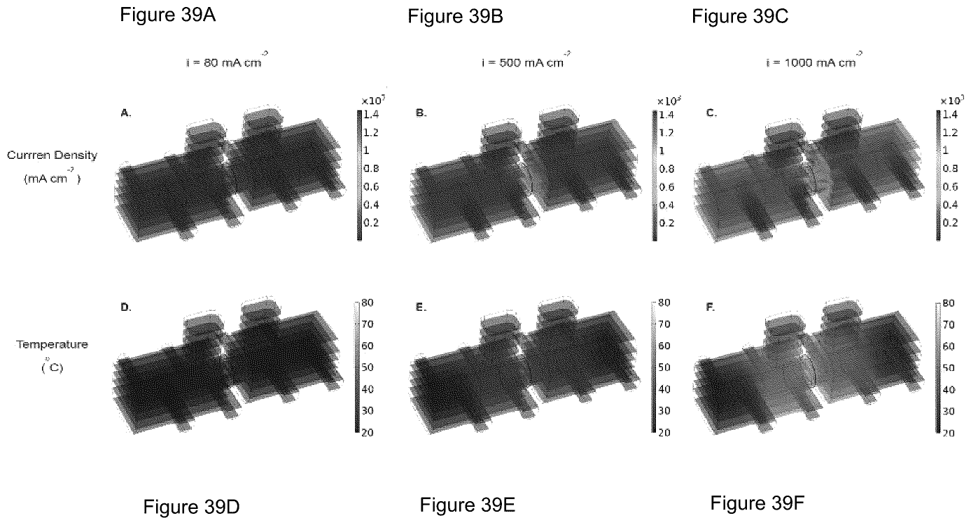

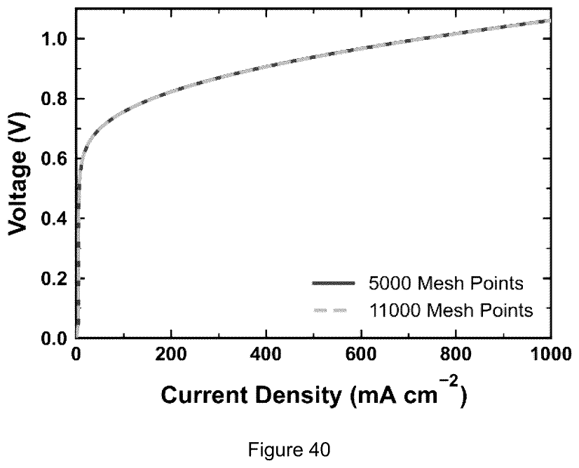

A 3-D temperature simulation for the custom electrodialysis cell uses a multiphysics finite element model featured with current distribution, resistive heating and fluid dynamics. The current distribution is simulated assuming a primary current model in which the current density distribution is simulated with an assigned conductivity for the electrolyte and ion-exchange membrane domains instead of explicitly resolving the ion concentration and flux. Three average current density values (80, 500, 1000 mA cm⁻²) are applied as the boundary condition. The current distribution inside the cell is plotted in FIGS. 39A through 39C with sliced heat maps indicating the magnitude of the local current density and arrows depicting both the direction and the magnitude of the current density vector.

Other than in the BPM domain, the local heating power per unit volume is calculated based on the local current density and conductivity by the differential form of Joule heating equation

$$\frac{d P}{d V} = \frac{1}{σ} {J}^{2} \qquad ( S13 )$$

where σ is conductivity and J is the current density. In the BPM domain, a portion of the potential is consumed as the energy to facilitate the water dissociation reaction:

H₂O [symbol] H⁺+OH⁻Δφ=0.83V (S14)

Thus, the differential form of Joule heating power inside the BPM is calculated by

$$\frac{d P}{d V} = \frac{1}{σ} {J}^{2} - {J}_{z} \frac{Δφ}{{Z}_{B P M}} \qquad ( S15 )$$

The temperature after about 1 hour of operation predicted by the simulation is plotted in FIGS. 39D through 39F. The temperature results from this model manifest that operating at about 80 mA/cm² a low temperature, not exceeding about 21.6° C. can be maintained throughout the cell, however, when the cell is operating at about 500 mA/cm² and about 1000 mA/cm², the temperature reaches a maximum of about 42.3° C. and about 80.7° C. respectively near the cylindrical region where the BPM is located.

### Example 4: Ion Transport

To solve for all concentrations and fluxes of relevant species (OH⁻, H⁺, Cl⁻, and Na⁺), species conservation is invoked within the modeled domain.

∇·Nᵢ=R_{B,i}, (S16)

where Nᵢ is the flux of species i, and R_{B,i} is a source term defined as the generation of species i from homogeneous buffer reactions and water recombination/dissociation. Under dilute-solution theory, the molar species flux is defined by the Nernst-Planck equation,

$${N}_{i} = - \frac{{D}_{i} {c}_{i}}{RT} \frac{d {μ}_{i}}{dx} , \qquad ( S17 )$$

where Dᵢ, cᵢ, μᵢ are the diffusivity, concentration, and chemical potential of species i, respectively. The chemical potential of a given species is defined as follows:

μᵢ=μᵢ⁰+RT ln(aᵢ)+zᵢFΦ. (S18)

In the above chemical potential expression, the first term is the reference chemical potential of species i, the second term accounts for changes in activity of i, the third term accounts for electrostatic potential and only applies for charged ionic species (i.e., all species except CO₂). Φ is the electrostatic potential within the electrolyte and membrane phases. R, T, and F are the ideal gas constant, the temperature, and Faraday's constant, respectively. The activity of a given species is defined by the following expression:

$${a}_{i \neq {H}_{2} O} = \frac{{f}_{i} {c}_{i} {c}_{{H}_{2} O}^{0}}{{c}_{ref} {c}_{{H}_{2} O}} , \qquad ( S19 )$$

where c_{ref} is a reference concentration (1 M), the ratio

$$\frac{{c}_{{H}_{2} O}}{{c}_{{H}_{2} O}^{0} = 55.56 [ M ]}$$

accounts for change in volumetric reference between the liquid electrolyte and liquid-filled channels of the BPM, and fᵢ is the activity coefficient, which is assumed to be unity (fᵢ=1) for all Na⁺ and Cl⁻ (i.e., salt species are treated ideally) and a function of electric field for hydronium and hydroxide ions

$$( {f}_{i} = \sqrt{\frac{{K}_{w}^{0}}{{K}_{w} ( E )}} ) .$$

This term accounts for the shift in water dissociation equilibrium with electric field by the Second Wien Effect and only applies to protons and hydroxides. The choice of square root in the term means that the Second Wien Effect applies equally to each dissociating ion. For water, the activity (a_{H}_{₂}_{O}) is assumed to be unity.

In the electrolyte phase diffusion coefficients are set to their values in water, but in the BPM, they are corrected by the following relationship:

$${D}_{i , eff} = \frac{{ϕ}_{L , M}^{q} {D}_{i , w}}{{x}_{w} ( 1 + \frac{1}{λ} {ζ}_{i} )} . \qquad ( S20 )$$

In this framework, q is a fitting parameter and x_{w} is the ratio of the moles of water in the membrane to the sum of the moles of water and fixed-charge groups given by

$${x}_{w} = \frac{λ}{1 + λ} , \qquad ( S21 )$$

where λ is the water content of the BPM defined as the ratio of water molecules absorbed in the BPM to fixed charge groups. ϕ_{L,M} is the water volume fraction in the ionomer,

$${ϕ}_{L , M} = \frac{{c}_{{H}_{2} O , M}}{{c}_{{H}_{2} O , 0}} , \qquad ( S22 )$$

where C_{H}_{₂}_{O,M} and C_{H}_{₂}_{O,0} are the molar concentrations of water in the membrane and of pure water, respectively. ζᵢ describes the ratio of the species-water and species-membrane diffusivities,¹³

$${ζ}_{i} = \frac{{D}_{i , w}}{{D}_{i , M}} = {( \frac{{V}_{M}}{{V}_{w}} )}^{\frac{2}{3}} {( \frac{{M}_{i , M}}{{M}_{i , w}} )}^{\frac{1}{2}} , \qquad ( S23 )$$

where V_{w} and V_{M} are the molar volume of water and ionomer.

$${M}_{i , M} = {( \frac{1}{{M}_{i}} + \frac{1}{{M}_{M}} )}^{- 1}$$

is the reduced molar mass.

Water transport limitations in BPMs does not occur until current densities >1 A cm⁻², when employing a thin ion-exchange layer, which is beyond the range of current densities studied in the present work. Water activity is assumed to be unity, and the membrane channels are fully liquid-filled. In this scenario, water content, λ, is only a function of the local ionic environment.

$${λ}_{CEL} = ( 1 - {f}_{{H}_{3} {O}^{+}} ) {λ}_{{f}_{{H}_{3} {O}^{+}} = 0} + {f}_{{H}_{3} {O}^{+}} {λ}_{{f}_{{H}_{3} {O}^{+}} = 1} \qquad ( S24 )$$

$${λ}_{AEL} = ( 1 - {f}_{{OH}^{-}} ) {λ}_{{f}_{{OH}^{-}} = 0} + {f}_{{OH}^{-}} {λ}_{{f}_{{OH}^{-}} = 1} \qquad ( S25 )$$

where f_{H}_{₃}ₒ_{⁺} and f_{OH}_{^{−}} are the fraction of ion-exchange groups in the CEL or AEL, respectively, exchanged with protons or hydroxides.

$${λ}_{{f}_{{H}_{3} {O}^{+}} = 0} , {λ}_{{f}_{{H}_{3} {O}^{+}} = 1} , {λ}_{{f}_{{OH}^{-}} = 0} , {λ}_{{f}_{{OH}^{-}} = 1}$$

are the water contents of CELs or AELs fully exchanged with protons/hydroxides or counterions and are determined from experimental literature for Nafion® and PiperION® membranes in proton or hydroxide form and sodium or chloride form. The water concentration in the domain is defined with the following hyperbolic tangent (invoked to smooth out the boundary gradients at the membrane and electrolyte interface to encourage simulation convergence).

$${c}_{{H}_{2} O} ( x ) = {c}_{{H}_{2} O , 0} - ( 0.5 ( {c}_{{H}_{2} O , 0} - {λ}_{CEL} {c}_{M , CEL} ) \times ( tanh ( \frac{x - {x}_{1}}{{L}_{char}} ) + 1 ) ) + ( 0.5 ( {ϕ}_{L , CL} {c}_{{H}_{2} O , 0} - {λ}_{CEL} {c}_{M , CEL} ) \times ( tanh ( \frac{x - {x}_{2}}{{L}_{char}} ) + 1 ) ) + ( 0.5 ( {λ}_{AEL} {c}_{M , AEL} - {ϕ}_{L , CL} {c}_{{H}_{2} O , 0} ) \times ( tanh ( \frac{x - {x}_{3}}{{L}_{char}} ) + 1 ) ) + ( 0.5 ( {c}_{{H}_{2} O , 0} - {λ}_{AEL} {c}_{M , AEL} ) \times ( tanh ( \frac{x - {x}_{4}}{{L}_{char}} ) + 1 ) ) \qquad ( S26 )$$

In the above expression, x₁ is the leftmost position of the CEL, x₂ is the right most position of CEL, x₃ is the leftmost position of AEL, and x₄ is the rightmost position of the AEL. The characteristic length used in this study is L_{char}=0.58 nm, related to the bond separation distance of water. ϕ_{L,CL} represents the volume fraction of water in the catalyst layer defined as:

$${ϕ}_{L , CL} = ( {ϕ}_{0 , CL} + {ϕ}_{N af , CL} ( \frac{{λ}_{CEL} {V}_{0}}{{λ}_{C E L} {V}_{0} + \frac{1}{{c}_{M , CEL}}} ) ) \qquad ( S27 )$$

ϕ_{L,CL} and ϕ_{Naf,CL} are both fit parameters. ϕ_{Naf,CL} is the fit volume fraction of Nafion® in the catalyst layer, roughly associated with the composition of the ionomer ink used to cast the CL. The term

$$\frac{{λ}_{C E L} {V}_{0}}{{λ}_{C E L} {V}_{0} + \frac{{{1}_{}}_{}}{{c}_{M , CEL}}}$$

represents the volume fraction of water in the hydrophilic domains of the Nafion® ionomer in the CL. φ_{0,CL} is the water volume fraction of the as-prepared catalyst layer and can be explained as the porosity or void fraction of the overall catalyst layer.

The fixed-charge concentration in the BPM, c_{M}(x), is defined by the following hyperbolic tangent:

$${c}_{M} ( x ) = \frac{{ρ}_{M , wet} \times I E C}{2} ( tanh ( \frac{x - {x}_{3}}{{L}_{char}} ) - tanh ( \frac{x - {x}_{4}}{{L}_{char}} ) + tanh ( \frac{x - {x}_{2}}{{L}_{char}} ) - tanh ( \frac{x - {x}_{1}}{{L}_{char}} ) ) \qquad ( S28 )$$

where ρ_{M,wet} and IEC are the wet membrane density and ion-exchange capacity, respectively. This distribution is equal to zero in the liquid electrolyte domains, and represents negative and positive fixed-charge in the CEL and AEL domains, respectively.

### Example 5: Charge Transport

The Poisson equation is solved to determine the electrostatic potential.

$$- \frac{{d}^{2} Φ}{d {x}^{2}} = \frac{F}{ε ( x )} ( {c}_{M} ( x ) + {\sum }_{i} {z}_{i} {c}_{i} ) , \qquad ( S29 )$$

ε(x) is the position-dependent dielectric permittivity of the medium. This permittivity is defined differently in each domain in the simulation. First, it is defined to be that of water

$$( \frac{{ε}_{{H}_{2} O , 0}}{{ε}_{0}} = 78 )$$

in the electrolyte domains, where ε₀ is the vacuum permittivity and the ratio

$$\frac{{ε}_{{H}_{2} O , 0}}{{ε}_{0}}$$

is the relative permittivity of water. Σᵢzᵢcᵢ represents the sum of the product of all charged species and their charge and includes charged GrOx surface species within the catalyst layer.

The permittivity of a polymer ion-exchange membrane can be approximated as a linear superposition of permittivity in the water phase in the ionomer and the permittivity of the polymer domains, weighted by the volume fraction of each phase. The polymer phase relative permittivity is determined as

$$\frac{{ε}_{M}}{{ε}_{0}} = 3.5$$

and for water in the polymer channels as

$$\frac{{ε}_{{H}_{2} O , M}}{{ε}_{0}} = 53.5$$

(slightly reduced from the value of bulk water of 78 due to confinement effects²⁴). Due to a lack of high frequency dielectric studies for PiperION® AEMs, the dielectric constants for Nafion® in the PiperION® phase are employed as well.

ε_{CEL/AEL}=(1−ϕ_{L,M})(ε_{M})+ϕ_{L,M}(ε_{H}_{₂}_{O,M}), (S30)

where ε_{M} is the permittivity of the dry Nafion® polymer.

Lastly, in the catalyst layer, the presence of graphene oxide, which has a relative permittivity of

$$\frac{{ε}_{{H}_{2} O , M}}{{ε}_{0}} = 2.3$$

when immersed in water, also participates in determining the dielectric permittivity.

ε_{CL}=ϕ_{M,CL}ε_{M}+ϕ_{L,M,CL}ε_{H}_{₂}_{O,M}+ϕ_{GrOx,CL}+ϕ_{L,CL}ε_{H}_{₂}_{O,0}, (S31)

ϕ_{M,CL} is the volume fraction of dry Nafion in the CL, and ϕ_{L,M,CL} is the volume fraction of liquid water inside of membrane pores in the catalyst layer.

$${ϕ}_{L , M , CL} = {ϕ}_{Naf , CL} ( \frac{{λ}_{CEL} {V}_{0}}{{λ}_{CEL} {V}_{0} + \frac{1}{{c}_{M , CEL}}} ) \qquad ( S32 )$$

$${ϕ}_{M , CL} = {ϕ}_{Naf , CL} ( 1 - \frac{{λ}_{CEL} {V}_{0}}{{λ}_{CEL} {V}_{0} + \frac{1}{{c}_{M , CEL}}} ) \qquad ( S33 )$$

Lastly, ϕ_{GrOx,CL} is the volume fraction of solid graphene oxide in the catalyst layer.

ϕ_{GrOx}=1−ϕ_{L,CL}−ϕ_{Naf,CL} (S34)

The position-dependent dielectric permittivity is also defined by a hyperbolic tangent to facilitate convergence as follows:

$$ε ( x ) = 0.5 {ε}_{{H}_{2} O , 0} ( 1 - tanh ( \frac{x - {x}_{1}}{{L}_{char}} ) ) + 0.5 {ε}_{CEL} ( tanh ( \frac{( x - {x}_{1} )}{{L}_{char}} ) - tanh ( \frac{x - {x}_{2}}{{L}_{char}} ) ) + 0.5 {ε}_{CL} ( tanh ( \frac{x - {x}_{2}}{{L}_{char}} ) - tanh ( \frac{( x - {x}_{3} )}{{L}_{char}} ) ) + 0.5 {ε}_{AEL} ( tanh ( \frac{x - {x}_{3}}{{L}_{char}} ) - tanh ( \frac{x - {x}_{4}}{{L}_{char}} ) ) + 0.5 {ε}_{{H}_{2} O , 0} ( 1 + tanh ( \frac{x - {x}_{4}}{{L}_{char}} ) ) \qquad ( S35 )$$

### Example 6: Homogeneous Kinetics and Electric Field-Enhanced Water Dissociation

The homogeneous water dissociation reaction consumes OH⁻ and H₃O⁺ throughout the electrolyte domain.

$$2 {H}_{2} O {↔}^{{k}_{w} , {k}_{- w}} {H}_{3} {O}^{+} + {OH}^{-} {K}_{w} \qquad ( S36 )$$

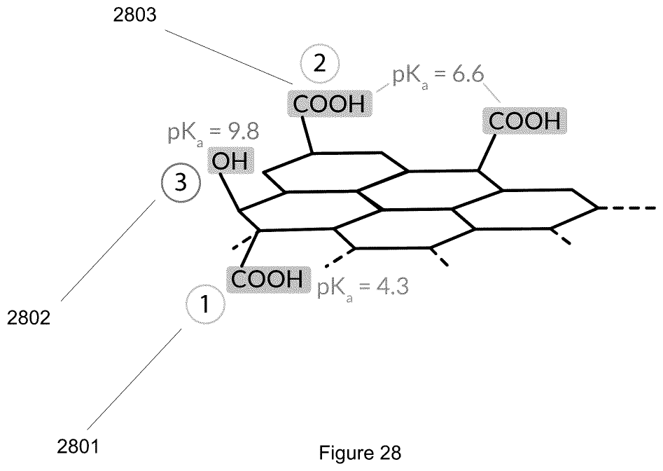

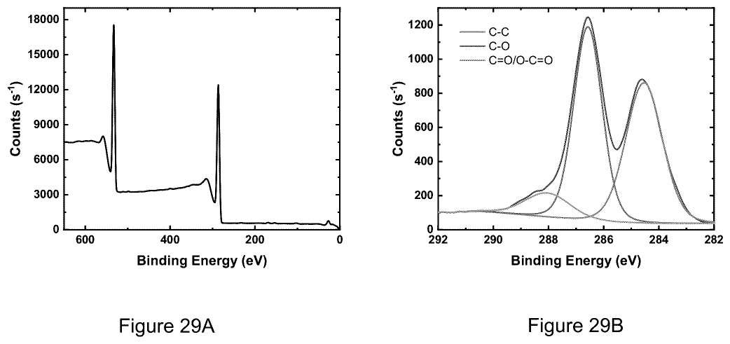

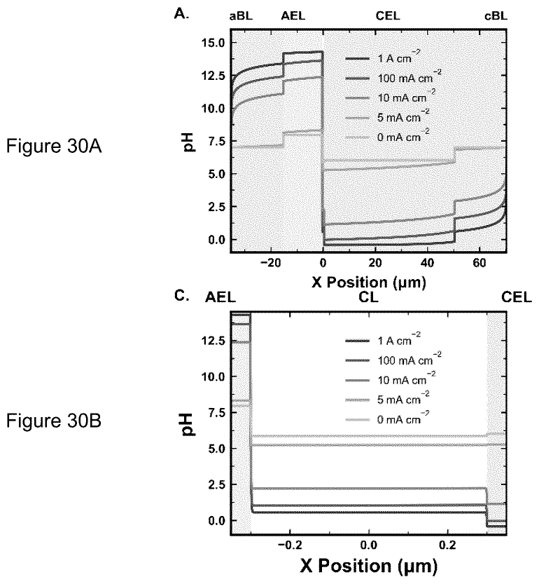

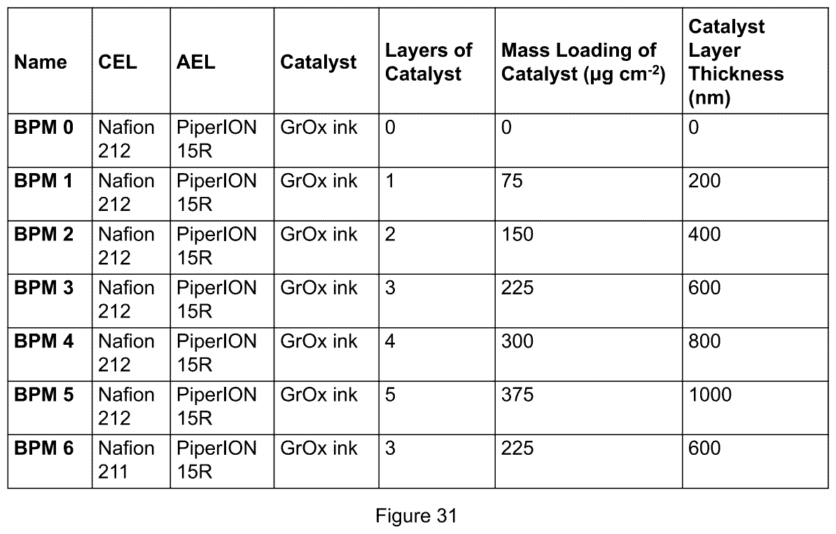

Additionally, as shown in FIG. 28, there are six different available sites on the graphene oxide, a carboxylic acid group adjacent to an alcohol that is electron withdrawing enabling a low pKₐ of 4.3 (Group 1) 2801, a carboxylic acid with no neighboring alcohols that possesses a pKₐ of 6.6 (Group 2) 2802, and an alcohol group with a pKₐ of 9.8 (Group 3) 2803. Each of these three groups can exist in a protonated (neutral) or deprotonated (− charge) form. Proton and hydroxide transfer reactions are associated with the consumption and generation of these surface species.

$${[ Gr - COOH ]}^{1} + {H}_{2} O {↔}^{{k}_{1} , {k}_{- 1}} {H}_{3} {O}^{+} + {[ Gr - {COO}^{-} ]}^{1} {K}_{1} \qquad ( S2 )$$

$${[ Gr - {COO}^{-} ]}^{1} + {H}_{2} O {↔}^{{k}_{1.5} , {k}_{- 1.5}} {[ Gr - COOH ]}^{1} + {OH}^{-} {K}_{1.5} \qquad ( S38 )$$

$${[ Gr - COOH ]}^{2} + {H}_{2} O {↔}^{{k}_{2} , {k}_{- 2}} {H}_{3} {O}^{+} + {[ Gr - {COO}^{-} ]}^{2} {K}_{2} \qquad ( S39 )$$

$${[ Gr - {COO}^{-} ]}^{2} + {H}_{2} O {↔}^{{k}_{2.5} , {k}_{- 2.5}} {[ Gr - COOH ]}^{2} + {OH}^{-} {K}_{2.5} \qquad ( S40 )$$

$${[ Gr - OH ]}^{3} + {H}_{2} O {↔}^{{k}_{3} , {k}_{- 3}} {H}_{3} {O}^{+} + {[ Gr - {O}^{-} ]}^{3} {K}_{3} \qquad ( S41 )$$

$${[ Gr - {O}^{-} ]}^{3} + {H}_{2} O {↔}^{{k}_{3.5} , {k}_{- 3.5}} {[ Gr - OH ]}^{3} + {OH}^{-} {K}_{3.5} \qquad ( S42 )$$

The overall ratios of these species occur in the ratio

$$\frac{3.}{16.9} : \frac{7.4}{16.9} : \frac{6.5}{16.9}$$

from the initial coverage of [Gr-COOH]₀¹:[Gr-COOH]₀²:[Gr-OH]₀³ species. The total concentration of sites on pure graphene oxide is determined to be c_{[Gr]}⁰=27.56 M by titration. This total concentration is also defined as distribution on a hyperbolic tangent to be the fixed site concentration of pure GrOx multiplied by the volume fraction of GrOx within the CL (ϕ_{GrOx}=1−ϕ_{L,CL}−ϕ_{Naf,CL}) and 0 outside of it, to help facilitate convergence.

$${c}_{[ Gr ]} ( x ) = 0.5 {c}_{[ Gr ]}^{0} {ϕ}_{GrOx , CL} ( tanh ( \frac{x - {x}_{2}}{{L}_{char}} ) - tanh ( \frac{x - {x}_{3}}{{L}_{char}} ) ) \qquad ( S43 )$$

The rate of consumption or generation by a bulk homogeneous reaction is defined using a mass action law. kₙ and k₋ₙ are the rate constants and kₙ is the equilibrium constant for homogeneous reaction n. The rate of consumption of species i in bulk reactions is given by:

$${R}_{B , i} = {\sum }_{n} {s}_{i , n} ( {k}_{n} {\prod }_{{s}_{i , n} < 0} {a}_{i}^{- {s}_{i , n}} - \frac{{k}_{n}}{{K}_{n}} {\prod }_{{s}_{i , n} > 0} {a}_{i}^{{s}_{i , n}} ) \qquad ( S44 )$$

To solve the mass continuity of the catalyst species, no flux of the graphene oxide surface species is assumed in the through plane (i.e., they are immobilized on the surface and do not transport). Therefore, mass balances can be written for all the graphene oxide species as follows.

$$\begin{matrix}\frac{{dN}_{{[ Gr - COOH ]}^{1}}}{dx} = - \frac{{dN}_{{[ Gr - {COO}^{-} ]}^{1}}}{dx} = 0 \\ = {k}_{- 1} {a}_{{[ Gr - {COO}^{-} ]}^{1}} {a}_{{H}_{3} {O}^{+}} - {k}_{1} {a}_{{[ Gr - COOH ]}^{1}} {a}_{{H}_{2} O} \\ - {k}_{- 1.5} {a}_{{[ Gr - COOH ]}^{1}} {a}_{{OH}^{-}} + {k}_{1.5} {a}_{{[ Gr - {COO}^{-} ]}^{1}} {a}_{{H}_{2} O}\end{matrix} \qquad ( S45 )$$

$$\begin{matrix}\frac{{dN}_{{[ Gr - COOH ]}^{2}}}{dx} = - \frac{{dN}_{{[ Gr - {COO}^{-} \}}^{2}}}{dx} = 0 \\ = {k}_{- 2} {a}_{{[ Gr - {COO}^{-} ]}^{2}} {a}_{{H}_{3} {O}^{+}} - {k}_{2} {a}_{{[ Gr - COOH ]}^{2}} {a}_{{H}_{2} O} \\ - {k}_{- 2.5} {a}_{{[ Gr - COOH ]}^{2}} {a}_{{OH}^{-}} + {k}_{2.5} {a}_{{[ Gr - {COO}^{-} ]}^{2}} {a}_{{H}_{2} O}\end{matrix} \qquad ( S46 )$$

$$\begin{matrix}\frac{{dN}_{{[ Gr - OH ]}^{3}}}{dx} = - \frac{{dN}_{{[ Gr - {O}^{-} ]}^{3}}}{dx} = 0 \\ = {k}_{- 3} {a}_{{[ Gr - {O}^{-} ]}^{3}} {a}_{{H}_{3} {O}^{+}} - {k}_{3} {a}_{{[ Gr - OH ]}^{3}} {a}_{{H}_{2} O} - \\ {k}_{- 3.5} {a}_{{[ Gr - OH ]}^{3}} {a}_{{OH}^{-}} \\ + {k}_{3.5} {a}_{{[ Gr - {O}^{-} ]}^{3}} {a}_{{H}_{2} O}\end{matrix} \qquad ( S47 )$$

Next, site balances are needed, because only 3 of the 6 mass conservation equations are linearly independent:

$${c}_{{[ Gr - COOH ]}^{1}}^{0} = \frac{3}{16.9} {c}_{[ Gr ]} ( x ) = {c}_{{[ Gr - COOH ]}^{1}} + {c}_{{[ Gr - {COO}^{-} ]}^{1}} \qquad ( S48 )$$

$${c}_{{[ Gr - COOH ]}^{2}}^{0} = \frac{7.4}{16.9} {c}_{[ Gr ]} ( x ) = {c}_{{[ Gr - COOH ]}^{2}} + {c}_{{[ Gr - {COO}^{-} ]}^{2}} \qquad ( S49 )$$

$${c}_{{[ Gr - OH ]}^{3}}^{0} = \frac{6.5}{16.9} {c}_{[ Gr ]} ( x ) = {c}_{{[ Gr - OH ]}^{3}} + {c}_{{[ Gr - {O}^{-} ]}^{3}} \qquad ( S50 )$$

Solving the linearly independent continuity equations and site balances in MATLAB®'s symbolic matrix inversion results in the following expressions for the activities of the graphene oxide surface species.

$${c}_{{[ Gr - COOH ]}^{1}}^{0} = \frac{\frac{3}{16.9} ( {c}_{[ Gr ]} ( x ) ( {k}_{1.5} {a}_{{H}_{2} O} + {k}_{- 1} {a}_{{H}_{3} {O}^{+}} ) )}{( {k}_{1} {a}_{{H}_{2} O} + {k}_{1.5} {a}_{{H}_{2} O} + {k}_{- 1} {a}_{{H}_{3} {O}^{+}} + {k}_{- 1.5} {a}_{{OH}^{-}} )} \qquad ( S51 )$$

$${c}_{{[ Gr - {COO}^{-} ]}^{1}}^{0} = \frac{( \frac{3}{16.9} ( {c}_{[ Gr ]} ( x ) ( {k}_{1} {a}_{{H}_{2} O} + {k}_{- 1.5} {a}_{{OH}^{-}} ) ) )}{( {k}_{1} {a}_{{H}_{2} O} + {k}_{1.5} {a}_{{H}_{2} O} + {k}_{- 1} {a}_{{H}_{3} {O}^{+}} + {k}_{- 1.5} {a}_{{OH}^{-}} )} \qquad ( S52 )$$

$${c}_{{[ Gr - COOH ]}^{2}}^{0} = \frac{\frac{7.4}{16.9} ( {c}_{[ Gr ]} ( x ) ( {k}_{2.5} {a}_{{H}_{2} O} + {k}_{- 2} {a}_{{H}_{3} {O}^{+}} ) )}{( {k}_{2} {a}_{{H}_{2} O} + {k}_{2.5} {a}_{{H}_{2} O} + {k}_{- 2} {a}_{{H}_{3} {O}^{+}} + {k}_{- 2.5} {a}_{{OH}^{-}} )} \qquad ( S53 )$$

$${c}_{{[ Gr - {COO}^{-} ]}^{2}}^{0} = \frac{\frac{7.4}{16.9} ( {c}_{[ Gr ]} ( x ) ( {k}_{2} {a}_{{H}_{2} O} + {k}_{- 2.5} {a}_{{OH}^{-}} ) )}{( {k}_{2} {a}_{{H}_{2} O} + {k}_{2.5} {a}_{{H}_{2} O} + {k}_{- 2} {a}_{{H}_{3} {O}^{+}} + {k}_{- 2.5} {a}_{{OH}^{-}} )} \qquad ( S54 )$$

$${c}_{{[ Gr - OH ]}^{3}}^{0} = \frac{\frac{6.5}{16.9} ( {c}_{[ Gr ]} ( x ) ( {k}_{3.5} {a}_{{H}_{2} O} + {k}_{- 3} {a}_{{H}_{3} {O}^{+}} ) )}{( {k}_{3} {a}_{{H}_{2} O} + {k}_{3.5} {a}_{{H}_{2} O} + {k}_{- 3} {a}_{{H}_{3} {O}^{+}} + {k}_{- 3.5} {a}_{{OH}^{-}} )} \qquad ( S55 )$$

$${c}_{{[ Gr - OH ]}^{3}}^{0} = \frac{\frac{6.5}{16.9} ( {c}_{[ Gr ]} ( x ) ( {k}_{3} {a}_{{H}_{2} O} + {k}_{- 3.5} {a}_{{OH}^{-}} ) )}{( {k}_{3} {a}_{{H}_{2} O} + {k}_{3.5} {a}_{{H}_{2} O} + {k}_{- 3} {a}_{{H}_{3} {O}^{+}} + {k}_{- 3.5} {a}_{{OH}^{-}} )} \qquad ( S56 )$$

Rate constants for the above reactions are found in Table 2. The equilibria of reactions that generate net charge (K_{w}, K₁, K₂, K₃) are affected by the Second Wien Effect

$$\frac{{K}_{i} ( b )}{{K}_{i}^{0}} = \frac{{k}_{i} ( b ) {k}_{- i}^{0}}{{k}_{- i} ( b ) {k}_{i}^{0}} = \frac{( {\sum }_{m = 0}^{∞} \frac{1}{m ! ( m + 1 ) !} {( 2 b )}^{m} ) cosh ( τ b ) {cosh ( τ )}^{b}}{1 + \frac{1 - exp ( - \frac{1}{σ} )}{2} ( {σ}^{2} b + ( 4.97 σ ) \frac{sinh ( 0.0835 σ b )}{{cosh}^{2} ( 0.0835 σ b )} )} \qquad ( S57 )$$

where b is a lumped unitless electric field parameter defined as follows:

$$b = {α}_{WD} \frac{{l}_{b} F}{RT} E \qquad ( S58 )$$

α_{WD} is a parameter fit to a value of 0.172 in the dimensionless electric field, which dictates the sensitivity of the WD kinetics to the field.²⁹ l_{b} is the Bjerrum length,

$${l}_{b} = \frac{eF}{8 {πε}_{{H}_{2} O} RT} .$$

τ is a lumped parameter.

τ=−0.128 ln(cosh(0.235σ))+5.72σ², (S59)

where σ is dimensionless number defined by the ratio of the bond dissociation length and the Bjerrum length.

$$σ = \frac{0.58 nm}{2 {l}_{b}} \qquad ( S60 )$$

To compare various models for the field-enhanced dissociation in the CL, the model is also run with an exponential dependence,

$$\frac{{K}_{i} ( b )}{{K}_{i}^{0}} = \frac{{k}_{i} ( b )}{{k}_{- i} ( b )} = exp ( b ) . \qquad ( S61 )$$

where b is a lumped unitless electric field parameter defined with a different fit α_{WD,exp}=1.18:

$$b = {α}_{WD , exp} \frac{{l}_{b} F}{RT} E \qquad ( S62 )$$

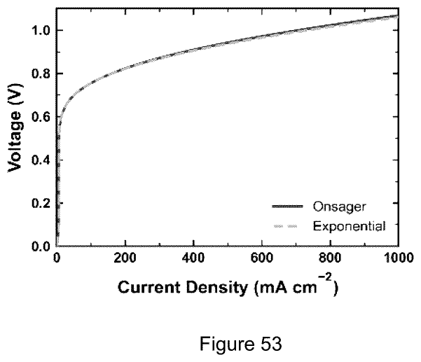

The choice of kinetics had no effect on the quality of fitting shown in FIG. 53.

### Example 7: Boundary Conditions

At the end of catholyte boundary layer (leftmost boundary), Dirichlet boundary conditions set the concentrations of all modeled ionic species to their bulk electrolyte concentration:

$${c}_{i} ( x = - \frac{{L}_{CL}}{2} - {L}_{CEL} - {L}_{cBL} ) = {c}_{i}^{bulk} \qquad ( S63 )$$

where the origin is defined at the center of the WD CL, L_{CL} is the catalyst layer thickness, L_{CEL} is the CEL thickness, and L_{cBL} is the catholyte boundary layer thickness.

The electrostatic potential is set to 0 V with another Dirichlet boundary condition.

$$Φ ( x = - \frac{{L}_{CL}}{2} - {L}_{CEL} - {L}_{cBL} ) = 0 V \qquad ( S64 )$$

At the end of the anolyte boundary layer (rightmost boundary), Dirichlet boundary conditions are again employed to set species concentrations to their bulk values:

$${c}_{i} ( x = \frac{{L}_{CL}}{2} + {L}_{AEL} + {L}_{aBL} ) = {c}_{i}^{bulk} \qquad ( S65 )$$

L_{AEL} is the AEL thickness, and L_{aBL} is the anolyte boundary layer thickness. Lastly, the electrostatic potential is set to the measured membrane potential at the anolyte boundary.

$$Φ ( x = \frac{{L}_{CL}}{2} + {L}_{CEL} + {L}_{cBL} ) = {V}_{mem} \qquad ( S66 )$$

### Example 8: Numerical Methods

The governing equations representing the model are solved using two coupled General Partial Differential Equation (g) Modules in COMSOL Multiphysics® with a relative tolerance of about 0.001. The modeling domain is discretized with a nonuniform mesh with heavy refinement near all interfaces (membrane-membrane, membrane-electrolyte, and membrane-CL). The resulting mesh is comprised of about 11,000 elements depending on the applied current density. A mesh independence study is performed, and the results are found to be independent of meshing for meshes greater than the 5,000 elements required to achieve convergence. Critically, to achieve initial convergence, the Donnan equilibria are solved analytically to obtain species concentrations in each of the membrane layers at zero applied membrane potential and fed to the simulation as initial conditions using hyperbolic tangent analytic functions. The simulations are solved using the Multifrontal Massively Parallel sparse direct Solver (MUMPS).

### Example 9: Table of Parameters Employed in Model

TABLE 2
List of transport parameters model employs.

| SPECIES | PARAMETER |
|---|---|
| D_{Na}_{⁺} | 1.33 × 10⁻⁹ |
| D_{Cl}_{^{−}} | 2.03 × 10⁻⁹ |
| D_{H}_{₃}_{O}_{⁺} | 6.9645 × 10⁻⁹ |
| D_{OH}_{^{−}} | 4.96 × 10⁻⁹ |
| $\frac{{ε}_{{H}_{2} O}}{{ε}_{0}}$ | 78.3 |

TABLE 3
List of buffer reaction constants.

| REACTION | CONSTANT |
|---|---|
| K_{w} | 1.0049 × 10⁻¹⁴ |
| k_{w} | 2.816 |
| K₁ | 10^{-4.3} |
| k₋₁ | 5 × 10¹⁰ |
| K_{1.5} | $\frac{{K}_{w}}{{K}_{1}}$ |
| k_{-1.5} | $\frac{{D}_{{OH}^{-}}}{{D}_{{H}_{3} {O}^{+}}} 5 \times {10}^{10}$ |
| K₂ | 10^{-6.6} |
| k₋₂ | 5 × 10¹⁰ |
| K_{2.5} | $\frac{{K}_{w}}{{K}_{2}}$ |
| k_{-2.5} | $\frac{{D}_{{OH}^{-}}}{{D}_{{H}_{3} {O}^{+}}} 5 \times {10}^{10}$ |
| K₃ | 10^{-9.8} |
| k₋₃ | 5 × 10¹⁰ |
| K_{3.5} | $\frac{{K}_{w}}{{K}_{2}}$ |
| k_{-3.5} | $\frac{{D}_{{OH}^{-}}}{{D}_{{H}_{3} {O}^{+}}} 5 \times {10}^{10}$ |

Note:
Rate constants are determined either assuming a diffusion limited reaction with H₃O⁺ or OH⁻, and employ a bimolecular proton-transfer reaction mechanism that is thermodynamically favorable at standard state and has an encounter-controlled diffusion-limited second-order rate constant.

TABLE 4
List of membrane properties the model employs.

| SPECIES | PARAMETER |
|---|---|
| IEC_{CEM} | 0.92 |
| ρ_{CEM} | 1.65 |
| L_{CEM} | 50 |
| λ_{CEM,Na+} | 12 |
| λ_{CEM,H+} | 22 |
| IEC_{AEM} | 2.35 |
| ρ_{AEM} | 1.05 |
| L_{AEM} | 15 |
| λ_{AEM,Cl}_{^{−}} | 12 |
| λ_{AEM,OH}_{^{−}} | 21 |
| $\frac{{ε}_{{H}_{2} O , M}}{{ε}_{0}}$ | 53.5 |
| $\frac{{ε}_{M}}{{ε}_{0}}$ | 3.5 |

TABLE 5
List of catalyst layer properties the model employs.

| SPECIES | PARAMETER |
|---|---|
| ρ_{GrOx} | 1.36 |
| $\frac{{ε}_{GrOx}}{{ε}_{0}}$ | 2.3 |
| $\frac{{c}_{{[ Gr - COOH ]}^{1}}^{0}}{{c}_{[ Gr ]}^{0}}$ | $\frac{3}{16.9}$ |
| $\frac{{c}_{{[ Gr - COOH ]}^{2}}^{0}}{{c}_{[ Gr ]}^{0}}$ | $\frac{7.4}{16.9}$ |
| $\frac{{c}_{{[ Gr - OH ]}^{3}}^{0}}{{c}_{[ Gr ]}^{0}}$ | $\frac{6.5}{16.9}$ |
| C_{GrOx,Pure}⁰ | 27.56 |

TABLE 6
List of fit parameters the model employs.

| SPECIES | PARAMETER |
|---|---|
| q | 1 |
| ϕ_{0, CL} | 0.45 |
| ϕ_{Naf, CL} | 0.10 |
| α_{WD} | 0.172 |
| α_{WD, Exp.} | 1.18 |

### Example 10: Titration Details

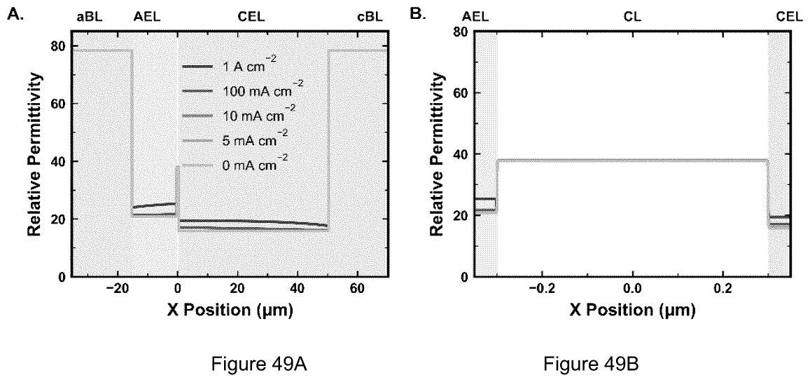

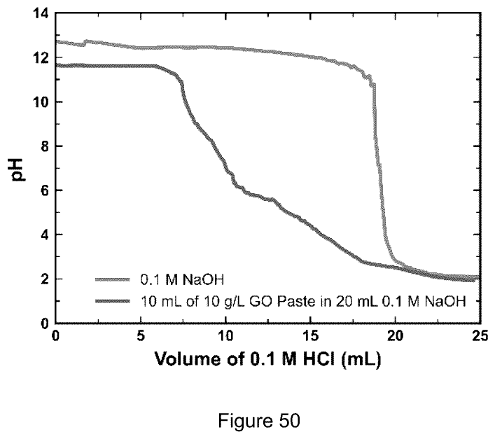

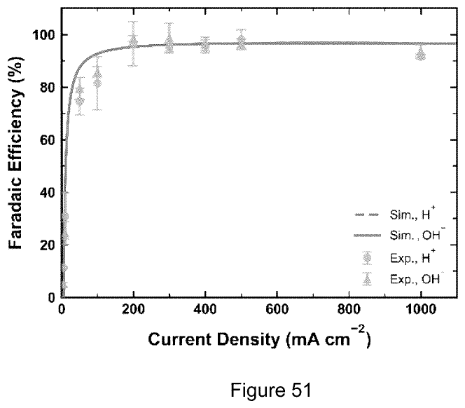

To calculate the total number of GrOx sites available for proton transfer from the titration data collected in FIG. 50 the GrOx in equilibrium is assumed.

$$\frac{{c}_{{[ Gr - {COO}^{-} ]}^{1}} {c}_{{H}_{3} {O}^{+}}}{{c}_{{[ Gr - COOH ]}^{1}}} = {10}^{- 4.3} [ M ] \qquad ( S67 )$$

$$\frac{{c}_{{[ Gr - {COO}^{-} ]}^{2}} {c}_{{H}_{3} {O}^{+}}}{{c}_{{[ Gr - COOH ]}^{2}}} = {10}^{- 6.6} [ M ] \qquad ( S68 )$$

$$\frac{{c}_{{[ Gr - {O}^{-} ]}^{3}} {c}_{{H}_{3} {O}^{+}}}{{c}_{{[ Gr - OH ]}^{3}}} = {10}^{- 9.8} [ M ] \qquad ( S69 )$$

At the equivalence point pH=7, so c_{H}_{₃}_{O}_{⁺⁼}10⁻⁷ [M] and c_{OH}_{^{−}}=10⁻⁷ [M]. Additionally, about 10.05 mL of 0.1 M HCl, about 20 mL of 0.1 M NaOH, and about 10 mL of a 10 g/L GrOx Paste is added. Substituting in the known proton concentration at the equivalence point:

$$\frac{{c}_{{[ Gr - {COO}^{-} ]}^{1}} ( {10}^{- 7} [ M ] )}{{c}_{{[ Gr - COOH ]}^{1}}} = {10}^{- 4.3} [ M ] \qquad ( S70 )$$

$$\frac{{c}_{{[ Gr - {COO}^{-} ]}^{2}} ( {10}^{- 7} [ M ] )}{{c}_{{[ Gr - COOH ]}^{2}}} = {10}^{- 6.6} [ M ] \qquad ( S71 )$$

$$\frac{{c}_{{[ Gr - {O}^{-} ]}^{3}} ( {10}^{- 7} [ M ] )}{{c}_{{[ Gr - OH ]}^{3}}} = {10}^{- 9.8} [ M ] \qquad ( S72 )$$

To determine the equilibrium concentrations of Na⁺ and Cl⁻, the starting concentrations to account for dilution is altered.

$${c}_{{Cl}^{-}} = \frac{10.05 [ mL ] \times 0.1 [ M ]}{10.05 [ mL ] + 20 [ mL ] + 10 [ mL ]} = 0.0251 [ M ] \qquad ( S73 )$$

$${c}_{{Na}^{+}} = \frac{20 [ mL ] \times 0.1 [ M ]}{10.05 [ mL ] + 20 [ mL ] + 10 [ mL ]} = 0.05 [ M ] \qquad ( S74 )$$

There must be a site balance where the all of the GrOx surface species add up to a total:

c_{[Gr-COOH]}_{¹}⁰+c_{[Gr-COOH]}_{²}⁰+c_{[Gr-OH]}_{³}⁰=c_{Gr}⁰ (S75)

Additionally, the fraction of the total sites occupied by each type of site by integration performed by prior research, and that a site balance must hold for each type of site on the GO.

$${c}_{{[ Gr - COOH ]}^{1}}^{0} = \frac{3}{16.9} {c}_{Gr}^{0} = {c}_{{[ Gr - {COO}^{-} ]}^{1}} + {c}_{{[ Gr - COOH ]}^{1}} \qquad ( S76 )$$

$${c}_{{[ Gr - COOH ]}^{2}}^{0} = \frac{7.4}{16.9} {c}_{Gr}^{0} = {c}_{{[ Gr - {COO}^{-} ]}^{2}} + {c}_{{[ Gr - COOH ]}^{2}} \qquad ( S77 )$$

$${c}_{{[ Gr - OH ]}^{3}}^{0} = \frac{6.5}{16.9} {c}_{Gr}^{0} = {c}_{{[ Gr - {O}^{-} ]}^{3}} + {c}_{{[ Gr - OH ]}^{3}} \qquad ( S78 )$$

### Electroneutrality is Conserved in the System:

c_{[Gr-COO}_{^{−}}_{]}_{¹}+c_{[Gr-COO}_{^{−}}_{]}_{²}+c_{[Gr-O}_{^{−}}_{]}_{³}+c_{Cl}_{^{−}}−c_{Na}_{⁺}+c_{OH}_{^{−}}−c_{H}_{₃}_{O}_{⁺}=0 (S79)

Solving the system of equation enables determination of the total GrOx site concentration:

c_{Gr}⁰=0.0506030446[M] (S80)

Now, the concentration basis is converted back to a mole basis by multiplying by the total volume of solution:

n_{Gr}⁰=0.0506030446 [M]×40.05 [mL]=0.00202665194 [moles] (S81)

There is 0.1 g of GrOx added to the solution (10 mL of 10 [g/L] GrOx paste). Therefore, the ion exchange capacity of pure GrOx can be determined as follows:

$${IEC}_{GrOx} = \frac{0.00202665194 moles}{0.1 [ g ]} = 20.2665194 [ mmol {g}^{- 1} ] \qquad ( S82 )$$

Lastly, the fixed-site concentration in pure GrOx can then be determined by multiplying the IEC by the density of GO³⁴ as follows:

c_{GrOx,Pure}⁰=IEC_{GrOx}×ρ_{GrOx}=20.2665194 [mmol g⁻¹]×1.36 [g cm⁻³]=27.56 [M] (S833)

### Example 11: Calculation of Salt-Ion Crossover Current Density

To determine the salt crossover current, the contribution to the total current density from WD as measured by pH change is subtracted from the total current density. Because the H⁺ and OH⁻ current density are equivalent stoichiometrically, their average is used to perform the subtraction to determine the salt crossover current density.

$${j}_{salt} = {j}_{total} - \frac{{j}_{{H}_{3} {O}^{+} , catholyte} + {j}_{{OH}^{-} , anolyte}}{2} \qquad ( S84 )$$

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A bipolar membrane comprising:
an anion exchange layer comprising an anion exchange membrane;
a cation exchange layer comprising a cation exchange membrane, wherein the anion exchange layer has a different thickness than the cation exchange layer such that water transport rate at an anion exchange layer-cation exchange layer interface increases; and
a catalyst disposed between the anion exchange layer and the cation exchange layer, wherein the catalyst catalyzes a water dissociation reaction; wherein the catalyst comprises a plurality of ionizable sites with a property of proton donating, proton withdrawing, or a combination thereof, such that the plurality of ionizable sites enhances an electric field at the anion exchange layer-cation exchange layer interface.

2. The bipolar membrane of claim 1, wherein the catalyst comprises a material selected from the group consisting of: a two-dimensional material, graphene oxide, a metal oxide, a titanium-based multivalent catalyst, a nanomaterial, a polymer, and any combinations thereof.

3. The bipolar membrane of claim 1, wherein the catalyst layer further comprises an ionomer.

4. The bipolar membrane of claim 1, wherein the plurality of ionizable sites comprises functional groups of different pkₐ values.

5. The bipolar membrane of claim 1, wherein the anion exchange membrane is selected from the group consisting of: SELEMION®, NEOSEPTA®, Fumapem® FAA, Fumasep® FAP, Sustainion® X37, Versogen® PiperION®, Ionomr Aemion®, and any combination thereof; and the cation exchange membrane comprises Nafion®.

6. The bipolar membrane of claim 1, wherein a thickness of the bipolar membrane is greater than or equal to 70 microns.

7. The bipolar membrane of claim 1, wherein the anion exchange layer has a thickness less than 100 microns and is thinner than the cation exchange layer.

8. The bipolar membrane of claim 1, wherein the cation exchange layer has a thickness less than 100 microns and is thinner than the anion exchange layer.

9. The bipolar membrane of claim 1, wherein the membrane is configured to be a portion of an electrodialysis cell.

10. The bipolar membrane of claim 9, wherein the electrodialysis cell has a configuration selected from the group consisting of: an H cell, a cell stack, a flow cell, and a flow stack.

11. The bipolar membrane of claim 9, wherein the electrodialysis cell comprises a cathode and an anode comprising a material selected from the group consisting of: a metal, a metal alloy, nickel, a nickel-based alloy, copper, a copper-based alloy, titanium, a titanium-based alloy, iron, an iron-based alloy, stainless steel, platinum, gold, silver, carbon, carbon cloth, glassy carbon, graphite, and any combinations thereof.

12. The bipolar membrane of claim 9, wherein the electrodialysis cell is a portion of a carbon capture system, an electrochemical conversion system, an energy storage system, a water splitting system, or a carbon dioxide reduction system.

13. The bipolar membrane of claim 12, wherein the carbon capture system is a direct ocean capture system.

14. The bipolar membrane of claim 9, wherein the electrodialysis cell operates at a current density of greater than or equal to 100 mA/cm² and at a voltage of less than or equal to 1.5 V for a duration of at least 60 hours.

15. An electrodialysis cell comprising:
a freestanding bipolar membrane comprising:
an anion exchange layer comprising an anion exchange membrane;
a cation exchange layer comprising a cation exchange membrane, wherein the anion exchange layer has a different thickness than the cation exchange layer such that water transportation rate at an anion exchange layer-cation exchange layer interface increases; and
a catalyst disposed between the anion and cation exchange layers catalyzes a water dissociation reaction; wherein the catalyst comprises a plurality of ionizable sites with a property of proton donating, proton withdrawing, or a combination thereof, such that the plurality of ionizable sites enhances an electric field at the anion exchange layer-cation exchange layer interface;
an anode and a cathode, wherein the freestanding bipolar membrane is disposed between the anode and the cathode.

16. The cell of claim 15, wherein the catalyst comprises a material selected from the group consisting of: a two-dimensional material, graphene oxide, a metal oxide, a titanium-based multivalent catalyst, a nanomaterial, a polymer, and any combinations thereof.

17. The cell of claim 15, wherein the catalyst layer further comprises an ionomer.

18. The cell of claim 15, wherein the plurality of ionizable sites comprises functional groups of different pkₐ values.

19. The cell of claim 15, wherein the anion exchange membrane is selected from the group consisting of: SELEMION®, NEOSEPTA®, Fumapem® FAA, Fumasep® FAP, Sustainion® X37, Versogen® PiperION®, Ionomr Aemion®, and any combination thereof; and the cation exchange membrane comprises Nafion®.

20. The cell of claim 15, wherein a thickness of the bipolar membrane is greater than or equal to 70 microns.

21. The cell of claim 15, wherein the anion exchange layer has a thickness less than 100 microns and is thinner than the cation exchange layer.

22. The cell of claim 15, wherein the cation exchange layer has a thickness less than 100 microns and is thinner than the anion exchange layer.

23. The cell of claim 15, wherein the electrodialysis cell has a configuration selected from the group consisting of: an H cell, a cell stack, a flow cell, and a flow stack.

24. The cell of claim 15, wherein the cathode and the anode comprise a material selected from the group consisting of: a metal, a metal alloy, nickel, a nickel-based alloy, copper, a copper-based alloy, titanium, a titanium-based alloy, iron, an iron-based alloy, stainless steel, platinum, gold, silver, carbon, carbon cloth, glassy carbon, graphite, and any combinations thereof.

25. The cell of claim 15, wherein the electrodialysis cell is configured to be a portion of a carbon capture system, an electrochemical conversion system, an energy storage system, a water splitting system, or a carbon dioxide reduction system.

26. The cell of claim 25, wherein the carbon capture system is a direct ocean capture system.

27. The cell of claim 15, wherein the electrodialysis cell operates at a current density of greater than or equal to 100 mA/cm² and at a voltage of less than or equal to 1.5 V for a duration of at least 60 hours.

28. A method for direct ocean capture, comprising:
contacting a water source comprising a dissolved carbon with a bipolar membrane comprising:
an anion exchange layer comprising an anion exchange membrane;
a cation exchange layer comprising a cation exchange membrane; wherein the anion exchange layer has a different thickness than the cation exchange layer such that water transport rate at an anion exchange layer-cation exchange layer interface increases; and
a catalyst disposed between the anion exchange layer and the cation exchange layer catalyzes a water dissociation reaction; wherein the catalyst comprises a plurality of ionizable sites with a property of proton donating, proton withdrawing, or a combination thereof, such that the plurality of ionizable sites enhances an electric field at the anion exchange layer-cation exchange layer interface;
collecting a carbon dioxide gaseous stream; wherein the bipolar membrane enhances an efficiency of producing the carbon dioxide gaseous stream; and
collecting an output water stream that has a lower dissolved carbon concentration than the water source.

29. The method of claim 28, wherein the catalyst comprises a material selected from the group consisting of: a two-dimensional material, graphene oxide, a metal oxide, a titanium-based multivalent catalyst, a nanomaterial, a polymer, and any combinations thereof.

30. The method of claim 28, wherein the catalyst layer further comprises an ionomer.

31. The method of claim 28, wherein the plurality of ionizable sites comprises functional groups of different pkₐ values.

32. The method of claim 28, wherein the anion exchange membrane is selected from the group consisting of: SELEMION®, NEOSEPTA®, fumapem FAA, fumasep FAP, Sustainion® X37, Versogen® PiperION®, Ionomr Aemion®, and any combination thereof; and the cation exchange membrane comprises Nafion®.

33. The method of claim 28, wherein a thickness of the bipolar membrane is greater than or equal to 70 microns.

34. The method of claim 28, wherein the anion exchange layer has a thickness less than 100 microns and is thinner than the cation exchange layer.

35. The method of claim 28, wherein the cation exchange layer has a thickness less than 100 microns and is thinner than the anion exchange layer.

36. The method of claim 28, wherein the bipolar membrane is a portion of an electrodialysis cell.

37. The method of claim 36, wherein the electrodialysis cell has a configuration selected from the group consisting of: an H cell, a cell stack, a flow cell, and a flow stack.

38. The method of claim 36, wherein the electrodialysis cell comprises a cathode and an anode comprising a material selected from the group consisting of: a metal, a metal alloy, nickel, a nickel-based alloy, copper, a copper-based alloy, titanium, a titanium-based alloy, iron, an iron-based alloy, stainless steel, platinum, gold, silver, carbon, carbon cloth, glassy carbon, graphite, and any combinations thereof.

39. The method of claim 28, wherein the water source is selected from the group consisting of: native oceanwater, river water, pretreated oceanwater, or any combination thereof.
